(19) United States
(12) Patent Application Publication
(10) Pub. No.: US 2013/0339438 A1
(43) Pub. Date: Dec. 19, 2013

(54) SYSTEMS AND METHODS FOR GROUP BASED ACCESS CONTROL OF MACHINE TO MACHINE DEVICES

(71) Applicant: Qualcomm Incorporated, San Diego, CA (US)

(72) Inventors: George Cherian, San Diego, CA (US); Jun Wang, San Diego, CA (US); Aleksandar Gogic, La Jolla, CA (US)

(73) Assignee: QUALCOMM INCORPORATED, San Diego, CA (US)

(21) Appl. No.: 13/691,643

(22) Filed: Nov. 30, 2012

Related U.S. Application Data
(60) Provisional application No. 61/566,129, filed on Dec. 2, 2011.
(60) Provisional application No. 61/624,207, filed on Apr. 13, 2012.

(30) Foreign Application Priority Data
Oct. 3, 2012 (CN) PCT/CN2012/082520

(51) Int. Cl. H04W 4/00

(52) U.S. Cl. CPC H04W 4/005
USPC 709/204

(57) ABSTRACT

Methods and devices for communicating in a communication system are described herein. In one aspect, methods and devices for group based access control of machine to machine devices for wireless communication are described. One method includes forming a machine-to-machine (M2M) group identifier based on a M2M service category. The method further includes associating the M2M group identifier with at least one wireless device. The method further includes transmitting data intended for receipt by the M2M group, the data including the M2M group identifier.

### CROSS-REFERENCE TO RELATED APPLICATIONS

The present application claims priority to U.S. Provisional Application No. 61/566,129, filed Dec. 2, 2011; U.S. Provisional Application No. 61/624,207, filed Apr. 13, 2012; and PCT Patent Application No. PCT/CN2012/082520 filed Oct. 3, 2012; all of which are hereby incorporated by reference herein.

### BACKGROUND

1. Field

The present application relates generally to communication systems and more specifically to group based access control methods and devices for machine to machine communications.

2. Background

In many communication systems, communications networks are used to exchange messages among several interacting spatially-separated devices. Networks can be classified according to geographic scope, which could be, for example, a metropolitan area, a local area, or a personal area. Such networks would be designated respectively as a wide area network (WAN), metropolitan area network (MAN), local area network (LAN), or personal area network (PAN). Networks also differ according to the switching/routing technique used to interconnect the various network nodes and devices (e.g., circuit switching vs. packet switching), the type of physical media employed for transmission (e.g., wired vs. wireless), and the set of communication protocols used (e.g., Internet protocol suite, SONET (Synchronous Optical Networking), Ethernet, etc.).

Wireless networks are often preferred when the network elements are mobile and thus have dynamic connectivity needs, or if the network architecture is formed in an ad hoc, rather than fixed, topology. Wireless networks employ intangible physical media in an unguided propagation mode using electromagnetic waves in the radio, microwave, infra-red, optical, etc. frequency bands. Wireless networks advantageously facilitate user mobility and rapid field deployment when compared to fixed wired networks.

As networks proliferate, the types of network elements connected thereto also expands. One type of network elements being introduced are machine to machine (M2M) elements. Examples of M2M elements include a smart utility meter (“smartmeter”), seismographs, vehicles, and appliances. Improvements to communication systems can be desirable which take advantage of certain characteristics of a M2M element.

### SUMMARY

The methods and devices described each have several aspects, no single one of which is solely responsible for its desirable attributes. Without limiting the scope of this disclosure as expressed by the claims which follow, some features will now be discussed briefly. After considering this discussion, and particularly after reading the section entitled “Detailed Description” one will understand how the features described provide advantages that include group based access control of machine to machine devices in a wireless communication system.

In one aspect, a wireless communications device is provided. The wireless communications device includes a transmitter configured to wirelessly transmit messages to a plurality of stations. Each station is a member of one or more of a plurality of groups of stations. The wireless communications device further includes a processor configured to generate a first message for a first one or more of the groups of stations. The first message includes an access control message indicating a first restriction on transmission. The processor is further configured to cause the transmitter to transmit the first message to each of the stations of the first one or more groups. The first restriction is based on one or more of a latency preference, a data volume per data session, and/or a subscription level associated with each of the plurality of stations.

In another aspect, a wireless communications device is provided. The wireless communications device includes a transmitter configured to wirelessly transmit messages to a plurality of stations. Each station is a member of one or more of a plurality of groups of stations. The wireless communications device further includes a processor configured to generate a first message for a first one or more of the groups of stations. The processor is further configured to cause the transmitter to transmit the first message to each of the stations of the first one or more groups with a first delay. The first delay is based on one or more of a latency preference, a data volume per data session, and/or a subscription level associated with each of the plurality of stations.

In another aspect, a method of controlling access of a plurality of stations is provided. Each station is a member of one or more of a plurality of groups of stations. The method includes generating a first message for a first one or more of the groups of stations. The first message includes an access control message indicating a first restriction on transmission. The method further includes transmitting the first message to each of the stations of the first one or more groups. The first restriction is based on one or more of a latency preference, a data volume per data session, and/or a subscription level associated with each of the plurality of stations.

In another aspect, a method of controlling access of a plurality of stations is provided. Each station is a member of one or more of a plurality of groups of stations. The method includes generating a first message for a first one or more of the groups of stations. The method further includes transmitting the first message to each of the stations of the first one or more groups with a first delay. The first delay is based on one or more of a latency preference, a data volume per data session, and/or a subscription level associated with each of the plurality of stations.

In another aspect, an apparatus for controlling access of a plurality of stations is provided. Each station is a member of one or more of a plurality of groups of stations. The apparatus includes means for generating a first message for a first one or more of the groups of stations. The first message includes an access control message indicating a first restriction on transmission. The apparatus further includes means for transmitting the first message to each of the stations of the first one or more groups. The first restriction is based on one or more of a latency preference, a data volume per data session, and/or a subscription level associated with each of the plurality of stations.

In another aspect, an apparatus for controlling access of a plurality of stations is provided. Each station is a member of one or more of a plurality of groups of stations. The apparatus includes means for generating a first message for a first one or more of the groups of stations. The apparatus further includes means for transmitting the first message to each of the stations of the first one or more groups with a first delay. The first delay is based on one or more of a latency preference, a data volume per data session, and/or a subscription level associated with each of the plurality of stations.

In another aspect, a non-transitory computer-readable medium is provided. The medium includes code that, when executed, causes an apparatus to wirelessly transmit messages to a plurality of stations. Each station is a member of one or more of a plurality of groups of stations. The medium further includes code that, when executed, causes the apparatus to generate a first message for a first one or more of the groups of stations. The first message includes an access control message indicating a first restriction on transmission. The medium further includes code that, when executed, causes the apparatus to transmit the first message to each of the stations of the first one or more groups. The first restriction is based on one or more of a latency preference, a data volume per data session, and/or a subscription level associated with each of the plurality of stations.

In another aspect, a non-transitory computer-readable medium is provided. The medium includes code that, when executed, causes an apparatus to wirelessly transmit messages to a plurality of stations. Each station is a member of one or more of a plurality of groups of stations. The medium further includes code that, when executed, causes the apparatus to generate a first message for a first one or more of the groups of stations. The medium further includes code that, when executed, causes the apparatus to transmit the first message to each of the stations of the first one or more groups with a first delay. The first delay is based on one or more of a latency preference, a data volume per data session, and/or a subscription level associated with each of the plurality of stations.

In another aspect, an implementation of a method for triggering a device is provided. The method includes receiving a device triggering request based on at least one of a short message service (SMS) message or an Unstructured Supplementary Service Data (USSD) message. The method further includes initiating a communication link to a server that initiated the device triggering request in response to receiving the device triggering request.

In another aspect, an apparatus for triggering a device is provided. The apparatus includes a transceiver configured to receive a device triggering request based on at least one of a short message service (SMS) message or an Unstructured Supplementary Service Data (USSD) message. The apparatus further includes a processor configured to initiate a communication link via the transceiver to a server that initiated the device triggering request in response to receiving the device triggering request.

In yet another aspect, an apparatus for triggering a device is provided. The apparatus includes means for receiving a device triggering request based on at least one of a short message service (SMS) message or an Unstructured Supplementary Service Data (USSD) message. The apparatus further includes means for initiating a communication link to a server that initiated the device triggering request in response to receiving the device triggering request.

In another aspect, a computer program product including a computer readable medium is provided. The computer readable medium includes code for receiving a device triggering request based on at least one of a short message service (SMS) message or an Unstructured Supplementary Service Data (USSD) message. The computer readable medium further includes code for initiating a communication link to a server that initiated the device triggering request in response to receiving the device triggering request.

In another aspect, a method for triggering a device is provided. The method includes receiving a message to request transmission of a device triggering request to the device. The method further includes transmitting the device triggering request to the device based on at least one of a short message service (SMS) message or an Unstructured Supplementary Service Data (USSD) message.

In another aspect, an apparatus for triggering a device is provided. The apparatus includes a receiver configured to receive a message to request transmission of a device triggering request to the device. The apparatus further includes a transmitter configured to transmit the device triggering request to the device based on at least one of a short message service (SMS) message or an Unstructured Supplementary Service Data (USSD) message.

In another aspect, an apparatus for triggering a device is provided. The apparatus includes means for receiving a message to request transmission of a device triggering request to the device. The apparatus further includes means for transmitting the device triggering request to the device based on at least one of a short message service (SMS) message or an Unstructured Supplementary Service Data (USSD) message.

In another aspect, a computer program product including a computer readable medium is provided. The computer readable medium includes code for receiving a message to request transmission of a device triggering request to the device. The computer readable medium further includes code for transmitting the device triggering request to the device based on at least one of a short message service (SMS) message or an Unstructured Supplementary Service Data (USSD) message.

In an aspect, a method, a computer program product, and an apparatus are provided. An apparatus notifies a user equipment (UE) of an upcoming multicast/broadcast of data intended for receipt by a group of UEs assigned a machine type communication (MTC) class. The UE has one or more MTC classes assigned to it and is configured to awake for the upcoming multicast/broadcast of data if the data to be broadcast corresponds to an MTC class assigned to the UE. The apparatus also multicasts/broadcasts the data intended for receipt by a group of UEs through at least one multicast/broadcast mechanism.

In another aspect, an apparatus receives a notice of an upcoming multicast/broadcast of data intended for receipt by a group of UEs assigned a MTC class. The apparatus has one or more MTC classes assigned to it and is configured to awake for the upcoming multicast/broadcast of data if the data to be broadcast corresponds to an MTC class assigned to the UE. The apparatus also receive a multicast/broadcast of the data intended for receipt by a group of UEs through at least one multicast/broadcast mechanism.

Another aspect of the subject matter described in the disclosure provides a method of wireless communication. The method includes forming a machine-to-machine (M2M) group identifier based on a M2M service category. The method further includes associating the M2M group identifier with at least one wireless device. The method further includes transmitting data intended for receipt by the M2M group, the data including the M2M group identifier.

Another aspect of the subject matter described in the disclosure provides a method of wireless communication. The method includes determining, at a wireless device, a machine-to-machine (M2M) group identifier based on a M2M service category. The method further includes transmitting an association communication indicating an association between the wireless device and the determined M2M group identifier.

Another aspect of the subject matter described in the disclosure provides an apparatus configured to communicate wirelessly. The apparatus includes a processor configured to form a machine-to-machine (M2M) group identifier based on a M2M service category. The processor is further configured to associate the M2M group identifier with at least one wireless device. The apparatus further includes a transmitter configured to transmit data intended for receipt by the M2M group, the data including the M2M group identifier.

Another aspect of the subject matter described in the disclosure provides a wireless device. The device includes a processor configured to determine a machine-to-machine (M2M) group identifier based on a M2M service category. The device further includes a transmitter configured to transmit an association communication indicating an association between the wireless device and the determined M2M group identifier.

Another aspect of the subject matter described in the disclosure provides an apparatus for wireless communication. The apparatus includes means for forming a machine-to-machine (M2M) group identifier based on a M2M service category. The apparatus further includes means for associating the M2M group identifier with at least one wireless device. The apparatus further includes means for transmitting data intended for receipt by the M2M group, the data including the M2M group identifier.

Another aspect of the subject matter described in the disclosure provides an apparatus of wireless communication. The apparatus includes means for determining a machine-to-machine (M2M) group identifier based on a M2M service category. The apparatus further includes means for transmitting an association communication indicating an association between the apparatus and the determined M2M group identifier.

Another aspect of the subject matter described in the disclosure provides a non-transitory computer-readable medium including code that, when executed, causes an apparatus to form a machine-to-machine (M2M) group identifier based on a M2M service category. The medium further includes code that, when executed, causes the apparatus to associate the M2M group identifier with at least one wireless device. The medium further includes code that, when executed, causes the apparatus to transmit data intended for receipt by the M2M group, the data including the M2M group identifier.

Another aspect of the subject matter described in the disclosure provides a non-transitory computer-readable medium including code that, when executed, causes an apparatus to determine a machine-to-machine (M2M) group identifier based on a M2M service category. The medium further includes code that, when executed, causes the apparatus to transmit an association communication indicating an association between the apparatus and the determined M2M group identifier.

Another aspect of the subject matter described in the disclosure provides a method of controlling access of a group of wireless devices associated with a machine-to-machine (M2M) group identifier. The method includes transmitting a group paging message for the M2M group. The paging message includes the M2M group identifier. The method further includes transmitting data intended for receipt by the M2M group.

Another aspect of the subject matter described in the disclosure provides a method of accessing a wireless network. The method includes receiving, at a wireless device associated with a machine-to-machine (M2M) group identifier, a group paging message for the M2M group. The paging message includes the group identifier. The method further includes receiving, based on the group paging message, data intended for receipt by the M2M group.

Another aspect of the subject matter described in the disclosure provides an apparatus configured to control wireless network access for a group of wireless devices associated with a machine-to-machine (M2M) group identifier. The apparatus includes a transmitter configured to transmit a group paging message for the M2M group. The paging message includes the group identifier. The transmitter is further configured to transmit data intended for receipt by the M2M group.

Another aspect of the subject matter described in the disclosure provides an apparatus associated with a machine-to-machine (M2M) group identifier. The apparatus is configured to access a wireless network. The apparatus includes a receiver configured to receive, at the apparatus associated with a machine-to-machine (M2M) group identifier, a group paging message for the M2M group. The paging message includes the group identifier. The receiver is further configured to receive, based on the group paging message, data intended for receipt by the M2M group.

Another aspect of the subject matter described in the disclosure provides an apparatus for controlling access of a group of wireless devices associated with a machine-to-machine (M2M) group identifier. The apparatus includes means for transmitting a group paging message for the M2M group. The paging message includes the group identifier. The apparatus further includes means for transmitting data intended for receipt by the M2M group.

Another aspect of the subject matter described in the disclosure provides an apparatus for accessing a wireless network. The apparatus is associated with a machine-to-machine (M2M) group identifier. The apparatus includes means for receiving a group paging message for the M2M group. The paging message includes the group identifier. The apparatus further includes means for receiving, based on the group paging message, data intended for receipt by the M2M group.

Another aspect of the subject matter described in the disclosure provides a non-transitory computer-readable medium including code that, when executed, causes an apparatus to transmit a group paging message for a group of wireless devices associated with a machine-to-machine (M2M) group identifier. The paging message includes the group identifier. The medium further includes code that, when executed, causes the apparatus to transmit data intended for receipt by the M2M group.

Another aspect of the subject matter described in the disclosure provides a non-transitory computer-readable medium including code that, when executed, causes an apparatus to receive a group paging message for an M2M group. The apparatus is associated with a machine-to-machine (M2M) group identifier. The paging message includes the group identifier. The medium further includes code that, when executed, causes the apparatus to receive, based on the group paging message, data intended for receipt by the M2M group.

Another aspect of the subject matter described in the disclosure provides a method of controlling access to a wireless network for a group of wireless devices associated with a machine-to-machine (M2M) group identifier. The method includes generating an access control message for the M2M group. The access control message includes the M2M group identifier. The method further includes transmitting the access control message to the M2M group.

Another aspect of the subject matter described in the disclosure provides a method of wireless network access. The method includes receiving, at a wireless device associated with a machine-to-machine (M2M) group identifier, an access control message for the M2M group. The access control message includes the M2M group identifier. The method further includes accessing, or refraining from accessing, the wireless network in accordance with the access control message.

Another aspect of the subject matter described in the disclosure provides an apparatus configured to control access to a wireless network for a group of wireless devices associated with a machine-to-machine (M2M) group identifier. The apparatus includes a processor configured to generate an access control message for the M2M group. The access control message includes the M2M group identifier. The apparatus further includes a transmitter configured to transmit the access control message to the M2M group.

Another aspect of the subject matter described in the disclosure provides an apparatus associated with a machine-to-machine (M2M) group identifier, configured to access a wireless network. The apparatus includes a receiver configured to receive an access control message for the M2M group. The access control message includes the M2M group identifier. The apparatus further includes a processor configured to access, or refrain from accessing, the wireless network in accordance with the access control message.

Another aspect of the subject matter described in the disclosure provides an apparatus for controlling access to a wireless network for a group of wireless devices associated with a machine-to-machine (M2M) group identifier. The apparatus includes means for generating an access control message for the M2M group. The access control message includes the M2M group identifier. The apparatus further includes means for transmitting the access control message to the M2M group.

Another aspect of the subject matter described in the disclosure provides an apparatus for wireless network access. The apparatus includes means for receiving, at a wireless device associated with a machine-to-machine (M2M) group identifier, an access control message for the M2M group. The access control message includes the M2M group identifier. The apparatus further includes means for accessing, or refraining from accessing, the wireless network in accordance with the access control message.

Another aspect of the subject matter described in the disclosure provides a non-transitory computer-readable medium including code that, when executed, causes an apparatus to generate an access control message for a group of wireless devices associated with a machine-to-machine (M2M) group identifier. The access control message includes the M2M group identifier. The medium further includes code that, when executed, causes the apparatus to transmit the access control message to the M2M group.

Another aspect of the subject matter described in the disclosure provides a non-transitory computer-readable medium including code that, when executed, causes an apparatus associated with a machine-to-machine (M2M) group identifier to receive an access control message for the M2M group. The access control message includes the M2M group identifier. The medium further includes code that, when executed, causes the apparatus to access, or refrain from accessing, the wireless network in accordance with the access control message.

Another aspect of the subject matter described in the disclosure provides a method of controlling access to a wireless network for a group of wireless devices associated with a machine-to-machine (M2M) group identifier. The method includes receiving, from a wireless device associated with a machine-to-machine (M2M) group identifier, an access message including the M2M group identifier. The method further includes verifying the M2M group identifier based on stored subscription information.

Another aspect of the subject matter described in the disclosure provides a method of wireless network access. The method includes transmitting, from a wireless device associated with a machine-to-machine (M2M) group identifier, an access message including the M2M group identifier. The method further includes receiving a message indicating verification of the M2M group identifier.

Another aspect of the subject matter described in the disclosure provides an apparatus configured to control access to a wireless network for a group of wireless devices associated with a machine-to-machine (M2M) group identifier. The apparatus includes a receiver configured to receive, from a wireless device associated with a machine-to-machine (M2M) group identifier, an access message including the M2M group identifier. The apparatus further includes a processor configured to verify the M2M group identifier based on stored subscription information.

Another aspect of the subject matter described in the disclosure provides an apparatus associated with a machine-to-machine (M2M) group identifier and configured to access a wireless network. The apparatus includes a transmitter configured to transmit an access message including the M2M group identifier. The apparatus further includes a receiver configured to receive a message indicating verification of the M2M group identifier.

Another aspect of the subject matter described in the disclosure provides an apparatus for controlling access to a wireless network for a group of wireless devices associated with a machine-to-machine (M2M) group identifier. The apparatus includes means for receiving, from a wireless device associated with a machine-to-machine (M2M) group identifier, an access message including the M2M group identifier. The apparatus further includes means for verifying the M2M group identifier based on stored subscription information.

Another aspect of the subject matter described in the disclosure provides an apparatus for wireless network access. The apparatus is associated with a machine-to-machine (M2M) group identifier. The apparatus includes means for transmitting an access message including the M2M group identifier. The apparatus further includes means for receiving a message indicating verification of the M2M group identifier.

Another aspect of the subject matter described in the disclosure provides a non-transitory computer-readable medium including code that, when executed, causes an apparatus to receive, from a wireless device associated with a machine-to-machine (M2M) group identifier, an access message including the M2M group identifier. The medium further includes code that, when executed, causes the apparatus to verify the M2M group identifier based on stored subscription information.

Another aspect of the subject matter described in the disclosure provides a non-transitory computer-readable medium including code that, when executed, causes an apparatus associated with a machine-to-machine (M2M) group identifier to transmit access message including the M2M group identifier. The medium further includes code that, when executed, causes the apparatus to receive a message indicating verification of the M2M group identifier.

### BRIEF DESCRIPTION OF THE DRAWINGS

FIG. 1 shows an exemplary communication system.

FIG. 2 shows a functional block diagram of an exemplary device that can be employed within the communication system of FIG. 1.

FIG. 3 shows a process flow diagram of an exemplary machine to machine access control process for a wireless communication system.

FIG. 4 shows a process flow diagram of another exemplary machine to machine access control process for a wireless communication system.

FIG. 5 shows a flowchart for an exemplary method of access control within the communication system of FIG. 1.

FIG. 6 shows a functional block diagram of another exemplary device that can be employed within the communication system of FIG. 1.

FIG. 7 shows a flowchart for another exemplary method of access control within the communication system of FIG. 1.

FIG. 8 shows a functional block diagram of another exemplary device that can be employed within the communication system of FIG. 1.

FIG. 9 shows a process flow diagram of an exemplary process for a wireless communication system.

FIG. 10A is a call flow diagram of an exemplary call flow for point-to-point machine-to-machine device triggering using Unstructured Supplementary Service Data (USSD) messages.

FIG. 10B is a call flow diagram of an exemplary call flow for broadcast machine-to-machine device triggering using USSD messages.

FIG. 11 is a call flow diagram of an exemplary call flow for point-to-point machine-to-machine device triggering using USSD messages over a common channel.

FIG. 12 is a call flow diagram of another exemplary call flow for point-to-point machine-to-machine device triggering using USSD messages over a common channel.

FIG. 13 is a call flow diagram of an exemplary call flow for point-to-point machine-to-machine device triggering using a USSD message over a traffic channel.

FIG. 14 is a call flow diagram of another exemplary call flow for point-to-point machine-to-machine device triggering using a USSD message over a traffic channel.

FIG. 15 is a call flow diagram of an exemplary call flow for broadcast machine-to-machine device triggering using a USSD message.

FIG. 16 is a call flow diagram of another exemplary call flow for broadcast machine-to-machine device triggering using a USSD message.

FIG. 17 is a call flow diagram of an exemplary call flow for point-to-point machine-to-machine device triggering using a Short Message Service (SMS) message over a common channel using a device triggering teleservice.

FIG. 18 is a call flow diagram of another exemplary call flow for point-to-point machine-to-machine device triggering using an SMS message over a common channel using a device triggering teleservice.

FIG. 19 is a call flow diagram of an exemplary call flow for point-to-point machine-to-machine device triggering using an SMS message over a traffic channel using a machine to machine teleservice.

FIG. 20 is a call flow diagram of another exemplary call flow for point-to-point machine-to-machine device triggering using an SMS message over a traffic channel using a machine to machine teleservice.

FIG. 21 is a call flow diagram of an exemplary call flow for broadcast machine-to-machine device triggering using an SMS message.

FIG. 22 is a call flow diagram of another exemplary call flow for broadcast machine-to-machine device triggering using an SMS message.

FIG. 23 shows a process flow diagram of an exemplary process for triggering a device.

FIG. 24 shows a functional block diagram of another exemplary device that can be employed within the communication system of FIG. 1.

FIG. 25 shows a process flow diagram of another exemplary process for triggering a device.

FIG. 26 shows a functional block diagram of another exemplary device that can be employed within the communication system of FIG. 1.

FIG. 27 shows a flowchart for an exemplary method of wireless communication within the communication system of FIG. 1.

FIG. 28 shows a functional block diagram of another exemplary device that can be employed within the communication system of FIG. 1.

FIG. 29 shows a flowchart for an exemplary method of wireless communication within the communication system of FIG. 1.

FIG. 30 shows a functional block diagram of another exemplary device that can be employed within the communication system of FIG. 1.

FIG. 31 shows a flowchart for controlling access of a group of wireless devices within the communication system of FIG. 1.

FIG. 32 shows a functional block diagram of another exemplary device that can be employed within the communication system of FIG. 1.

FIG. 33 shows a flowchart for an exemplary method of controlling access of a group of wireless devices within the communication system of FIG. 1.

FIG. 34 shows a functional block diagram of another exemplary device that can be employed within the communication system of FIG. 1.

FIG. 35 shows a flowchart for an exemplary method of controlling access, for a group of wireless devices, to the communication system of FIG. 1.

FIG. 36 shows a functional block diagram of another exemplary device that can be employed within the communication system of FIG. 1.

FIG. 37 shows a flowchart for an exemplary method of accessing the communication system of FIG. 1.

FIG. 38 shows a functional block diagram of another exemplary device that can be employed within the communication system of FIG. 1.

FIG. 39 shows a flowchart for an exemplary method of controlling access, for a group of wireless devices, to the communication system of FIG. 1.

FIG. 40 shows a functional block diagram of another exemplary device that can be employed within the communication system of FIG. 1.

FIG. 41 shows a flowchart for an exemplary method of accessing the communication system of FIG. 1.

FIG. 42 shows a functional block diagram of another exemplary device that can be employed within the communication system of FIG. 1.

### DETAILED DESCRIPTION

Various aspects of the novel apparatuses and methods are described more fully hereinafter with reference to the accompanying drawings. The teachings disclosure can, however, be implemented in many different forms and should not be construed as limited to any specific structure or function presented throughout this disclosure. Rather, these aspects are provided so that this disclosure will be thorough and complete, and will fully convey the scope of the disclosure to those skilled in the art. Based on the teachings herein one skilled in the art should appreciate that the scope of the disclosure is intended to cover any aspect of the novel apparatuses and methods disclosed herein, whether implemented independently of or combined with any other aspect of the disclosure. For example, an apparatus can be implemented or a method can be practiced using any number of the aspects set forth herein. In addition, the scope of the description is intended to cover such an apparatus or method which is practiced using other structure, functionality, or structure and functionality in addition to or other than the various aspects set forth herein. It should be understood that any aspect disclosed herein can be implemented by one or more elements of a claim.

Although particular aspects are described herein, many variations and permutations of these aspects fall within the scope of the disclosure. Although some benefits and advantages of the preferred aspects are mentioned, the scope of the disclosure is not intended to be limited to particular benefits, uses, or objectives. Rather, aspects of the disclosure are intended to be broadly applicable to different communication technologies, system configurations, networks, and transmission protocols, some of which are illustrated by way of example in the figures and in the following description of the preferred aspects. The detailed description and drawings are merely illustrative of the disclosure rather than limiting, the scope of the disclosure being defined by the appended claims and equivalents thereof.

Popular wireless network technologies can include various types of wireless local area networks (WLANs). A WLAN can be used to interconnect nearby devices together, employing widely used networking protocols. The various aspects described herein can apply to a communication standard, such as wireless protocols. For example, the various aspects described herein can use Zigbee, WiFi, HomePlug, Bluetooth, Zwave, cellular, or other radio communications.

In some implementations, a communication network includes various devices which are the components that access the network. For example, there can be two types of devices: access points (“APs”) and clients (also referred to as stations, or “STAs”). In general, an AP serves as a hub or base station for the communication network and an STA serves as a user of the communication network. For example, an STA can be a laptop computer, a personal digital assistant (PDA), a mobile phone, etc. In an example, an STA connects to an AP via a WiFi (e.g., IEEE 802.11 protocol such as 802.11ah) compliant wireless link to obtain general connectivity to the Internet or to other wide area networks.

An access point (“AP”) can also comprise, be implemented as, or known as a NodeB, Radio Network Controller (“RNC”), eNodeB, Base Station Controller (“BSC”), Base Transceiver Station (“BTS”), Base Station (“BS”), Transceiver Function (“TF”), Router, Transceiver, Hub, or some other terminology.

A station “STA” can also comprise, be implemented as, or be known as an access terminal (“AT”), a subscriber station, a subscriber unit, a mobile station, a remote station, a remote terminal, a user terminal, a user agent, a user device, user equipment, or some other terminology. In some implementations an access terminal can comprise a cellular telephone, a telephone, a Session Initiation Protocol (“SIP”) phone, a wireless local loop (“WLL”) station, a personal digital assistant (“PDA”), a handheld device, or some other suitable processing device connected to a modem. Accordingly, one or more aspects taught herein can be incorporated into a phone (e.g., a cellular phone or smartphone), a computer (e.g., a laptop), a portable communication device, a headset, a portable computing device (e.g., a personal data assistant), an entertainment device (e.g., a music or video device, or a satellite radio), a gaming device or system, a global positioning system device, an appliance, power generating/transmitting equipment, surveillance equipment (e.g., seismograph, smoke detector, Geiger counter, camera), smartmeter, vending machine or any other suitable device that is configured to communicate via a wireless or wired medium in a machine to machine fashion.

Some devices can be used for smart metering, in a smart grid network, or in smart appliances (e.g., appliances configurable in response to transmitted or detected signals). Such devices can provide sensor applications or be used in home automation. The devices can instead or in addition be used in a healthcare context, for example for personal healthcare. They can also be used for surveillance, to enable extended-range Internet connectivity (e.g. for use with hotspots), or to implement machine-to-machine communications.

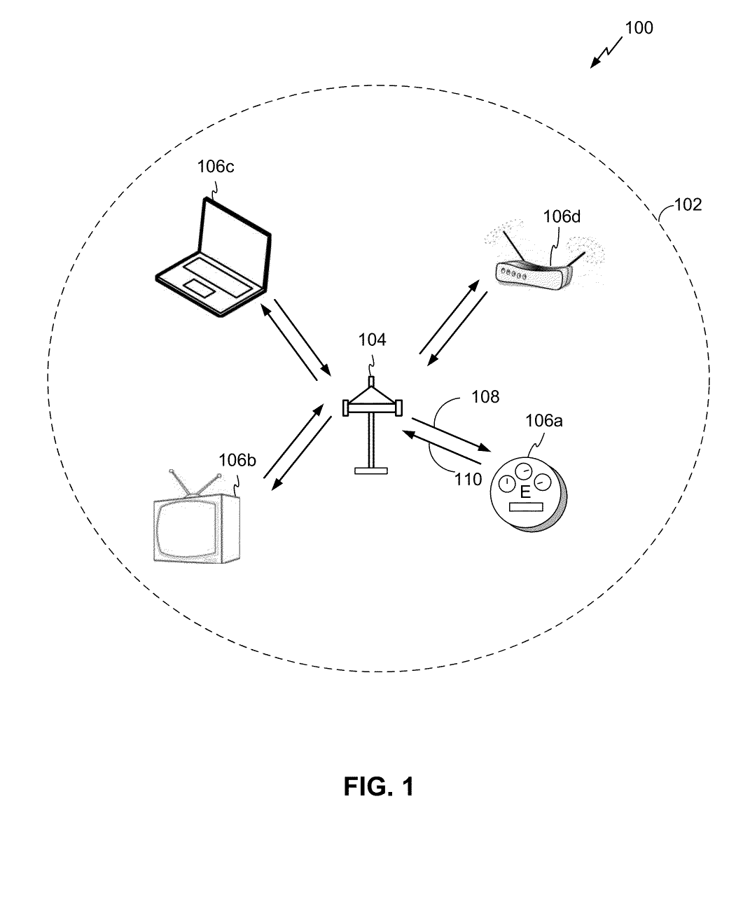

FIG. 1 shows an exemplary communication system. The communication system 100 can operate pursuant to a wireless standard. The communication system 100 can include an AP 104, which communicates with STAs such as a smart utility meter 106a, a television 106b, a computer 106c, or another access point 106d (individually or collectively hereinafter identified by 106).

A variety of processes and methods can be used for transmissions in the communication system 100 between the AP 104 and the STAs 106. For example, signals can be sent and received between the AP 104 and the STAs 106 in accordance with OFDM/OFDMA techniques. If this is the case, the communication system 100 can be referred to as an OFDM/OFDMA system. Alternatively, signals can be sent and received between the AP 104 and the STAs 106 in accordance with CDMA techniques. If this is the case, the communication system 100 can be referred to as a CDMA system. In some implementations, the signals between the AP 104 and the STAs 106 can be sent via a wired connections such as Ethernet, optical, cable, telephone, power line, and facsimile connections.

A communication link that facilitates transmission from the AP 104 to one or more of the STAs 106 can be referred to as a downlink (DL) 108, and a communication link that facilitates transmission from one or more of the STAs 106 to the AP 104 can be referred to as an uplink (UL) 110. Alternatively, a downlink 108 can be referred to as a forward link or a forward channel, and an uplink 110 can be referred to as a reverse link or a reverse channel.

The AP 104 can provide communication coverage in a basic service area (BSA) 102. The AP 104 along with the STAs 106 associated with the AP 104 and that are configured to use the AP 104 for communication can be referred to as a basic service set (BSS). It should be noted that the communication system 100 may not have a central AP 104, but rather can function as a peer-to-peer network between the STAs 106. Accordingly, the functions of the AP 104 described herein can alternatively be performed by an STA 106. For example, in some implementations, one or more STAs 106 can be located outside the BSA 102.

In implementations where the communication system 100 includes multiple STAs 106, the STAs 106 can compete for uplink 110 and downlink 108 resources. In CDMA implementations, for example, the STAs 106 can receive data from the AP 104 via a Forward Access Channel (F-ACH) of the downlink 108. Similarly, the STAs 106 can send data to the AP 104 via a Reverse Access Channel (R-ACH) of the uplink 110. The STAs 106 can access the R-ACH without explicit permission from the AP 104, and the AP 104 may not anticipate the transmission. Accordingly, the R-ACH can be referred to as a random multiple-access channel. The R-ACH can also be referred to as a contention channel because STAs 106 contend for communication resources, and simultaneous access attempts can result in collisions. In some implementations, the STAs 106 wait for a backoff period (i.e., an additional period of time in which the node wishing to transmit will not attempt to access the medium), based on an access restriction, before attempting retransmission. The access restriction can be, for example, a group-based APersistence value as described below. In an implementation, the AP 104 can wait for a relatively longer backoff period when access channel occupancy is relatively high, and can wait for a relatively shorter backoff period when access channel occupancy is relatively low. In an embodiment, the AP 104 can determine the backoff period probabilistically, based on the detected access channel occupancy.

In an implementation, the AP 104 can affect the backoff period by sending a message to one or more STAs 106. For example, in a CDMA implementation, the AP 104 can send an “Access Parameters Message” to one or more STAs 106 on a Forward Paging Channel (F-PCH).

In implementations where the STAs 106 are M2M devices, there can be many more devices in the communication network 100 than are typical of a traditional communication network. For example, there can be a smart electric meter for each house in a smart electric grid. Moreover, M2M devices can have unpredictable future usage patterns. For example, while smart electric meters can infrequently access the communication network 100, other applications (such as, for example, health monitors and car-to-car communicators, etc.) can cause increased access frequencies. Similarly, new web-based applications (such as, for example, social networking, cloud computing, etc.) can have unexpected ACH usage patterns. Furthermore, M2M communications can have unexpected correlations. For example, a network of seismographs can all attempt to transmit data simultaneously after a shared seismic event. Because of the unpredictable nature of M2M communications, and the tendency for M2M communications to have a small data payload, ACH throughput can be a bottleneck in M2M communication networks. Another potential bottleneck in M2M communication networks is the F-PCH. For example, the AP 104 can attempt to page every seismograph in an earthquake detection network simultaneously after a shared seismic event. In various embodiments herein, M2M communications can include or be referred to as machine-type communications (MTC).

In an implementation, contentious access to the communication network 100 can be managed by grouping M2M devices into one or more access control groups. For example, each STA 106 can be associated with one or more access control groups. In an embodiment, the AP 104 can address access control groups by sending an “Access Parameters Message” including an “M2M Group Based APersistence” field. In an embodiment, an APersistence value can indicate a probability with which the STA 106 can transmit during any particular time slot. Time slots can be any time frame. Likewise, a group-based APersistence value can indicate the probability with which an STA in an associated group can transmit. The AP 106 can determine one or more group-based APersistence values based on one or more inputs including the access control group associated with the STA 106, ACH occupancy, a ratio of un-served/served access attempts, an RL receiver rise over thermal (ROT) noise, FL packet queuing delays, a MAC index use rate, etc. The STA 106 can then apply the group-based APersistence value when determining the backoff period.

Although the access control is described herein with respect to HRPD terminology, one having ordinary skill in the art will appreciate that the access control can be applied to any communication technology including, for example, EVDO, UMTS, LTE, 1xRTT, and PPP systems.

In various implementations, the STAs 106 can be associated with the one or more access control groups based on factors such as, for example, latency/deferral tolerances, data-volume per data session, and/or device subscription level. In an implementation, the STA 106 (or a particular application executing on the STA 106) can be associated with a deferral tolerance indicative of a permitted latency of the STA 106 or application. In an embodiment, the STAs 106 and/or applications can convey their deferral tolerance by providing a latency preference to the AP 104. For example, the STAs 106 can transmit a latency preference message indicating a delay tolerance to the AP 104. In an embodiment, the AP 104 can include a database of latency preferences for one or more STAs 106 and/or applications. In an embodiment, the AP 104 can deduce deferral tolerance by observing communications from the STAs 106.

Delay tolerant applications can be grouped together, and delay intolerant applications can be grouped together. In an implementation, the STAs 106 having applications that generate high-data-volume per data session can be grouped together and the STAs 106 having applications that generate low-data-volume per data session can be grouped together. In an implementation, the STAs 106 or applications can be grouped based on a subscription level. For example, high-priority subscriptions can be grouped together for more expensive subscription packages, whereas low-priority subscriptions can be grouped together for less expensive subscription packages. In various embodiments, access control groups can be referred to as “classes.” Table 1, below, illustrates exemplary access control group assignments according to one implementation.

TABLE 1

| Group | Description | Example Application |
|---|---|---|
| 0 | (Reserved) | |
| 1 | Extremely low deferral | Smart highway M2M |
| | tolerance (~50 ms) | |
| 2 | Low deferral tolerance | Advanced medical M2M |
| | (~200-500 ms) | |
| 3 | Human scale deferral tolerance | Human-interactive |
| | (~1-2 s) | applications |
| 4 | Deferral tolerance ~30-60 s | Inventory control |
| 5 | Deferral tolerance ~15 min. | Calendar update |
| 6 | Deferral tolerance >1 hr | Utility meters |
| 7-8 | (Reserved) | |
| 9 | X % access deferral probability | Premium users (gold) |
| | in excess of Y s | |
| 10 | W % access deferral probability | Medium expediency |
| | in excess of Z s | |
| 11 | (Reserved) | |

As shown in Table 1, above, Group 0 can be reserved for future use. Group 1 can include applications with extremely low deferral tolerance (for example, applications that can tolerate latency of around 50 ms). An example of an application with extremely low deferral tolerance includes smart highway M2M. In an implementation, one car can adjust its speed based on communications from the car in front of it. Accordingly, safety considerations can give smart highway applications a relatively high priority.

Group 2 can include applications with relatively low deferral tolerance (for example, applications that can tolerate latency of around 200 ms to around 500 ms). An example of an application with low deferral tolerance includes advanced medical M2M. In an implementation, a health monitor can relay vital signs to a health professional. Accordingly, safety considerations can give advanced medical applications a relatively high priority.

Group 3 can include applications with human-scale deferral tolerance (for example, applications that can tolerate latency of around 1 second to around 2 second.). An example of an application with human-scale deferral tolerance includes human-interactive applications such as, for example, a remote thermometer display that might be watched by a human.

Group 4 can include applications that can tolerate latency of around 30 seconds to around 60 seconds such as, for example, an inventory control application. Group 5 can include applications that can tolerate latency on the order of around 15 minutes such as, for example, a calendar update application. Group 6 can include applications that can tolerate latency on an order greater than around 1 hour such as, for example, a utility meter application. Groups 7 and 8 can be reserved for future use.

A subset of the access control groups can be determined based on subscription factors. For example, as shown in Table 1, Groups 1-8 do not include subscription factors, whereas Groups 9-11 can include subscription factors. Group 9 can include applications associated with premium account subscriptions (for example, “gold,” “silver,” etc.). In an implementation, Group 9 communications can have a first probability (X %) of access deferral in excess of a first threshold (Y seconds).

Group 10 can include applications associated with a medium expediency account subscription. In an implementation, Group 10 communications can have a second probability (W %) of access deferral in excess of a second threshold (Z seconds). In an implementation, the first probability (X %) can be lower than the second probability (Y %). In an implementation, the first threshold (Y seconds) can be lower than the second threshold (Z seconds). Group 11 can be reserved for future allocation.

User devices can be preconfigured with class assignments. Classes, defined for example, by M2M category or group IDs, can be assigned via M2M service registration and request. The M2M category can be smart grid, health care, etc. The M2M group ID can be assigned for each M2M group including category information. For example Group ID1 can be San Diego Gas and Electric (SDGE) meter readers. Categories/group IDs can be assigned to devices through a paging message, for example, under CMAS-indication, CMAS-indication-Group-X and CMAS-indication-Group-Y can be added. In another example, M2M-Indication and M2M-Indication-Group x can be added and a new SIB for M2M introduced. In yet another example, eMBMS-indication or further eMBMS-indication-Group-x and eMBMS-indication-Group-y (currently systemInfoModification indicates any broadcast control channel (BCCH) modification other than SIB10/11/12) can be added.

As mentioned above, in order to multicast/broadcast data to a group of user devices, the devices are associated with an M2M class, i.e., a category having one or more associated groups, sub-groups and/or sub-sub groups, corresponding to data intended for receipt by the group of UEs. Within each category a hierarchy of group IDs can exist. For example, as shown in the table below, M2M categories can include consumer electronics (CE), healthcare, automotive and metering. Each category has an assigned group ID. A group ID can have one or more associated sub-group IDs and a sub-group ID can have one or more associated sub-sub-group IDs.

TABLE 2

| M2M | | | |
|---|---|---|---|
| Categories | Group ID | Sub-Group ID | Sub-Sub-GroupID |
| Consumer | M2M-CE | M2M-CE-Alarms | |
| Electronics | | M2M-CE-Cameras | |
| | | M2M-CE-Tracking | |
| | | M2M-CE-Gadget | |
| Healthcare | M2M- | M2M-Health- | |
| | Health | WWANGateway | |
| | | M2M-Health- | |
| | | EmbeddedWWAN | |
| | | M2M-Health- | |
| | | Smartphone | |
| | | M2M-Health- | |
| | | CareProvider | |
| Automotive | M2M-Auto | M2M-Auto-Telematics | |
| | | M2M-Auto-HeadUnit | |
| | | M2M-Auto- | |
| | | EVChargers | |
| Metering | M2M- | M2M-Meter-Home | M2M-Meter-Home- |
| | Meter | M2M-Meter- | Electric |
| | | Enterprise | |
| | | M2M-Meter- | M2M-Meter-Home- |
| | | Commercial | Gas |
| | | | M2M-Meter-Home- |
| | | | Water |

A user device can be associated with one or more group IDs, sub-group IDs or sub-sub-group IDs such that the device is set up to receive broadcast/multicast data corresponding to one or more of the IDs. For ease in further description, the term “group ID,” is intended to encompass all levels of ID, including group, sub-group and sub-sub-group.

Group IDs can be allocated by an operator or a service provider. For example, in the case of an operation, mobile country code/mobile network code (MCC/MNC) can be included in group ID, and in the case of a service provider, MCC/Service provider ID can be included in Group ID. Group IDs can also be allocated by a M2M international forum, such as OneM2M.

Group ID assignment to user devices can occur through preconfiguration or through online assignment. In the case of preconfiguration, a device can register its group ID with an M2M server during M2M service registration. In cases of online assignment, the M2M server can assign a group ID to the device during M2M service registration. Also, an operator can assign a group ID during attach procedures, in which case the device subsequently registers its assigned group ID with the M2M server during M2M service registration.

In some embodiments, many small M2M devices can need to be woken up at the same time. For example, a utility company can be requesting the devices to upload their current measurement data, or a utility company can want the devices to act on a load shedding demand/response request, e.g. to turn off power hungry appliances such as air conditioners or dishwashers. A broadcast paging mechanism is desirable as unicast paging for each individual device can consume significant network resources.

Utility companies can need to have the capability to send a broadcast message to a group of M2M nodes (e.g. in the smartgrid). In this case, a broadcast message needs to reach intended devices. A response from the devices can or may not be necessary. For example, if the broadcast message relates to a pricing update, a unicast response from the devices is not needed. Alternatively, unicast acknowledgement can be desired (e.g. for D/R situations) within in a certain timeframe. Such acknowledgement can include an ACK indicating a full response is being processed (optional) or an ACK indicating an actual full response. In both cases a time period within which to respond is provided, with full responses having a longer timeframe. Responses, whether only indicating a full response is being processed or indicating a full response, can flood the network and therefore need to be managed well.

Definition of a group of nodes for a utility can be different from a group of nodes within a cellular network. In one case, one utility group corresponds to nodes across multiple cells typically. In the other case, one utility group corresponds to a subset of nodes within a cell.

Enhancements to the MTC server provide Broadcast Service Coordination capability to deliver broadcasts to many M2M devices. The enhanced MTC server: maintains a mapping between utility group(s) and cellular group(s); maintains a list of serviced devices for each utility group; enables different types of broadcast services, such as pricing update, D/R etc.; crafts a broadcast message indicating specific broadcast service and an (absolute) response time (if ACK is desired); creates a header to indicate a coarse indication of type of broadcast message acceptable by the WWAN, for example this can just be a broadcast message with ACK, a broadcast message with no ACK desired, can also indicate that this is a smartgrid-related message.

The enhanced MTC server also: submits messages to cellular network; derives a list of intended devices (from a service perspective) intended to be reached; waits for service layer unicast acknowledgements/responses from intended target devices; maintains a list of devices that have responded if response is desired; retargets broadcast groups or nodes that have not responded; and sends an update to utility company on efficacy of the broadcast request.

In an exemplary broadcasting implementation, a network (WWAN) sends a broadcast page to a group of devices. The page includes a generic group classification identifier associated with an M2M device (C1). The page also provides a staggered time duration (T1) during which a response from the M2M device is desired by the network. The network can rebroadcast the page multiple times to increase the efficiency of the broadcast. The page also includes a broadcast transaction identifier (B1) which is reused if the page is rebroadcast. The three-tuple (B1, C1, and T1) constitutes the broadcast page request. The network waits for a response from the M2M devices within the time frame suggested

If some of M2M devices do not respond within the time frame, the network can send a new broadcast page with a new broadcast transaction identifier and a new time duration for response. This new page can be rebroadcast multiple times as well to increase the efficiency of the broadcast. Different classes of M2M devices can be targeted with different time durations, where higher priority devices have to respond over a shorter duration, and lower priority devices have to respond over an extended time duration. For example, a multi-class broadcast message can consist of (B1, C1, T1, C2, T2, C3, T3, . . . ), where T is time and T1<T2<T3. Devices of class C1 have to respond within time T1. Devices of class C2 have to respond within time T2 and can respond only in the time T2−T1 for example. Devices of class C3 have to respond within time T3 and can respond only in the time T3−T2 for example. Finally, an optional unicast session can be utilized by the network to reach out to each M2M device that has not responded to the broadcast page attempts

With respect to an M2M device, it receives the broadcast page and identifies that the device classification identifier in the page matches its classification identifier. The device identifies the time duration during which its response is desired. For a multi-class broadcast page, the device identifies the time frame during which its response is desired, e.g., T3−T2 for device class C3. The device selects a random time for transmission within the time frame identified for response. The device communicates back to the network at that random time. If a failure in transmission occurs, the device attempts again at a random time in the remaining time left. If the device fails to communicate within the time allocated, it waits for a new broadcast page from the network with a new broadcast identifier. Alternatively the device waits for a unicast page specific for the device.

With respect to unicast responses, devices can respond over RACH picking a transmission time randomly within their allocated staggered time interval. Devices that received information but which are attempting repair can report their status, for example, as follows: received message, attempting repair; or received message, repair successful. Devices that did not receive any information and which did not receive the broadcast message can be targeted again by the MTC server in a subsequent broadcast message. Different subgroups of devices can target different repair servers to distribute the load on the repair servers when multiple subgroups are targeted simultaneously. Different subgroups of devices can be targeted in different time intervals to alleviate the unicast response congestion load on the network.

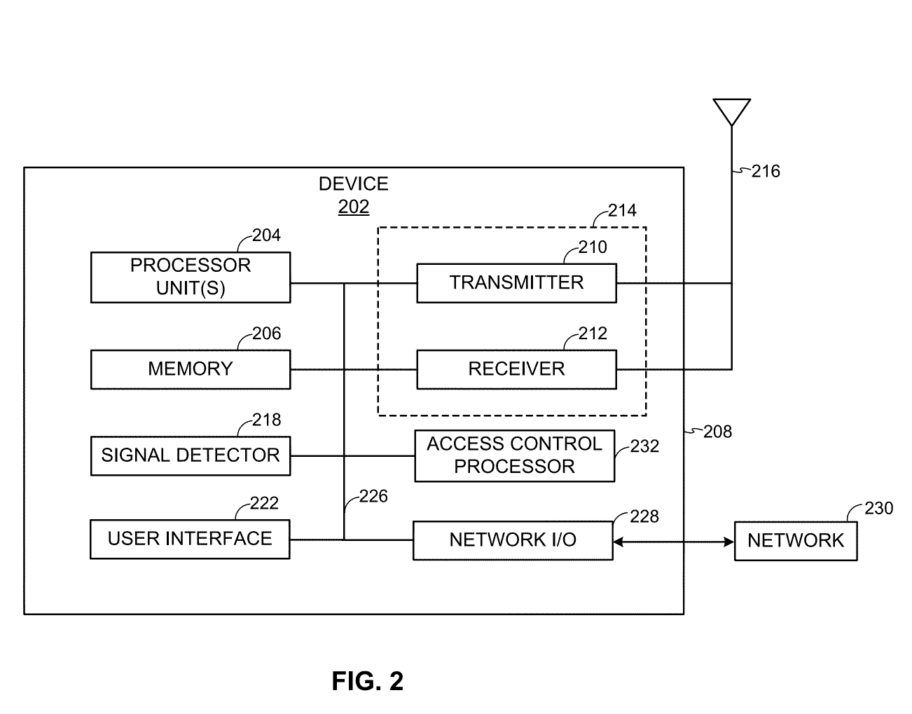

FIG. 2 shows a functional block diagram of an exemplary a device that can be employed within the communication system of FIG. 1. The device 202 is an example of a device that can be configured to implement the various methods described herein. For example, the device 202 can include the AP 104 or one of the STAs 106.

The device 202 can include processor unit(s) 204 which control operation of the device 202. One or more of the processor unit(s) 204 can be collectively referred to as a central processing unit (CPU). Memory 206, which can include both read-only memory (ROM) and random access memory (RAM), provides instructions and data to the processor units 204. A portion of the memory 206 can also include non-volatile random access memory (NVRAM). The processor unit(s) 204 can be configured to perform logical and arithmetic operations based on program instructions stored within the memory 206. The instructions in the memory 206 can be executable to implement the methods described herein.

When the device 202 is implemented or used as a transmitting node, the processor unit(s) 204 can be configured to select one of a plurality of packet formats, and to generate a packet having that format. For example, the processor unit(s) 204 can be configured to generate data packets. When the device 202 is implemented or used as a receiving node, the processor unit(s) 204 can be configured to process received packets. The processor unit(s) 204 generate a packet for transmission to one or more STAs 106. A packet includes a series of data bits representing the data being exchanged between an AP 104 and a STA 106.

The processor unit(s) 204 can be implemented with any combination of general-purpose microprocessors, microcontrollers, digital signal processors (DSPs), field programmable gate array (FPGAs), programmable logic devices (PLDs), controllers, state machines, gated logic, discrete hardware components, dedicated hardware finite state machines, or any other suitable entities that can perform calculations or other manipulations of information. In an implementation where the processor unit(s) 204 include a DSP, the DSP can be configured to generate a packet for transmission. In some aspects, the packet can include a physical layer data unit (PLDU).

The device 202 can also include machine-readable media for storing software. The processor unit(s) 204 can include one or more machine-readable media for storing software. Software shall be construed broadly to mean any type of instructions, whether referred to as software, firmware, middleware, microcode, hardware description language, or otherwise. Instructions can include code (e.g., in source code format, binary code format, executable code format, or any other suitable format of code). The instructions, when executed by the processor unit(s) 204, cause the wireless device 202 to perform the various functions described herein.

The device 202 can include a transmitter 210 and/or a receiver 212 to allow transmission and reception, respectively, of data between the device 202 and a remote location. The transmitter 210 and receiver 212 can be combined into a transceiver 214. An antenna 216 can be electrically coupled with the transceiver 214. The device 202 can also include (not shown) multiple transmitters, multiple receivers, multiple transceivers, and/or multiple antennas.

The transmitter 210 can be configured to wirelessly transmit packets and/or signals. For example, the transmitter 210 can be configured to transmit different types of packets generated by the processor unit(s) 204, discussed above. The packets are made available to the transmitter 210. For example, the processor unit(s) 204 can store a packet in the memory 206 and the transmitter 210 can be configured to retrieve the packet. Once the transmitter 210 retrieves the packet, the transmitter 210 transmits the packet to the device 202 via the antenna 216.

The transmitter 210 can be configured to wirelessly transmit messages, which can be referred to as “paging messages” that are configured to indicate to wireless devices whether or not the wireless devices need to wake up from a doze state and enter an awake state as discussed below. For example, the transmitter 210 can be configured to transmit paging messages generated by the processor 204, discussed above. When the wireless device 202 is implemented or used as a STA 106, the processor 204 can be configured to process paging messages. When the wireless device 202 is implemented or used as an AP 104, the processor 204 can also be configured to generate paging messages.

The antenna 216 on the device 202 can detect the transmitted packets/signals. The receiver 212 can be configured to process the detected packets/signals and make them available to the processor unit(s) 204. For example, the receiver 212 can store the packet in memory 206 and the processor unit(s) 204 can be configured to retrieve the packet.

The device 202 can also include a signal detector 218 that can be used in to detect and quantify the level of signals received by the transceiver 214. The signal detector 218 can detect such signals as total energy, energy per subcarrier per symbol, power spectral density, and other signals.

In the example implementation shown in FIG. 2, the device 202 includes a network input/output 228. The network input/output 228 can be configured to communicate via a wired means with a network 230. The network input/output 228 can be used to communicate with one or more devices (e.g., STA 106, AP 108). The network input/output 228 can be configured to communicate via wired connections such as Ethernet, optical, cable, telephone, power line, and facsimile connections.

The network input/output 228 of the device 202 can detect the transmitted packets/signals. The device 202 can be configured to process the detected packets/signals and make them available to the processor unit(s) 204. For example, the network input/output 228 can store the packet in the memory 206 and the processor unit(s) 204 can be configured to retrieve the packet from the memory 206 and process the packet.

In some aspects, the device 202 can further include a user interface 222. The user interface 222 can include a keypad, a microphone, a speaker, and/or a display. The user interface 222 can include any element or component that conveys information to a user of the device 202 and/or receives input from the user. The device 202 can also include a housing 208 surrounding one or more of the components included in the device 202.

The device 202 can also include an access control processor 232. The access control processor 232 can be configured to perform group based access control. For example, when the device 202 is configured as a STA 106, the access control processor 232 can receive a group-based access control from the AP 104, via the receiver 212. In an embodiment, the group-based access control can include an “Access Parameters Message” including a group-based APersistence field. The access control processor 232 can store the group-based access control in the memory 206.

The access control processor 232 can also store information about an associated group in the memory 206. For example, the STA 106 can be associated with one or more M2M groups based on access control factors such as, for example, deferral tolerances, data-volume per data session, and/or subscription level, as discussed above. In an implementation, the access control processor 232 can receive the group association from the AP 104 via the receiver 212. In another implementation, the device 202 can be pre-programmed with one or more group associations. For example, a wireless carrier can provision the device 202 with one or more M2M group associations, which can be stored in the memory 206. In another implementation, the access control processor 232 can determine the one or more group associations, for example based on one or more of the access control factors discussed above.

When the STA 106 attempts to access the communication network 106, in case of congestion indicated by corresponding APersistence value, the access control processor 232 can delay a subsequent access attempt for the associated access control group. For example, the access control processor 232 can determine a backoff period based on an associated M2M group. In an implementation, the access control processor 232 can determine the backoff period based on the group-based APersistence value received from the AP 104 via the receiver 212. For example, the access control processor 232 can retrieve the group-based APersistence value from the memory 206, generate a pseudorandom number, and compare the pseudorandom number to the APersistence value. In an implementation, the access control processor 232 can continue to compare pseudorandom numbers to the APersistence value until the pseudorandom number is greater than the APersistence value.

After the backoff period, the access control processor 232 can reattempt transmitting on the R-ACH via the transmitter 210. In an implementation, the APersistence value can be a vector including multiple APersistence values. The access control processor 232 can be configured to compute an APersistence value based on, for example, one or more of the access control group associated with the STA 106, the ACH occupancy, a ratio of un-served/served access attempts, an RL receiver rise over thermal (ROT) noise, FL packet queuing delays, and a MAC index use rate.

When the device 202 is configured as an AP 104, the access control processor 232 can transmit the group-based access control to the STA 106, via the transmitter 210. In an embodiment, the group-based access control can include an “Access Parameters Message” including a group-based APersistence field. The access control processor 232 can retrieve the group-based access control from the memory 206, and transmit it to the STA 106 via the transmitter 210. As discussed in greater detail below, the access control processor 232 can continually or intermittently recompute new group-based access control (for example, an APersistence value) based on refreshed access node statistics, and retransmit the group-based access control (via the transmitter 210) in a dynamic loop.

In an implementation, the access control processor 232 can send a provisioning message to the STA 106 via the transmitter 210. The provisioning message can assign one or more access control groups to the STA 106. In an implementation, the access control processor 232 can assign one or more M2M groups to the STA 106 based on access control factors such as, for example, deferral tolerances, data-volume per data session, and/or subscription level, as discussed above.

In an implementation, the access control processor 232 can send one or more paging messages to the STAs 106 via the transmitter 210. The access control processor 232 can prioritize the paging messages based on the access control groups associated with each STA 106, for example, when the F-PCH is congested. For example, the access control processor 232 can transmit paging messages for higher priority M2M groups with a shorter delay, and can transmit paging messages for lower priority M2M groups with a longer delay.

In an implementation, the access control processor 232 can retrieve a list of access control group associations stored in the memory 206, determine a delay to apply to each paging message based on the access control group of the STA 106 to which the message is addressed, and to transmit the paging message via the transmitter 210 after the delay. Although the paging delay is described herein as being applied by the AP 104, the paging delay can be applied by any aspect in the communication network 100 including, for example, an RAN, a core network, an M2M IWF, and/or an M2M server.

The access control processor 232 can also apply a variable paging delay to messages destined for the STAs 106 associated with the same access control group. In an implementation, the access control processor 232 can apply a random or pseudorandom delay to paging messages within an M2M group, for example, when there is a high volume of paging activity destined for a single M2M group. In an implementation, this intra-group delay can be based on additional factors such as, for example, deferral tolerances.

In some implementations, the STA 106 can provide information to allow the network to identify a subscription for the STA 106. For example, a smartmeter can access a network under a subscription with a service provider. The access control processor 232 included in the smartmeter can be configured to include the subscription number as part of a power up registration request. In some implementations, the access control processor 232 can provide information to allow the AP 104 to identify the subscription associated with the smartmeter (e.g., UUID, customer ID). In these implementations, the access control processor 232 at the AP 104 can determine the subscription based on the received information.

The various components of the device 202 can be coupled together by a bus system 226. The bus system 226 can include a data bus, for example, as well as a power bus, a control signal bus, and a status signal bus in addition to the data bus. Those of skill in the art will appreciate the components of the device 202 can be coupled together or accept or provide inputs to each other using some other mechanism.

Although a number of separate components are illustrated in FIG. 2, those of skill in the art will recognize that one or more of the components can be combined or commonly implemented. For example, the processor unit(s) 204 can be used to implement not only the functionality described above with respect to the processor unit(s) 204, but also to implement the functionality described above with respect to the access control processor 232 and/or the signal detector 218. Further, each of the components illustrated in FIG. 2 can be implemented using a plurality of separate elements.

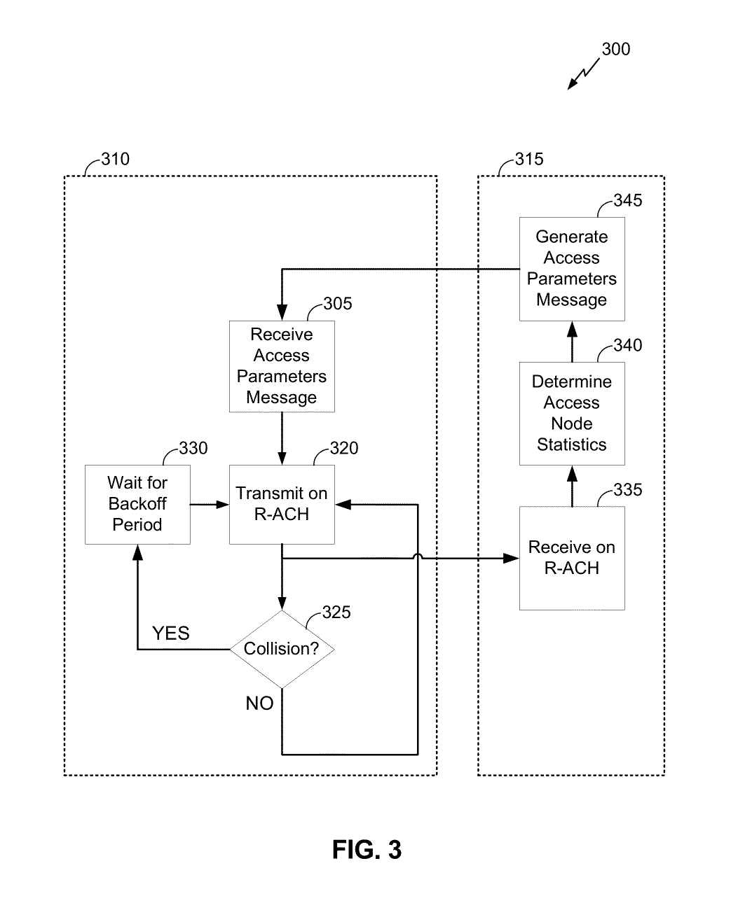

FIG. 3 shows a process flow diagram 300 of an exemplary machine to machine access control process for a wireless communication system. In the example shown, at block 305, a device 310, such as a machine-to-machine STA 106, can receive the access parameters message from an AP 315. As discussed above, in an embodiment, the access parameters message can include an APersistence value. In an implementation, the AP 315 can be, for example, the AP 104 described above with respect to FIG. 1.

Next, at block 320, the device 310 attempts to transmit on the R-ACH. Then, at block 325, the device 310 determines whether there was a collision when transmitting on the R-ACH. If there is a collision, the device 310 continues to block 330. At block 330, the device 310 waits for a backoff period. The backoff period can be based on the access parameters message and an access control group associated with the device 310. After the backoff period, the device 310 can reattempt transmission on the R-ACH at block 320. If the transmission is successful, the device 310 can continue to block 320, at which it can again transmit on the R-ACH when additional data is available.

At block 335, the AP 315 receives the transmission from the device 310 on the R-ACH. Next, at block 340, the AP 315 can determine one or more access node statistics. In various embodiments, the access node statistics can include one or more of the access control group associated with the STA 106, the ACH occupancy, a ratio of un-served/served access attempts, an RL receiver rise over thermal (ROT) noise, FL packet queuing delays, and a MAC index use rate. Then, at block 345, the AP 315 can generate an access parameters message based on the access node statistics and/or the access control group associated with the device 310. The AP 315 can transmit the access parameters message (which can include the APersistence value) to the device 310, thereby completing a closed access control loop. Accordingly, in an embodiment, the AP 315 can continually or intermittently monitor access channel congestion, recompute an APersistence value, and re-transmit the recomputed APersistence value to the device 310.

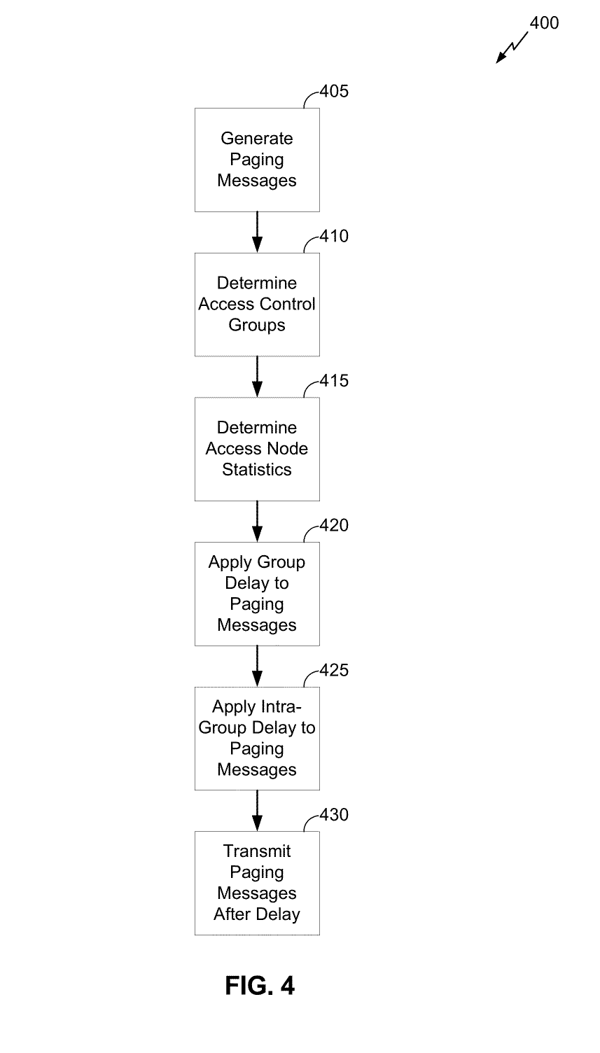

FIG. 4 shows a process flow diagram 400 of another exemplary machine to machine access control process for a wireless communication system. In the example shown, at block 405, a device, such as the AP 106, can generate one or more paging messages. The paging messages can be addressed to various STAs 106, each of which can be associated with one or more access control groups. Next, at block 410, the AP 106 determines the access control group associated with the STA 106 to which each paging message is addressed. The access control groups can be determined based on factors such as, for example, latency/deferral tolerances, data-volume per data session, and/or device subscription level.

Thereafter, at block 415, the AP 106 can determine one or more access node statistics. In an embodiment, the access node statistics can indicate a congestion level of the access channel. In various embodiments, the access node statistics can include one or more of the access control group associated with the STA 106, the ACH occupancy, a ratio of un-served/served access attempts, an RL receiver rise over thermal (ROT) noise, FL packet queuing delays, and a MAC index use rate.

Then, at block 420, the AP 106 applies a group delay to each paging message based on one or more of the access control groups determined at block 410, the access node statistics determined at block 415, mean downlink queuing delay, etc. For example, the AP 106 can apply a relatively short delay to paging messages addressed to STAs 106 associated with a relatively high priority group (such as Group 1 shown in Table 1). On the other hand, the AP 106 can apply a relatively long delay to paging messages addressed to STAs 106 associated with a relatively low priority group (such as Group 6 shown in Table 1).

As another example, for a least delay tolerant group G1, there can be no paging delay. For a more delay tolerant group G2, the group delay can be a predetermined factor X2 times the DL queuing delay. Similarly, for an even more delay tolerant group G3, the group delay can be a predetermined factor X3 times the DL queuing delay, and so on. The factor X3 can be greater than the factor X2.

Subsequently, at block 425 the AP 106 can apply an intra-group delay to one or more paging messages addressed within a group. In an embodiment, the AP 106 can apply intra-group delays, for example, when the number of paging messages to be sent, or a number of paging messages to be sent per unit time, is greater than a threshold. In another embodiment, the AP 106 can apply intra-group delays, for example, when two paging messages within a group have the same page trigger time of arrival at the STA 106. In an embodiment, the AP 106 can compute individual delays for paging messages on a random or pseudorandom basis. In an embodiment, the AP 106 can delay paging messages within a group on a First-Come-First-Served (FCFS) basis. The intra-group delays can be relatively short, compared to the group-based delays discussed above. In an embodiment, the AP 106 may not apply intra-group delays.

Next, at block 430, the AP 106 transmits the paging messages after the delay assigned to each paging message. Accordingly, if there is congestion, the AP 106 transmits paging messages addressed to STAs associated with high-priority access control groups with lower delay, and transmits paging messages addressed to STAs associated with low-priority access control groups with higher delay.

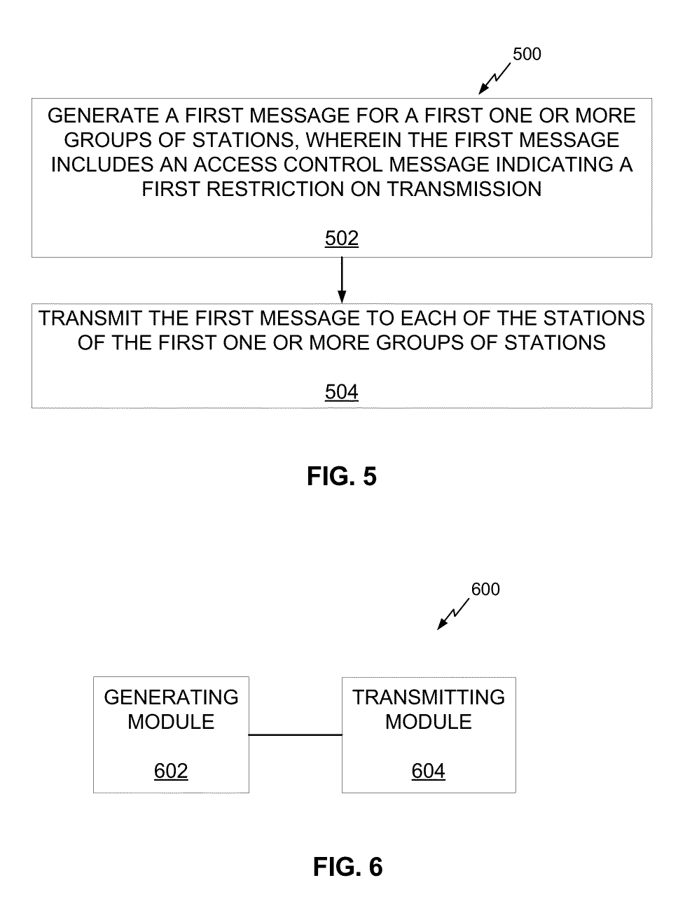

FIG. 5 shows a flowchart for an exemplary method 500 of access control within the communication system 100 of FIG. 1. One or more of the apparatuses described herein can be configured to implement the method shown in FIG. 5. An AP 104 can be configured to implement the method shown in FIG. 5. Although the method 500 is described herein with reference to the AP 104, a person having ordinary skill in the art will appreciate that the method 500 can be implemented by and/or any other suitable device. Moreover, although the method 500 is described herein with reference to a particular order, in various embodiments, blocks herein can be performed in a different order, or omitted, and additional blocks can be added.

First, at block 502, the AP 104 generates a first message for a first one or more groups of stations. The first message includes an access control message indicating a first restriction on transmission. The first restriction is based on one or more of a latency preference, a data volume per data session, and/or a subscription level associated with each of the plurality of stations. Next, at block 504, the AP 104 transmits the first message to each of the stations of the first one or more groups.

FIG. 6 shows a functional block diagram of another exemplary device 600 that can be employed within the communication system 100 of FIG. 1. Those skilled in the art will appreciate that a wireless communication device can have more components than the simplified wireless communication device 600 shown in FIG. 6. The wireless communication device 600 shown includes only those components useful for describing some prominent features of certain implementations. The wireless communication device 600 includes a generating module 602 and a transmitting module 604.

In some implementations the generating module 602 is configured to generate a first message for a first one or more groups of stations. The first message includes an access control message indicating a first restriction on transmission. The first restriction is based on one or more of a latency preference, a data volume per data session, and/or a subscription level associated with each of the plurality of stations. The generating module 602 can be configured to implement the block 502, described above with respect to FIG. 5. The generating module 602 can include means for generating. The generating module 602 can include one or more of the processor 204, the access control processor 232, and/or the memory 206, described above with respect to FIG. 2.

The transmitting module 604 can be configured to transmit the first message to each of the stations of the first one or more groups. The transmitting module 604 can be configured to implement the block 504, described above with respect to FIG. 5. The transmitting module 604 can include means for transmitting. The transmitting module 604 can include one or more of the processor 204, the access control processor 232, the memory 206, the network I/O 228, and/or the transmitter 210, described above with respect to FIG. 2.

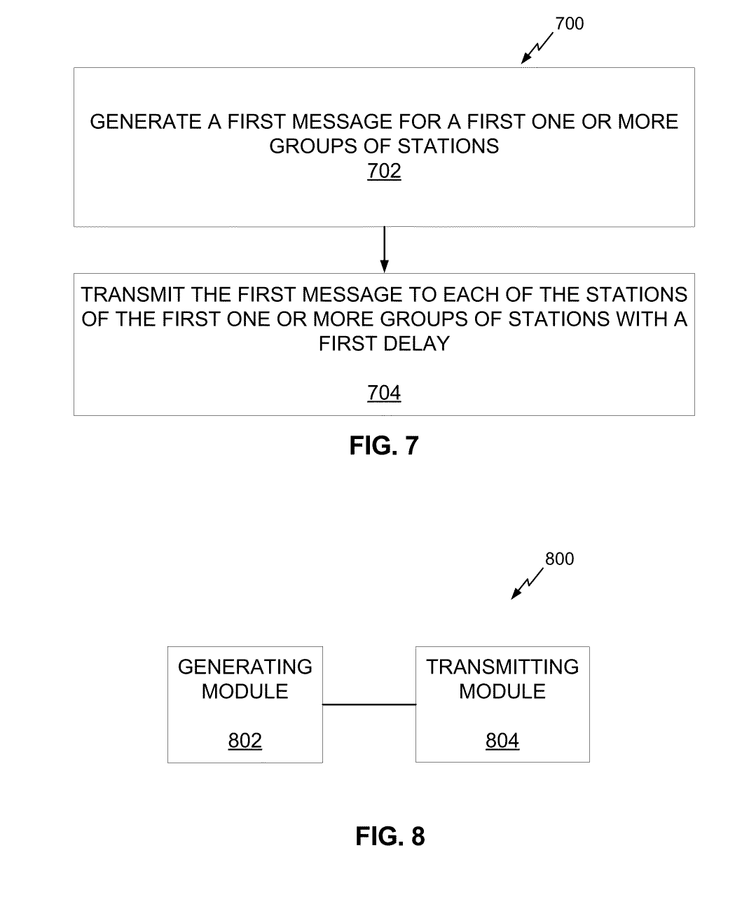

FIG. 7 shows a flowchart for another exemplary method 700 of access control within the communication system 100 of FIG. 1. One or more of the apparatuses described herein can be configured to implement the method shown in FIG. 7. For example, the AP 104 can be configured to implement the method shown in FIG. 7. Although the method 700 is described herein with reference to the AP 104, a person having ordinary skill in the art will appreciate that the method 700 can be implemented by and/or any other suitable device. Moreover, although the method 700 is described herein with reference to a particular order, in various embodiments, blocks herein can be performed in a different order, or omitted, and additional blocks can be added.

First, at block 702, the AP 104 can be configured to generate a first message for a first one or more of the groups of stations. Next, at block 704, the AP 104 can transmit the first message to each of the stations of the first one or more groups with a first delay. In an implementation, the first delay is based on one or more of a latency preference, a data volume per data session, and/or a subscription level associated with each of the plurality of stations.

FIG. 8 shows a functional block diagram of another exemplary device 800 that can be employed within the communication system 100 of FIG. 1. Those skilled in the art will appreciate that a wireless communication device can have more components than the simplified wireless communication device 800 shown in FIG. 8. The wireless communication device 800 shown includes only those components useful for describing some prominent features of certain implementations. The wireless communication device 800 includes a generating module 802 and a transmitting module 604.

In some implementations the generating module 802 is configured to generate a first message for a first one or more of the groups of stations. The generating module 802 can be configured to implement the block 702, described above with respect to FIG. 7. The generating module 802 can include means for generating. The generating module 802 can include one or more of the processor 204, the access control processor 232, and/or the memory 206, described above with respect to FIG. 2.

The transmitting module 804 can be configured to transmit the first message to each of the stations of the first one or more groups with a first delay. In an implementation, the first delay is based on one or more of a latency preference, a data volume per data session, and/or a subscription level associated with each of the plurality of stations. The transmitting module 804 can be configured to implement the block 704, described above with respect to FIG. 7. The transmitting module 804 can include means for transmitting. The transmitting module 804 can include one or more of the processor 204, the access control processor 232, the memory 206, the network I/O 228, and/or the transmitter 210, described above with respect to FIG. 2.

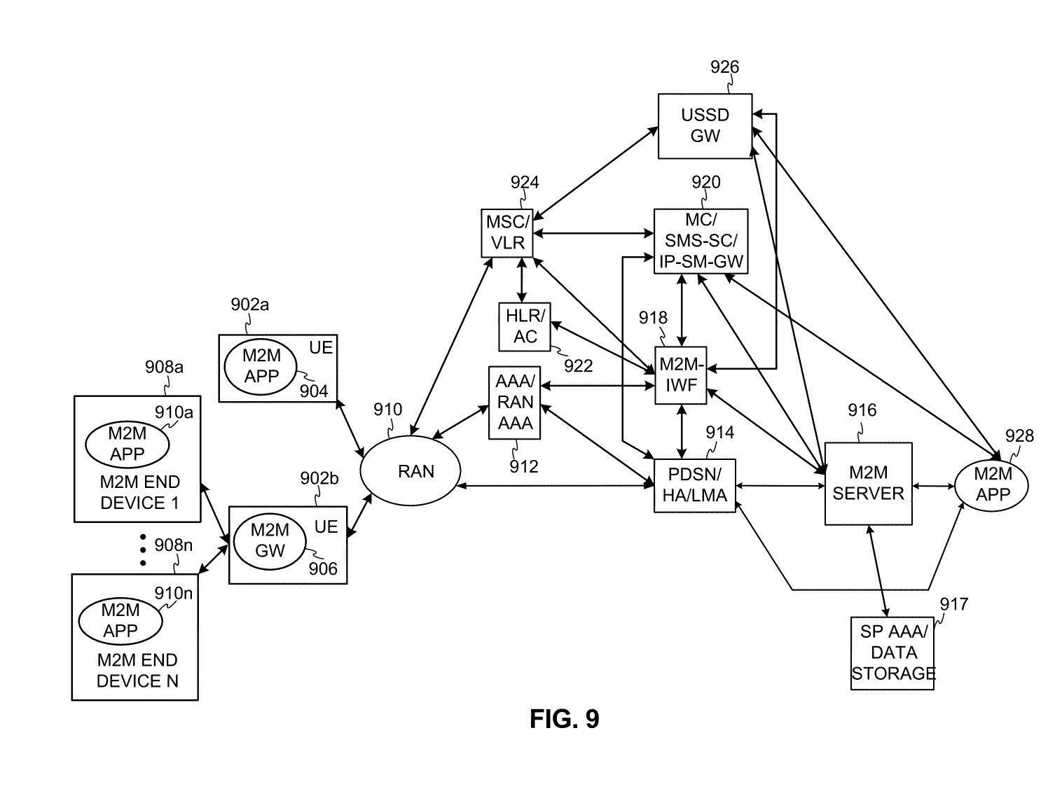

FIG. 9 shows an interaction diagram for various aspects of a communication system. The system 900 includes two user equipment (UE) devices 902a and 902b (collective or individually hereinafter identified as 902). In some implementation, the user equipment devices 902 can be implemented as local access points. The user equipment 902a includes a machine to machine application (M2M APP) 902a. This machine to machine application 904 can be configured to communicate with a machine to machine application 928.

The user equipment 902b shown in FIG. 9 includes a machine to machine gateway (M2M GW) 906. The machine to machine gateway 906 can include one or more of the elements shown in FIG. 2 to allow machine to machine devices to connect to the user equipment 902b. In the implementation shown, machine to machine device 908a and machine to machine device 908n (collectively or individually hereinafter identified as 908) are coupled with the user equipment 902b. As discussed above, this coupling can be wired (e.g., Ethernet, power-line, coaxial, fiber optic) or wireless (e.g., Zigbee, WLAN, Bluetooth). Machine to machine device 908a and machine to machine device 908n include machine to machine application 910a and machine to machine application 910n, respectively. Although not shown, a machine to machine device 908 can include more than one machine to machine application.

When the machine to machine device 908 connects with the user equipment 902b, the machine to machine device 908 can transmit registration information to attach to the user equipment 902b. The registration information can include one or more of a device class and a device identifier associated with the machine to machine device 908. For example, the device identifier can include a media access control (MAC) identifier, or a service provider unique identifier.

The user equipment 902 can be configured to couple with a radio access network (RAN) 910. The radio access network 910 can implement LTE, cdma2000, 1x, or other radio access technology. As part of the coupling, the user equipment 902 can be configured to transmit a local host identifier to the RAN 910 which can be used to route traffic to the user equipment 902.

The user equipment 902b can be further configured to assign a device connection identifier to each machine to machine device 908 connected with the user equipment 902b. In some implementations, the assignment can be performed at the machine to machine application level. The machine to machine gateway 906 can use this assignment information to send data to and receive data from the machine to machine device 908. For example, the machine to machine gateway 906 can ensure the packets include the device connection information prior to transmission to the RAN 910. On the receiving end, when a packet is received from the RAN 910, a portion of the packet (e.g., header field) can be interrogated to obtain the device connection identifier associated with the packet. The machine to machine gateway 906 can then use this device identifier to route the packet to the appropriate machine to machine device 908.

In some implementations, the RAN 910 is coupled with one or more of a packet data serving node (PDSN), a home agent (HA), or a location mobility anchor (LMA) (collectively identified as 914). The PDSN/HA/LMA 914 can be configured to provide a bridge between the radio domain and the packet data domain. As such, the PDSN/HA/LMA 914 can perform data communication with a machine to machine (M2M) server 916. The data communication received by machine to machine server 916 can ultimately be serviced by a machine to machine application 928. In some implementations, the machine to machine server 916 and the machine to machine application 928 are controlled by a machine to machine service provider, such as a utility company or automotive manufacturer as described above. In some implementations, the PDSN/HA/LMA 914 can be configured to communicate directly with the machine to machine application 928.

In some implementations, such as that shown in FIG. 9, it can be desirable for a service provider to also include a service provider (SP) authentication, authorization, and accounting (AAA) module 917. This module can be implemented as a data storage configured to store usage information for the machine to machine server 916 and/or the machine to machine application 928. For example, as a data packet passes through the machine to machine server, the machine to machine server 916 can identify the device connection information associated with the packet. This can allow the machine to machine server 916 to identify the machine to machine device 908 that generated the packet. Based on one or more of authentication, authorization, subscription, and the like, the machine to machine server 916 can process the packet. For example, if the machine to machine device 908 is subscribed for one transaction per week and a second transaction is received, the machine to machine server 916 can block the packet. In this case, the machine to machine server 916 can be configured to transmit a response packet identifying the cause (e.g., subscription exceeded) and/or how to correct the issue (e.g., increasing the subscription level).

In some implementations, it can be desired to communicate with the machine to machine device 908 via a non-packet switched network. For example, the machine to machine server 916 can transmit information to the machine to machine device using control plane signaling. In this example, the machine to machine server 916 can be configured to communicate with a machine to machine interworking framework (M2M-IWF) 918. The machine to machine interworking framework 918 can receive a control plane signal from the machine to machine server 916. In one implementation, the machine to machine interworking framework 918 can be coupled with the PDSN/HA/LMA 914. In this implementation, the M2M-IWF 918 can transmit the control signal to the PDSN/HA/LMA 914 for delivery as described above. In some implementations, the M2M-IWF 918 can be further configured to translate the control plane signal into a packet signal for transmission to the PDSN/HA/LMA 914.

In some implementations, the M2M server 916 or the M2M application 928 can transmit data to a machine to machine device 908 via Short Message Service (SMS) messaging. The message can be received by an SMS service controller (SMS-SC)/IP short-message gateway (IP-SM-GW) 920. The SMS-SC 920 can also be referred to herein as a Message Center (MC) 920. In this implementation, the SMS-SC/IP-SM-GW 920 can be configured to receive the message and transmit the message to the PSDN/HA/LMA 914. In one implementation, the SMS-SC/IP-SM-GW 920 can communicate with the M2M-IWF 918 to determine the PSDN associated with the intended message recipient. The SMS-SC/IP-SM-GW 920 can then establish a connection with the identified PSDN/HA/LMA 914 and transmit the SMS as an IP SMS packet. The IP SMS packet can include one or more of the device identifier, device connection identifier, and the local host identifier associated with the machine to machine device 908 to receive the SMS message.

In some implementations, the M2M server 916 or the M2M application 928 can transmit data to a machine-to-machine device 902 via Unstructured Supplementary Service Data (USSD) messaging. The message can be received by an USSD gateway 926. The USSD gateway 926 can be configured to receive a message and transmit the message to the M2M-IWF 918. The USSD gateway 926 can establish a connection with the M2M-IWF 918 and transmit the USSD message in conjunction with and/or after establishing a USSD session.

While the above communication paths have been described as communications originating with the machine to machine server 916 or the machine to machine application 928 and destine for a machine to machine device 908, it will be understood that similar transmission patterns can be implemented to allow the machine to machine device 908 to transmit communication to the machine to machine server 916 or the machine to machine application 928.

In some implementations, the M2M server 916 and/or the M2M application 928 can push a message to a M2M device 908. For example, if a utility company is the service provider, during high electricity demand periods, the utility company can transmit a demand response signal to smart meters (M2M device 908) indicating a reduced usage situation has arisen. The smart meters can be configured, for example, to reduce the usage by disabling certain non-essential appliances. In this case, the location of the M2M device 908 may not necessarily be known.

When a UE 902b first registers with the RAN 910, the RAN 910 can transmit a record of the location of the UE 902b to a mobility switching center (MSC)/visitor location record 924. In some implementations, the RAN 910 can provide the local host identifier for the UE 902b. In some implementation, the RAN 910 can also provide the device connection identifier for the attached devices 908. In some implementation, the RAN 910 can also provide the device identifier for the attached devices 908. A corresponding record can be transmitted to a home locator record (HLR)/authentication center (AC) 924. As part of the registration, the RAN 910 can communicate with the AAA 912 to identify whether the device can attach to the network, what service level it can be provided, etc. In the context of packet data networks, when the UE 902b registers with the RAN 910, an IP address can be associated with the UE 902b and/or the devices attached with the UE 902b.

After registration of the UE 902b, the M2M server 916 can transmit a message for a M2M device 908n attached to the UE 902b through one or more communication pathways. Device triggering can be used to provide a message from a machine to machine service provider to a machine to machine device. Device triggering can be used to request that the M2M device 902 initiate communications with the M2M server 916. For example, once the M2M device 902 has registered with the network, the M2M device 902 may not always be operating in a mode for communicating with the M2M server 916. In order to cause the M2M device 902 to perform operations so as to be able to communicate with the M2M server 916, the M2M server 916 can send a device triggering request that, when received by the M2M device 902, will cause the M2M device 902 to initiate a connection to the M2M server 916. In one implementation, the M2M server 916 can transmit the triggering request to the M2M-IWF 918. The triggering request can include an external interface identifier such as the device identifier and/or device connection identifier. The M2M-IWF 918 can determine the IP address for the UE 902 running an M2M application 904 or 910 associated with the external interface identifier. For example, the M2M-IWF 918 can query one or both of the network operator AAA 912 or service provider AAA 917 to identify the appropriate device connection identifier to use for transmitting the triggering request. In the context of packet data connections, the IP address can be used to create a data flow through the PSDN/HA/LMA 914 or the appropriate IP anchor for the IP address. This in turn can cause the RAN 910 attached to the UE 902 (referred to hereinafter as an M2M device 902 that can include the UE 902a with M2M applications or the UE 902b that can be used to communicate with M2M devices 908) to create a data flow for the device trigger. Once established, the data flow can be used for bi-directional packet data communication between the M2M device 902 to be triggered and the M2M server 916.

In one aspect, various communication pathways can be used to cause a device trigger request to reach the M2M device 902. For example, in one implementation, text based messaging services provided by the network can be provided. For example Unstructured Supplementary Service Data (USSD) messages and SMS message can be used for M2M device triggering as will be further described below.

As stated, USSD messages can be used for device triggering. As USSD can operate as a session based communication service, full session device triggering via USSD can be provided in one aspect. A USSD REGISTER message can be sent that includes an unstructured supplementary service request Notify invoke (UnstructuredSS-Notify Invoke). An M2M device 902 can acknowledge by sending a FACILITY message including an empty result component. If the M2M application wishes to continue communications via the USSD session that is set via USSD messages, then more FACILITY messages including an UnstructuredSS-Notify Invoke component or UnstructuredSS-Request component can be sent. The session can be terminated by sending a RELEASE COMPLETE message. In addition, the M2M device 902 can send the RELEASE COMPLETE message to clear the session. If the M2M device 902 is unable to handle the notification or request, it will send a FACILITY message including an error result. The USSD notification can be call dependent in the M2M device 902 is already in call. Otherwise, the M2M device 902 can send a RELEASE COMPLETE message including a ‘USSD-Busy’ error.

While several messages including M2M data can be transmitted using a UUSD session, device triggering can make use of as few USSD messages as possible. In one aspect, device triggering can be accomplished via a REGISTER message and a RELEASE message.

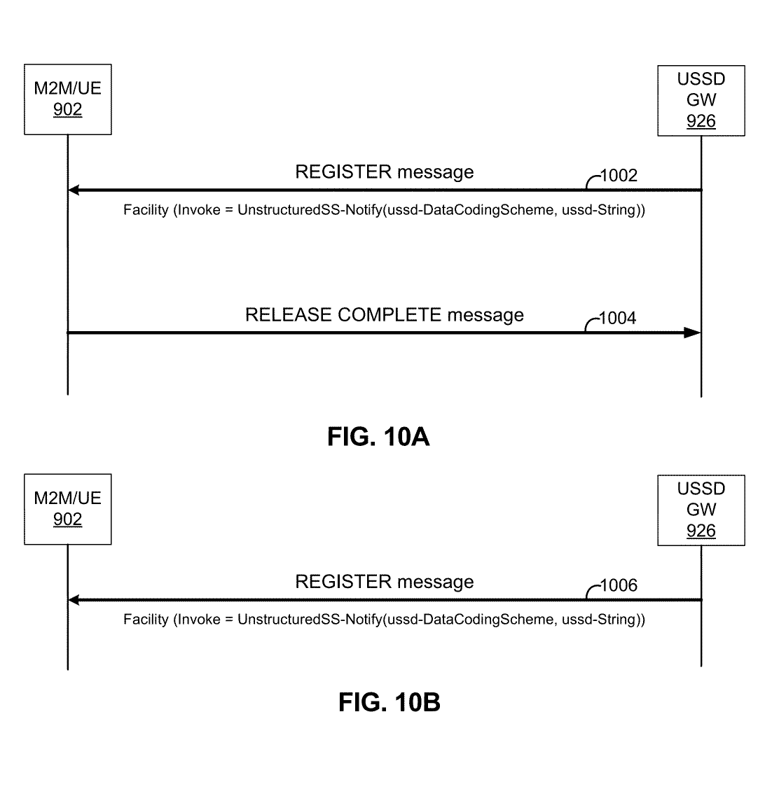

FIG. 10A is a call flow diagram of an exemplary call flow for point-to-point machine-to-machine device triggering using Unstructured Supplementary Service Data (USSD) messages. Once the USSD gateway 926 receives a request that a device triggering request be sent to an M2M device 902, at call 1002, the USSD gateway 926 sends a REGISTER message to an M2M device 902. The REGISTER message can include an UnstructuredSS-Notify Invoke component via a paging (i.e., common) or traffic channel. The REGISTER message can be sent as a Facility (Invoke=UnstructuredSS-Notify (ussd-DataCodingScheme, ussd-String)), where the ussd-String parameter can include the device triggering request. In response, to clear the session, the M2M device 902 can send a RELEASE COMPLETE message. As such, device triggering can be accomplished using the two USSD messages, where the device triggering request can be included in the initial REGISTER message.

FIG. 10B is a call flow diagram of an exemplary call flow for broadcast machine-to-machine device triggering using USSD messages. In this case, once the USSD gateway 926 receives a request that a device triggering request be sent to an M2M device 902, the USSD gateway 926 can send a REGISTER message. The REGISTER message can be sent as a Facility (Invoke=UnstructuredSS-Notify (ussd-DataCodingScheme, ussd-String)), where the ussd-String parameter can include the device triggering request. In this case, the USSD message is sent via a paging channel. In this case, due to the broadcast nature, the M2M device 902 may not reply. As such, another entity within the network can send a RELEASE message to complete the session as will be further described below.

Sending the device triggering request via the USSD message to the M2M device 902 can involve several of the entities as described above with reference to FIG. 9. As such, examples of ways for sending the USSD message are described below. However, other methods and mechanisms can be provided using different entities as shown in FIG. 9.

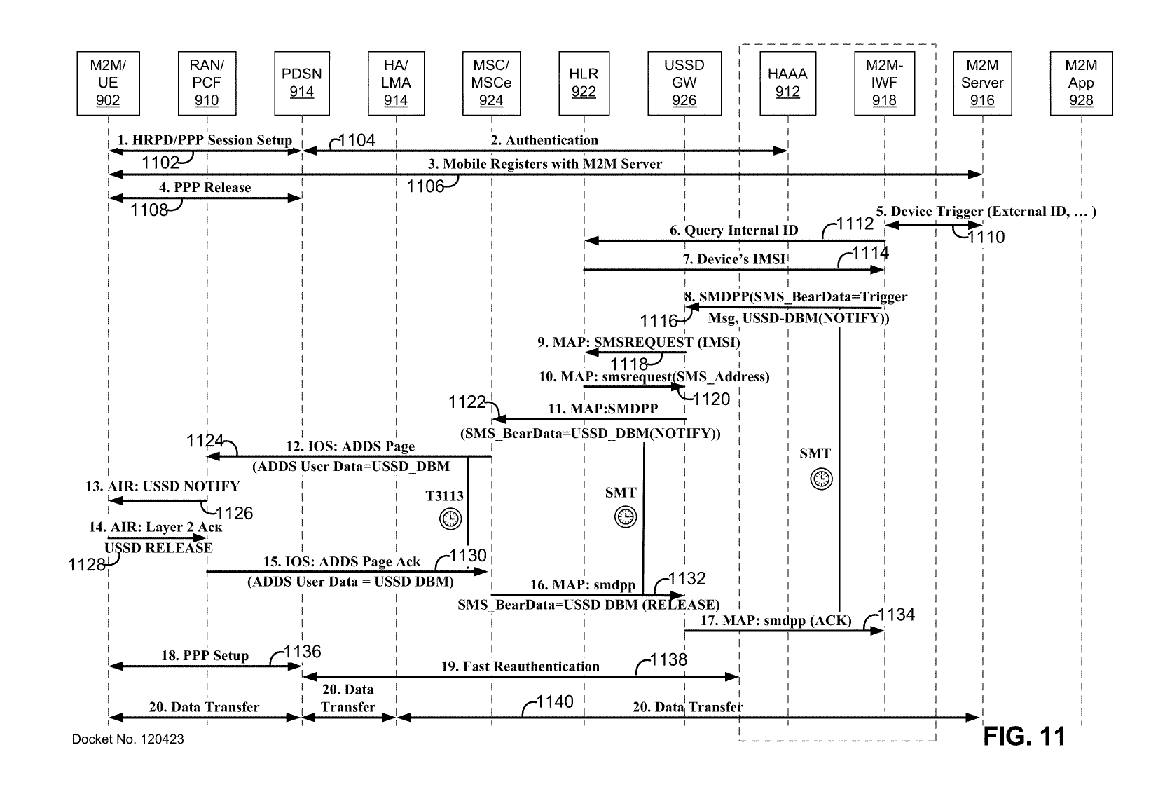

FIG. 11 is a call flow diagram of an exemplary call flow for point-to-point machine-to-machine device triggering using USSD messages over a common channel. When first registering with the M2M server 916, the M2M device 902 can first setup an HRPD session and a PPP session at call 1102 with the PDSN 914 via the RAN/PCF 910. Further authentication can take place (for example, the HAAA 912 can send the device class to the PDSN 914) via call 1104. Furthermore, registration between the M2M device 902 the M2M server 916 can further be accomplished as shown by call 1106. After registration the PPP session is released at call 1108.

Sometime thereafter, when the M2M device 902 no longer has an active data flow open with the M2M server 916, the M2M Server 916 can have a need to communicate with the M2M device 902. To activate or “wake up” the M2M device 902, the M2M server 916 can send a device trigger request to the M2M device 902. At call 1110, the M2M Server 916 can send a message to the M2M-IWF 918 to trigger the M2M device 902. At calls 1112 and 1114, the M2M-IWF 918 can send messages to obtain the International Mobile Subscriber Identify (IMSI) for the M2M device 902 from the HLR 922. In some aspects, another identifier can be used. At call 1116, the M2M-IWF 918 can send a device triggering request within a USSD NOTIFY to the USSD gateway 926 after obtaining the IMSI from the HLR 922 to notify that a USSD message with a device triggering request be sent to the M2M device 902. At that point the M2M-IWF 918 can start a short message timer (SMT). If the M2M-IWF 918 does not receive another indication within the duration of the SMT, some action can be taken by the M2M-IWF 918 such as either to resend or respond with a failure message. At calls 1119 and 1120, the USSD gateway 926 obtains the network address of the M2M device 902 from the HLR 922. In one aspect, the SMSRequest message can be used. At call 1122, the USSD gateway 926 can construct a MAP SMDPP INVOKE message with SMS_BearData parameter including a USSD Notify and sends the message to MSC/MSCe 924. At this point the USSD gateway 926 can start a SMT. If the USSD gateway 926 does not receive a response within the duration of the SMT, some action can be taken by the USSD gateway 926 to either resend or respond with a failure message.

Upon receipt of the SMDPP INVOKE message, the MSC/MSCe 924 determines if the subscriber is authorized to use USSD services and if the USSD message is for M2M device triggering by examining the subscriber profile. If the size of the USSD REGISTER message is not large, then a traffic channel does not have to be used. At call 1124, the MSC/MSCe 924 can construct an IOS ADDS Page to send the message to be forwarded to the M2M device 920 via the RAN/PCF 910. The MSC/MSCe 924 can start a timer T3113 based on the paging request. If the MSC/MSCe 924 does not receive a response to the IOS ADDS Page within the duration of the T3113 timer, the MSC/MSCe 924 can take some action such as resending or responding with a failure message. At call 1126, the RAN/PCF 910 then sends a NOTIFY message with the USSD message over a common channel. In some aspects, sending the USSD message over the common channel can allow for improved performance as, for example, no resources need to be reserved for establishing a traffic channel. However, in one aspect there can be constraints on the amount of data in a USSD message that can be transferred over the common channel.

The M2M device 902 can then construct a USSD RELEASE message to be sent with the Layer 2 Ack to the RAN/PCF 910 as indicated in call 1128. The RAN/PCF 910 thereafter constructs and sends an IOS ADDs Page Ack with the USSD RELEASE message to the MSC/MSCe 924 at call 1130. At this point the T3113 timer can be stopped. The MSC/MSCe 924 acknowledges the MAP SMDPP invoke by constructing an SMDPP RETURN RESULT message that includes the USSD DBM (RELEASE) and sends the SMDPP message to the USSD gateway 926 at call 1132. At this point the SMT can be stopped by the USSD gateway 926. Upon receipt of the SMDPP RETURN RESULT with the USSD DBM (RELEASE), the USSD gateway 926 can send a MAP smdpp(ACK) to the M2M-IWF 918 at call 1134. The M2M-IWF 918 can then stop the SMT.

After receiving the USSD message with the device triggering request, the M2M device 902 can be triggered to initiate a communication link with the M2M server 916. As such, at call 1136, the M2M device 902 can perform a PPP setup with the PDSN 914, perform authentication at call 1138, and then be able to open up a communication pathway to the M2M server 916 at call 1140 to perform data transfer.

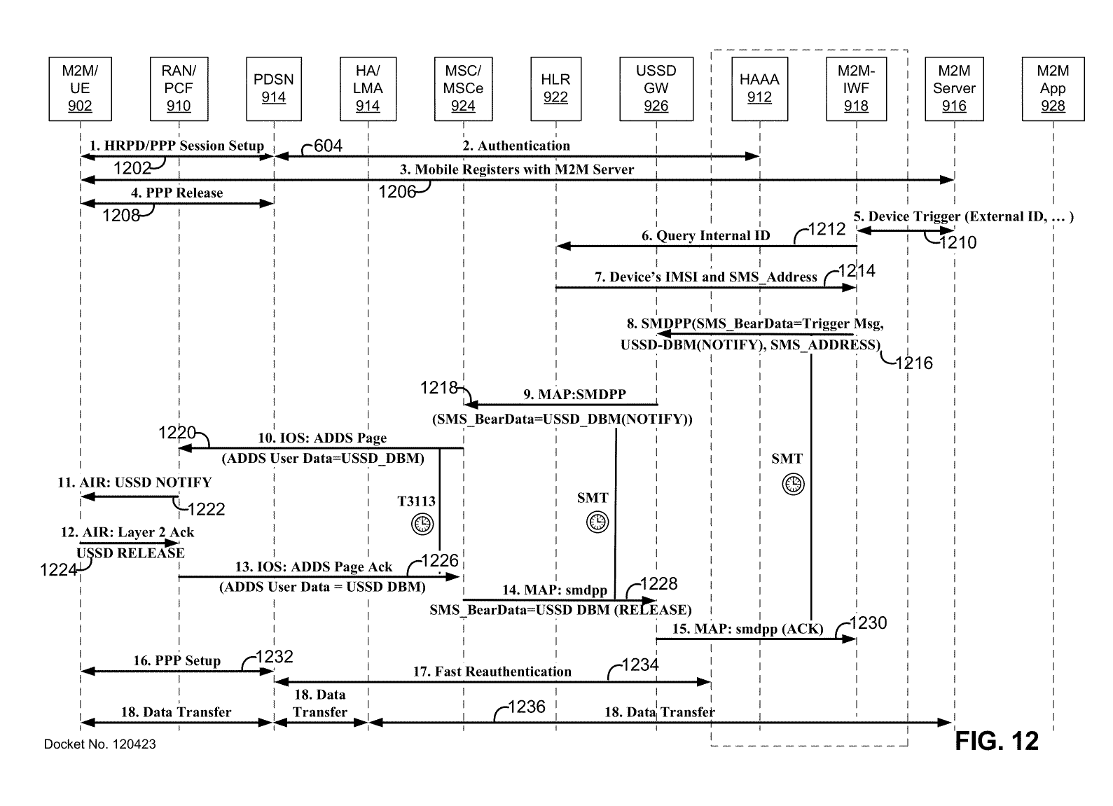

FIG. 12 is a call flow diagram of another exemplary call flow for point-to-point machine-to-machine device triggering using USSD messages over a common channel. In contrast to the call flow shown in FIG. 11, the M2M-IWF 918 can pass the network address and external ID to the HLR 922 in order to receive the internal ID and the address for the M2M device 902 and then pass the address to the USSD gateway 926. As such the USSD gateway 926 may not have to pull out the location information from the HLR 922 and can send it directly to the correct MSC/MSCe 924.

Accordingly, initial M2M device registration as shown in calls 1202, 1204, 1206, and 1208 can occur as described above with reference to FIG. 11. At call 1210, the M2M Server 916 can send a message to the M2M-IWF 918 to trigger the M2M device 902. At calls 1212 and 1214, the M2M-IWF 918 can send messages as described above to obtain the IMSI for the M2M device 902 and the address (e.g., SMS_Address) from the HLR 922. In some aspects, another identifier can be used. At call 1216, the M2M-IWF 918 can send a device triggering request within a USSD NOTIFY as well as the address to the USSD gateway 926 after obtaining the IMSI and address from the HLR 922 to notify that a USSD message with a device triggering request be sent to the M2M device 902. At that point the M2M-IWF 918 can start a short message timer (SMT). In this case, the USSD gateway 926 does not request or obtain the address of the M2M device 902, as it now already has the address. At call 1218, the USSD gateway 926 can construct a MAP SMDPP INVOKE message with SMS_BearData parameter including a USSD Notify and sends the message to MSC/MSCe 924. At this point the USSD gateway 926 can start an SMT.

Upon receipt of the SMDPP INVOKE message, the MSC/MSCe 924 determines if the subscriber is authorized to use USSD services and if the USSD message is for M2M device triggering by examining the subscriber profile. If the size of the USSD REGISTER message is not large, then a traffic channel does not have to be used. At call 1220, the MSC/MSCe 924 can construct an IOS ADDS Page to send the message to be forwarded to the M2M device 920 via the RAN/PCF 910. The MSC/MSCe 924 can start a timer T3113 based on the paging request. At call 1222, the RAN/PCF 910 then sends a NOTIFY message with the USSD message over a common channel.

The M2M device 902 can then construct a USSD RELEASE message to be sent with the Layer 2 Ack to the RAN/PCF 910 as indicated in call 1224. The RAN/PCF 910 thereafter constructs and sends an IOS ADDS Page Ack with the USSD RELEASE message to the MSC/MSCe 924 at call 1226. At this point the T3113 timer can be stopped. The MSC/MSCe 924 acknowledges the MAP SMDPP invoke by constructing an SMDPP RETURN RESULT message that includes the USSD DBM (RELEASE) and sends the SMDPP message to the USSD gateway 926 at call 1228. At this point the SMT can be stopped by the USSD gateway 926. Upon receipt of the SMDPP RETURN RESULT with the USSD DBM (RELEASE), the USSD gateway 926 can send a MAP smdpp(ACK) to the M2M-IWF 918 at call 1230. The M2M-IWF 918 can then stop the SMT.

After receiving the USSD message with the device triggering request, the M2M device 902 can be triggered to initiate a communication link with the M2M server 916. As such, at call 1232, the M2M device 902 can perform a PPP setup with the PDSN 914, perform authentication at call 1234, and then be able to open up a communication pathway to the M2M server 916 at call 1236 to perform data transfer.

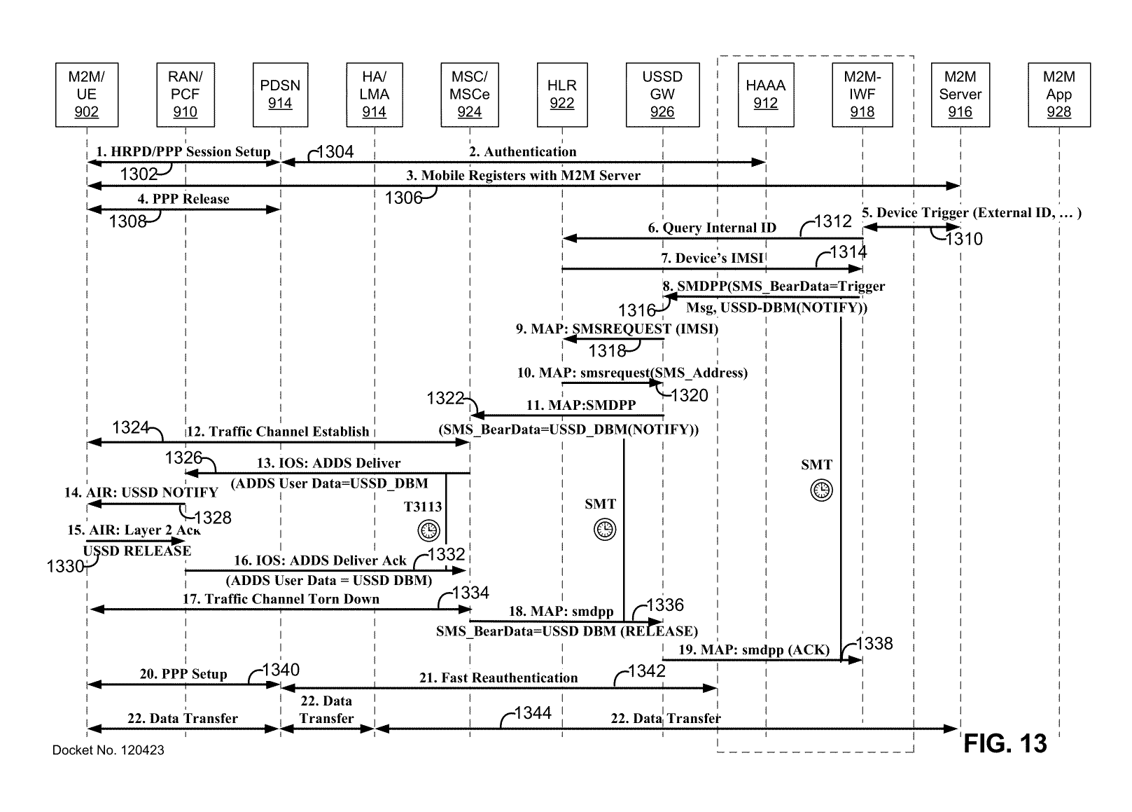

FIG. 13 is a call flow diagram of an exemplary call flow for point-to-point machine-to-machine device triggering using a USSD message over a traffic channel. In contrast to the call flow shown in FIG. 11, it can be determined a traffic channel should be established for sending the USSD message rather than sending the message on the common channel. Initial M2M device registration as shown in calls 1302, 1304, 1306, and 1308 can occur as described above with reference to FIG. 11. Once the M2M device 902 is registered, sometime thereafter as described above, when no communication session is established between the M2M device 902 and the M2M server 916, the M2M server 916 can wish to trigger the M2M device 902 by sending a device triggering request to cause the M2M device 902 to initiate a communication session with the M2M server 916. As described above with reference to FIG. 11, a USSD message can be used to provide the device triggering request to the M2M device. In this case call flow as indicated by calls 1310, 1312, 1314, 1317, 1318, and 1322 can proceed similarly as described above with reference to FIG. 11.

When the SMDPP Invoke message is received by the MSC/MSCe 924, in contrast to FIG. 11, the MSC/MSCe 924 can determine that the USSD REGISTER message is large enough to setup a traffic channel. If the M2M device 902 is not on a traffic channel, then at call 1324, a traffic channel can be established between the MSC/MSCe 924 and the M2M device 902. The MSC/MSCe 924 then constructs and sends the IOS ADDS Deliver to send the message to be forwarded to the M2M device 902 via the RAN/PCF 910 at call 1326 and starts the T3113 timer. The RAN/PCF 910 can then send the Notify message with the USSD REGISTER message along with the device triggering request information over the traffic channel at call 1328. At call 1330, the M2M device 902 can respond with a USSD RELEASE with a Layer 2 Ack. The RAN/PCF 910, at call 1332, constructs an IOS ADDS Deliver ACK with the USSD RELEASE and sends it to the MSC/MSCe 924. The T3113 timer is stopped, and the MSC/MSCe 924 can proceed to tear down the traffic channel as shown in call 1334. The MSC/MSCe 924 acknowledges the MAP SMDPP invoke by constructing an SMDPP RETURN RESULT message that includes the USSD DBM (RELEASE) and sends the SMDPP message to the USSD gateway 926 at call 1336. At this point the SMT can be stopped by the USSD gateway 926. Upon receipt of the SMDPP RETURN RESULT with the USSD DBM (RELEASE), the USSD gateway 926 can send a MAP smdpp(ACK) to the M2M-IWF 918 at call 1338. The M2M-IWF 918 can then stop the SMT. The M2M device 902 can then initiate a communication link with the M2M server 916 by establishing a PPP session or like session and proceed with transferring data with the M2M server 916 in calls 1340, 1342, and 1344 as described above with reference to FIG. 11.

In one aspect, by using USSD based M2M device triggering, the MC/SMS-SC 920 can avoid being overloaded with M2M device triggering messages. In addition, M2M device triggering can be accomplished via a session based messaging system.

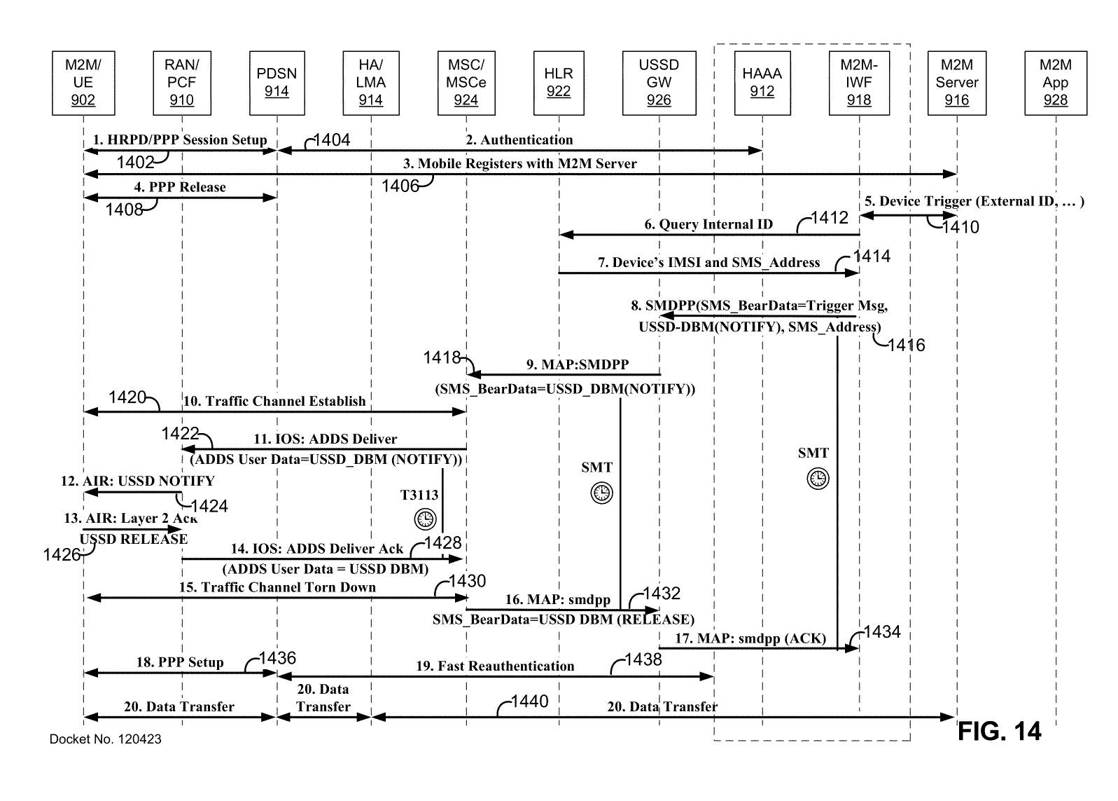

FIG. 14 is a call flow diagram of another exemplary call flow for point-to-point machine-to-machine device triggering using a USSD message over a traffic channel. Initial M2M device registration as shown in calls 1402, 1404, 1406, and 1408 can occur as described above with reference to FIG. 11. In contrast to FIG. 13, the M2M-IWF 918 can pass the network address and external ID to the HLR 922 in order to receive the internal ID and the address for the M2M device 902 and then pass the address to the USSD gateway 926. As such the USSD gateway 926 may not have to pull out the location information from the HLR 922 and can send it directly to the correct MSC/MSCe 924. As such, the call flow of FIG. 14 shown in calls 1410, 1412, 1414, 1416, and 1418 can proceed similarly to the corresponding flow of FIG. 12 as shown in calls 1210, 1212, 1214, 1216, and 1218.

When the SMDPP Invoke message is received by the MSC/MSCe 924, in contrast to FIG. 12, the MSC/MSCe 924 can determine that the USSD REGISTER message is large enough to setup a traffic channel. If the M2M device 902 is not on a traffic channel, then at call 1420, a traffic channel can be established between the MSC/MSCe 924 and the M2M device 902. The MSC/MSCe 924 then constructs and sends the IOS ADDS Deliver to send the message to be forwarded to the M2M device 902 via the RAN/PCF 910 at call 1422 and starts the T3113 timer. The RAN/PCF 910 can then send the Notify message with the USSD REGISTER message along with the device triggering request information over the traffic channel at call 1424. At call 1426, the M2M device 902 can respond with a USSD RELEASE with a Layer 2 Ack. The RAN/PCF 910, at call 1428, constructs an IOS ADDS Deliver ACK with the USSD RELEASE and sends it to the MSC/MSCe 924. The T3113 timer is stopped, and the MSC/MSCe 924 can proceed to tear down the traffic channel as shown in call 1430. The MSC/MSCe 924 acknowledges the MAP SMDPP invoke by constructing an SMDPP RETURN RESULT message that includes the USSD DBM (RELEASE) and sends the SMDPP message to the USSD gateway 926 at call 1432. At this point the SMT can be stopped by the USSD gateway 926. Upon receipt of the SMDPP RETURN RESULT with the USSD DBM (RELEASE), the USSD gateway 926 can send a MAP smdpp(ACK) to the M2M-IWF 918 at call 1434. The M2M-IWF 918 can then stop the SMT. The M2M device 902 can then initiate a communication link with the M2M server 916 by establishing a PPP session or like session and proceed with transferring data with the M2M server 916 in calls 1436, 1438, and 1434 as described above with reference to FIG. 11.

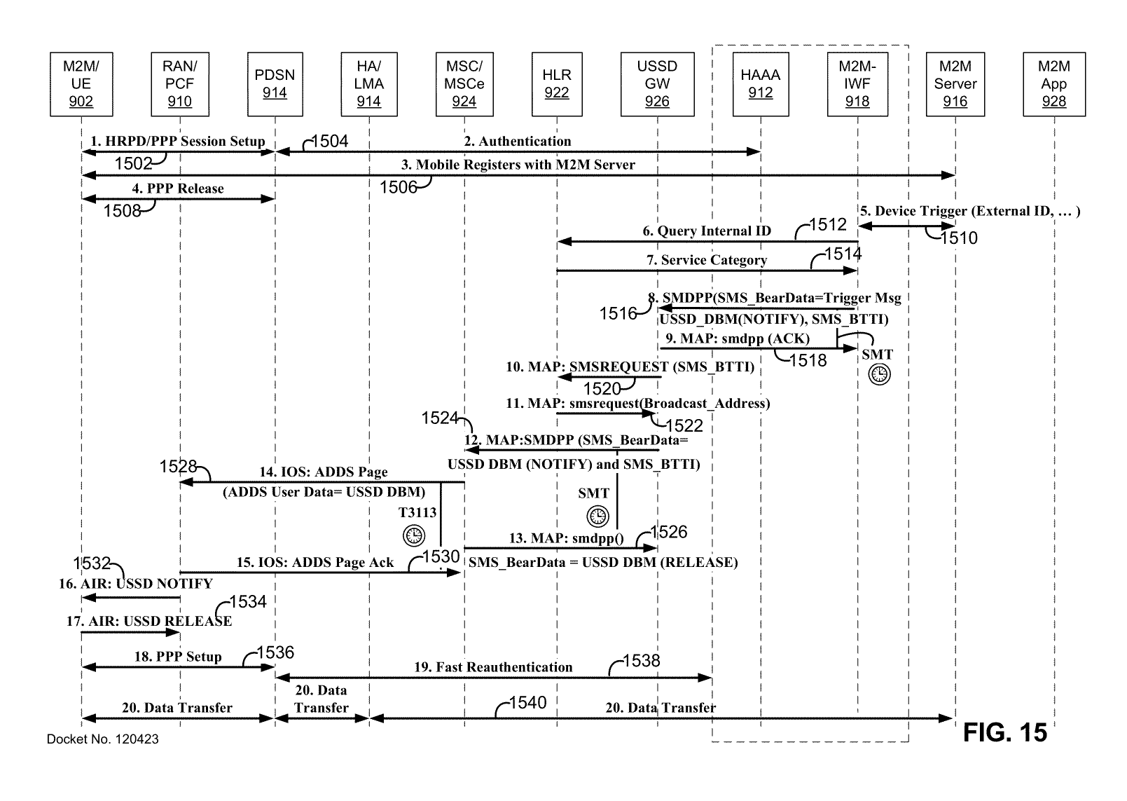

FIG. 15 is a call flow diagram of an exemplary call flow for broadcast machine-to-machine device triggering using a USSD message. In this case, after multiple M2M devices have registered with the network and M2M server 916, the M2M server 916 can send device triggering requests to the multiple M2M devices in a broadcast fashion rather then sending individual triggering requests to each M2M device 902. As such, in one aspect, USSD messages can be used to broadcast a device triggering request from the M2M server 916 to individual M2M devices.

Initial M2M device registration for any one of multiple M2M devices as shown in calls 1502, 1504, 1506, and 1508 can occur as described above with reference to FIG. 11. Once M2M devices are registered, sometime thereafter as described above, the M2M server 916 can wish to trigger one or more M2M devices with a single request. At call 1510, the M2M Server 916 can send a device trigger to the M2M-IWF 918 indicating that a device triggering request should be broadcast to one or more M2M devices. At calls 1512 and 1514, the M2M-IWF 918 can query the HLR 922 and receive the service category. The service category can be defined to correspond to a mode for broadcasting a USSD message including a device triggering request to one or more M2M devices. At call 1516, the M2M-IWF 918 sends a triggering message to the USSD gateway 926 using an MAP SMDPP INVOKE message with SMS_BearData set to trigger message and SMS_BTTI (SMS broadcast category). At this point, the M2M-IWF 918 can start the SMT. At call 1518, the USSD gateway 926 acknowledges the SMDPP message to the M2M-IWF 918 at which point the SMT can stop if the acknowledgement is received. At calls 1520 and 1522, the USSG gateway 926 queries the HLR 922 using the service category in the SMS_BTTI to retrieve the broadcast address. At call 1524, the USSG gateway 926 constructs a MAP SMDPP INVOKE message with SMS_BearData parameter including a USSD Notify and SMS_BTTI and sends the message to the MSC/MSCe 924. At this point, the USSD gateway 926 can start an SMT. When the MSC/MSCe 924 receives the SMDPP INVOKE message, the MSC/MSCe 924 determines whether the request is authorized and is for broadcast and if so, the MSC/MSCe 924 sends an SMDPP message with USSD RELEASE to the USSD gateway 926 at which point the SMT can be stopped at call 1526.

At call 1528, the MSC/MSCe 924 can construct an IOS ADDS Page. The data burst type of the ADDS User Data Informational Element is set to USSD. The SMS_BearData parameter of the MAP SMDPP INVOKE is used to create the Application Data Message of the ADDS User Data Informational Element. The MSC/MSCe 924 sends the IOS ADDS page to the RAN/PCF 910. The MSC/MSCe 924 can start a timer T3113 based on the paging request. When the RAN/PCF 910 receives the IOS:ADDS Page message, at call 1530, the RAN/PCF 910 sends an acknowledgment message via a IOS:ADDS Page Ack to the MSC/MSCe 924. At that point the MSC/MSCe 924 can stop the timer T3113. The RAN/PCF 910 then transmits the broadcast triggering message over the common channel at call 1532 via the USSD notify to an M2M device 902 that is included in the broadcast address. The M2M device 902 constructs a USSD RELEASE message with the Layer 2 Ack in call 1534 and sends it to the RAN/PCF 910. The M2M device 902 of the broadcast group can then initiate a communication link with the M2M server 916 by establishing a PPP session or like session and proceed with transferring data with the M2M server 916 in calls 1536, 1538, and 1540 as described above with reference to FIG. 11.

In one aspect, as USSD is session based, for USSD based broadcast M2M device triggering, the USSD gateway 926 can be modified to not accept any answer from the M2M device 902. Or, a proxy (e.g., the MSC/MSCe 924 as shown above with reference to call 1526) can need to terminate a session on behalf of the M2M device 902 by sending a RELEASE COMPLETE message to the USSD gateway 920.

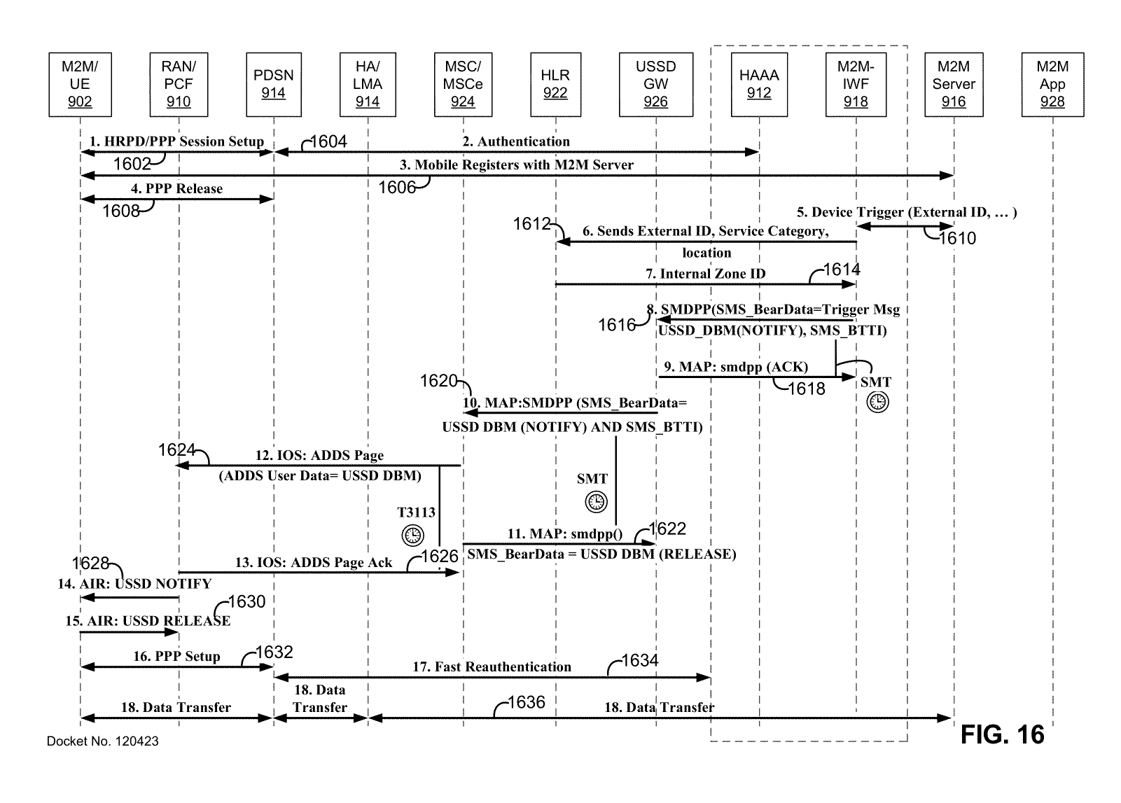

FIG. 16 is a call flow diagram of another exemplary call flow for broadcast machine-to-machine device triggering using a USSD message. In contrast to FIG. 15, the M2M-IWF 918 can send the external ID, service category, and location to the HLR 1612 to receive, in response, an internal location (e.g., internal zone ID) that can indicate the broadcast address. In this way the USSD gateway 926 may not need to request the location information from the HLR 922 and can send it directly to the correct MSC/MSCe 924.

Accordingly, initial M2M device registration for any one of multiple M2M devices as shown in calls 1602, 1604, 1606, and 1608 can occur as described above with reference to FIG. 11. Once M2M devices are registered, sometime thereafter as described above, the M2M server 916 can wish to trigger one or more M2M devices with a single request. At call 1610, the M2M Server 916 can send a device trigger to the M2M-IWF 918 indicating that a device triggering request should be broadcast to one or more M2M devices. At calls 1612 and 1614, the M2M-IWF 918 can query the HLR 922 sending an external ID, service category, and location and receive an Internal Zone ID. The service category can be defined to correspond to a mode for broadcasting a USSD message including a device triggering request to one or more M2M devices. At call 1616, the M2M-IWF 918 sends a triggering message to the USSD gateway 926 using an MAP SMDPP INVOKE message with SMS_BearData set to trigger message and SMS_BTTI (SMS broadcast category). At this point, the M2M-IWF 918 can start the SMT. At call 1618, the USSD gateway 926 acknowledges the SMDPP message to the M2M-IWF 918 at which point the SMT can stop if the acknowledgement is received. At call 1620, the USSG gateway 926 constructs a MAP SMDPP INVOKE message with SMS_BearData parameter including a USSD Notify and SMS_BTTI and sends the message to the MSC/MSCe 924. At this point, the USSD gateway 926 can start an SMT. When the MSC/MSCe 924 receives the SMDPP INVOKE message, the MSC/MSCe 924 determines whether the request is authorized and is for broadcast and if so, the MSC/MSCe 924 sends an SMDPP message at call 1622 with USSD RELEASE to the USSD gateway 926 at which point the SMT can be stopped.

At call 1624, the MSC/MSCe 924 can construct an IOS ADDS Page. The data burst type of the ADDS User Data Informational Element is set to USSD. The SMS_BearData parameter of the MAP SMDPP INVOKE is used to create the Application Data Message of the ADDS User Data Informational Element. The MSC/MSCe 924 sends the IOS ADDS page to the RAN/PCF 910. The MSC/MSCe 924 can start a timer T3113 based on the paging request. When the RAN/PCF 910 receives the IOS:ADDS Page message, at call 1626, the RAN/PCF 910 sends an acknowledgment message via a IOS:ADDS Page Ack to the MSC/MSCe 924. At that point the MSC/MSCe 924 can stop the timer T3113. The RAN/PCF 910 then transmits the broadcast triggering message over the common channel at call 1628 via the USSD notify to an M2M device 902 that is included in the broadcast address. The M2M device 902 constructs a USSD RELEASE message with the Layer 2 Ack in call 1630 and sends it to the RAN/PCF 910. The M2M device 902 of the broadcast group can then initiate a communication link with the M2M server 916 by establishing a PPP session or like session and proceed with transferring data with the M2M server 916 in calls 1632, 1634, and 1636 as described above with reference to FIG. 11.

In another aspect, Short Message Service (SMS) messaging can be used for M2M device triggering in a cellular network. In one aspect, to improve the use of SMS messaging for M2M device triggering, for point-to-point triggering a teleservice can be defined that specifies a SMS messaging mode for M2M device triggering. In one aspect the teleservice can be referred to as Wireless Machine to Machine Teleservice (WMMT). An M2M device 920 and the M2M application 928 can communicate M2M triggering procedures using the WMMT teleservice. Dependent on the size of the triggering message, the MSC/MSCe 924 can use the control/paging channel or traffic channel when the MSC/MSCe 924 receives messages from an MC/SMS-SC 920 with WMMT as the designated teleservice.

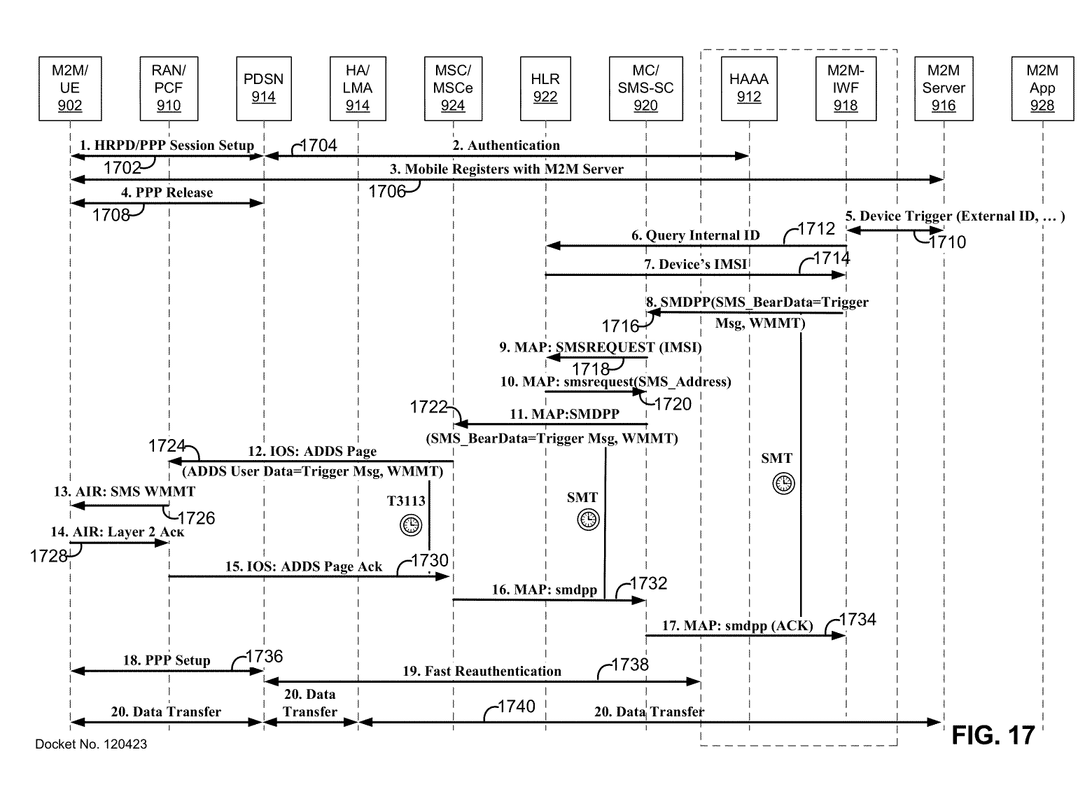

FIG. 17 is a call flow diagram of an exemplary call flow for point-to-point machine-to-machine device triggering using a Short Message Service (SMS) message over a common channel using a device triggering teleservice. Initial M2M device registration as shown in calls 1702, 1704, 1706, and 1708 can occur as described above with reference to FIG. 11. At call 1710, the M2M Server 916 can send a message to the M2M-IWF 918 to trigger the M2M device 902. At calls 1712 and 1714 the M2M-IWF 918 can send messages to obtain the International Mobile Subscriber Identify (IMSI) from the HLR 922. In some aspects, another identifier can be used. At call 1716, the M2M-IWF 918 can send a device triggering request within a SMDPP message indicating the WMMT teleservice to the MC/SMS-SC 920 after obtaining the IMSI from the HLR 922. At that point the M2M-IWF 918 can start a short message timer (SMT). At calls 1718 and 1720, the MC/SMS-SC 920 obtains the network address of the M2M device 902 from the HLR. In one aspect, the SMSRequest message can be used. At call 1722, the MC/SMS-SC 920 can construct a MAP SMDPP INVOKE message with SMS_BearData parameter including a triggering message and the WMMT teleservice indication and sends the message to the MSC/MSCe 924. At this point the MC/SMS-SC 920 can start an SMT.

Upon receipt of the SMDPP INVOKE message, the MSC/MSCe 924 determines if the subscriber is authorized to use SMS services and this SMS for M2M device triggering by examining the subscriber profile. If the size of the SMS message is not large, then a traffic channel does not have to be used. At call 1724, the MSC/MSCe 924 can construct an IOS ADDS Page to send the message to be forwarded to the M2M device 920 via the RAN/PCF 910. The IOS ADDS page can include the triggering message, the WMMT teleservice and service category. The MSC/MSCe 924 can start a timer T3113 based on the paging request. At call 1726, the RAN/PCF 910 then sends the device triggering message over a common channel. In some aspects, sending the SMS message with the triggering request over the common channel can allow for improved performance as, for example, no resources need to be reserved for establishing a traffic channel. However, in one aspect there can be constraints on the amount of data in an SMS message that can be transferred over the common channel.

The M2M device 902 can then acknowledge receipt by sending a Layer 2 Ack to the RAN/PCF 910 as indicated in call 1728. The RAN/PCF 910 thereafter constructs and sends an IOS ADDs Page Ack to the MSC/MSCe 924 at call 1730. At this point the T3113 timer can be stopped. The MSC/MSCe 924 acknowledges the MAP SMDPP invoke by constructing an empty MAP smdpp to the MC/SMS-SC 920. At this point the SMT can be stopped by the MC/SMS-SC 920. Upon receipt of the empty SMDPP MAP, the MC/SMS-SC 920 can send a MAP smdpp(ACK) to the M2M-IWF 918 at call 1734. The M2M-IWF 918 can then stop the SMT.

After receiving the triggering request via SMS procedures, the M2M device 902 can be triggered to initiate a communication link with the M2M server 916. As such, at call 1736, the M2M device 902 can perform a PPP setup with the PDSN 914, perform authentication at call 1738, and then be able to open up a communication pathway to the M2M 916 server at call 1740 to perform data transfer.

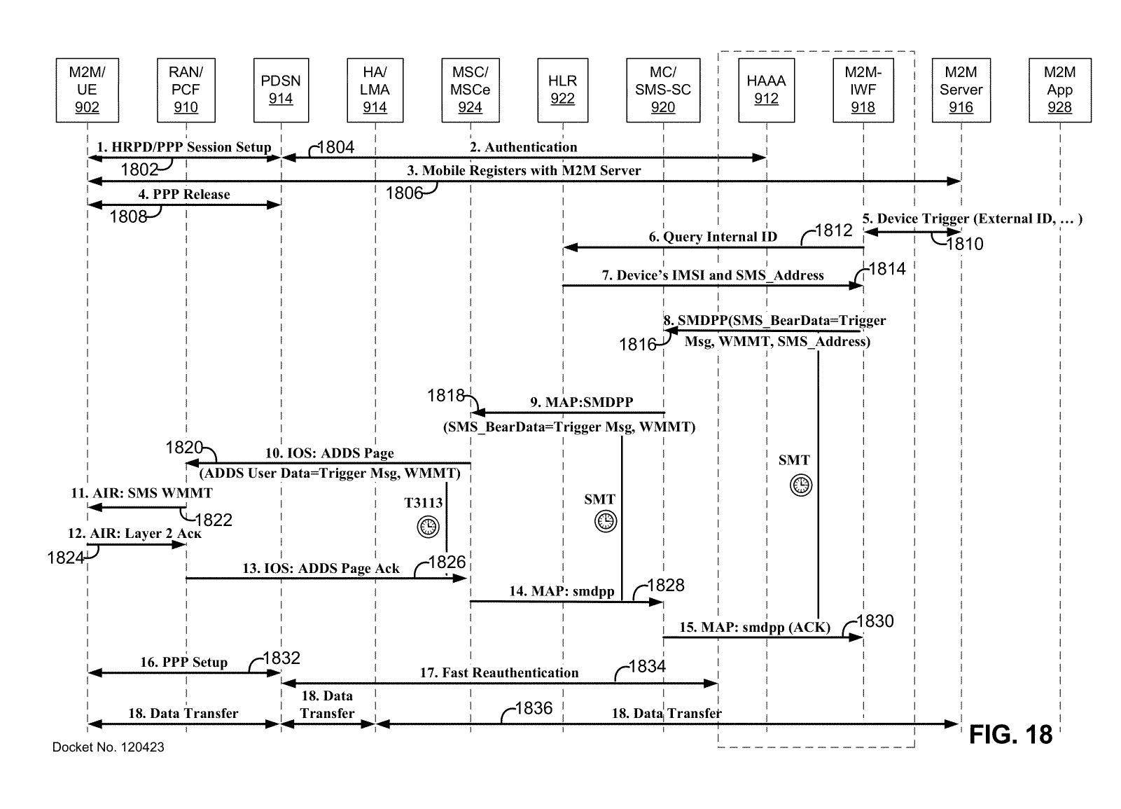

FIG. 18 is a call flow diagram of another exemplary call flow for point-to-point machine-to-machine device triggering using an SMS message over a common channel using a device triggering teleservice. In contrast to the call flow shown in FIG. 17, the M2M-IWF 918 can pass the network address and external ID to the HLR 922 in order to receive the internal ID and the address for the M2M device 902 and then pass the address to the MC/SMS-SC 920. As such the MC/SMS-SC 920 may not have to pull out the location information from the HLR 922 and can send it directly to the correct MSC/MSCe 924.

Accordingly, initial M2M device registration as shown in calls 1802, 1804, 1806, and 1808 can occur as described above with reference to FIG. 11. At call 1810, the M2M Server 916 can send a message to the M2M-IWF 918 to trigger the M2M device 902. At calls 1812 and 1814 the M2M-IWF 918 can send messages to obtain the International Mobile Subscriber Identify (IMSI) and address of the M2M device 9202 (e.g., SMS_Address) from the HLR 922. In some aspects, another identifier can be used. At call 1816, the M2M-IWF 918 can send a device triggering request within a SMDPP message indicating the WMMT teleservice and the address to the MC/SMS-SC 920 after obtaining the IMSI and address from the HLR 922. At that point the M2M-IWF 918 can start a short message timer (SMT). As the MC/SMS-SC 920 has the address, another request for the address from the HLR is unnecessary in some aspects. At call 1818, the MC/SMS-SC 920 can construct a MAP SMDPP INVOKE message with SMS_BearData parameter including a triggering message and the WMMT teleservice indication and sends the message to the MSC/MSCe 924. At this point the MC/SMS-SC 920 can start an SMT.

Upon receipt of the SMDPP INVOKE message, the MSC/MSCe 924 determines if the subscriber is authorized to use SMS services and this SMS for M2M device triggering by examining the subscriber profile. If the size of the SMS message is not large, then a traffic channel does not have to be used. At call 1820, the MSC/MSCe 924 can construct an IOS ADDS Page to send the message to be forwarded to the M2M device 920 via the RAN/PCF 910. The IOS ADDS page can include the triggering message, the WMMT teleservice and service category. The MSC/MSCe 924 can start a timer T3113 based on the paging request. At call 1822 the RAN/PCF 910 then sends the device triggering message over a common channel.

The M2M device 902 can then acknowledge receipt by sending a Layer 2 Ack to the RAN/PCF 910 as indicated in call 1824. The RAN/PCF 910 thereafter constructs and sends an IOS ADDS Page Ack to the MSC/MSCe 924 at call 1826. At this point the T3113 timer can be stopped. The MSC/MSCe 924 acknowledges the MAP SMDPP invoke by constructing an empty MAP smdpp to the MC/SMS-SC 920. At this point the SMT can be stopped by the MC/SMS-SC 920. Upon receipt of the empty SMDPP MAP, the MC/SMS-SC 920 can send a MAP smdpp(ACK) to the M2M-IWF 918 at call 1830. The M2M-IWF 918 can then stop the SMT.

After receiving the triggering request via SMS procedures, the M2M device 902 can be triggered to initiate a communication link with the M2M server 916. As such, at call 1832, the M2M device 902 can perform a PPP setup with the PDSN 914, perform authentication at call 1834, and then be able to open up a communication pathway to the M2M 916 server at call 1836 to perform data transfer.

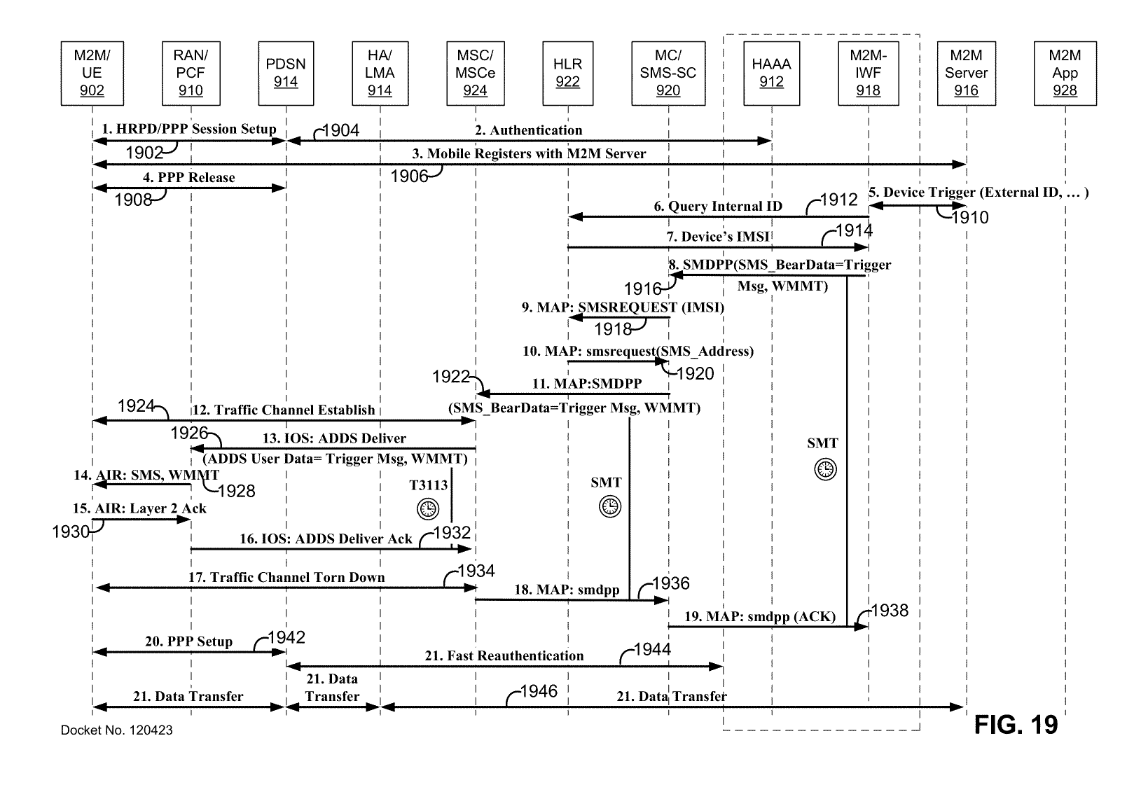

FIG. 19 is a call flow diagram of an exemplary call flow for point-to-point machine-to-machine device triggering using an SMS message over a traffic channel using a machine to machine teleservice. In contrast to the call flow shown in FIG. 17, it can be determined a traffic channel should be established for sending the triggering via SMS procedures rather than sending the message on the common channel. Initial M2M device registration as shown in calls 1902, 1904, 1906, and 1908 can occur as described above with reference to FIG. 11. Once the M2M device 902 is registered, sometime thereafter as described above, when no communication session is established between the M2M device 902 and the M2M server 916, the M2M server 916 can wish to trigger the M2M device 902 by sending a device triggering request to cause the M2M device 902 to initiate a data flow with the M2M server. As described above with reference to FIG. 17, SMS procedures can be used to provide the device triggering request to the M2M device. In this case call flow as indicated by calls 1910, 1912, 1914, 1916, 1918, and 1922 can proceed similarly as described above with reference to FIG. 17.

When the SMDPP Invoke message is received by the MSC/MSCe 924, in contrast to FIG. 17, the MSC/MSCe 924 can determine that the size of the SMS message is large enough to setup a traffic channel. If the M2M device 902 is not on a traffic channel, then at call 1924, a traffic channel can be established between the MSC/MSCe 924 as described above. The MSC/MSCe 924 then constructs and sends the IOS ADDS Deliver to send the message to be forwarded to the M2M device 902 via the RAN/PCF 910 at call 1926 and starts the T3113 timer. The RAN/PCF 910 can then send triggering message via the SMS message using the WMMT teleservice over the traffic channel at call 1928. At call 1930, the M2M device 902 can respond with a Layer 2 Ack. The RAN/PCF 910, at call 1932, constructs an IOS ADDS Deliver ACK and sends it to the MSC/MSCe 924. The T3113 timer is stopped, and the MSC/MSCe 924 can proceed to tear down the traffic channel as shown in call 1934. The MSC/MSCe 924 acknowledges the MAP SMDPP invoke by sending an empty MAP smdpp to the MC/SMS-SC 920 at call 1236. At this point, the SMT can be stopped by the MC/SMS-SC 920. Upon receipt of the empty MAP smdpp( ), the MC/SMS-SC 920 can send a MAP smdpp(ACK) to the M2M-IWF 918 at call 1938. The M2M-IWF 918 can then stop the SMT. The M2M device 902 can then initiate a communication link with the M2M server 916 by establishing a PPP session or like session and proceed with transferring data with the M2M server 916 in calls 1942, 1944, and 1946 as described above with reference to FIG. 17.

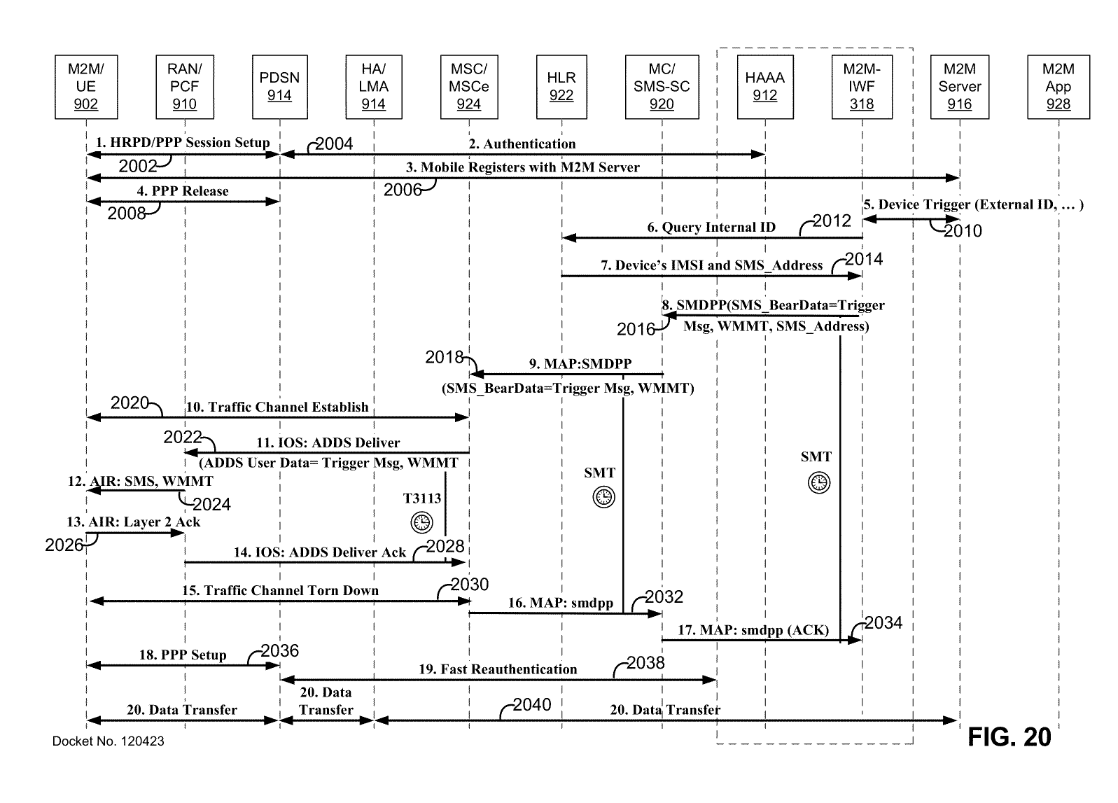

FIG. 20 is a call flow diagram of another exemplary call flow for point-to-point machine-to-machine device triggering using an SMS message over a traffic channel using a machine to machine teleservice. In contrast to FIG. 19, the M2M-IWF 918 can pass the network address and external ID to the HLR 922 in order to receive the internal ID and the address (e.g., SMS_Address) for the M2M device 902 and then pass the address to the MC/SMS-SC 920. As such the MC/SMS-SC 920 may not have to pull out the location information from the HLR 922 and can send it directly to the correct MSC/MSCe 924. As such, the call flow of FIG. 20 shown in calls 2010, 2012, 2014, 2016, and 2018 can proceed similarly to the corresponding flow of FIG. 18 as shown in calls 1810, 1812, 1814, 1816, and 1818.

When the SMDPP Invoke message is received by the MSC/MSCe 924, in contrast to FIG. 18, the MSC/MSCe 924 can determine that the size of the SMS message is large enough to setup a traffic channel. If the M2M device 902 is not on a traffic channel, then at call 2020, a traffic channel can be established between the MSC/MSCe 924 as described above. The MSC/MSCe 924 then constructs and sends the IOS ADDS Deliver to send the message to be forwarded to the M2M device 902 via the RAN/PCF 910 at call 2022 and starts the T3113 timer. The RAN/PCF 910 can then send triggering message via the SMS message using the WMMT teleservice over the traffic channel at call 2024. At call 2026, the M2M device 902 can respond with a Layer 2 Ack. The RAN/PCF 910, at call 2028, constructs an IOS ADDS Deliver ACK and sends it to the MSC/MSCe 924. The T3113 timer is stopped, and the MSC/MSCe 924 can proceed to tear down the traffic channel as shown in call 2030. The MSC/MSCe 924 acknowledges the MAP SMDPP invoke by sending an empty MAP smdpp to the MC/SMS-SC 920 at call 1232. At this point, the SMT can be stopped by the MC/SMS-SC 920. Upon receipt of the empty MAP smdpp( ), the MC/SMS-SC 920 can send a MAP smdpp(ACK) to the M2M-IWF 918 at call 2034. The M2M-IWF 918 can then stop the SMT. The M2M device 902 can then initiate a communication link with the M2M server 916 by establishing a PPP session or like session and proceed with transferring data with the M2M server 916 in calls 2036, 2038, and 2040 as described above with reference to FIG. 17.

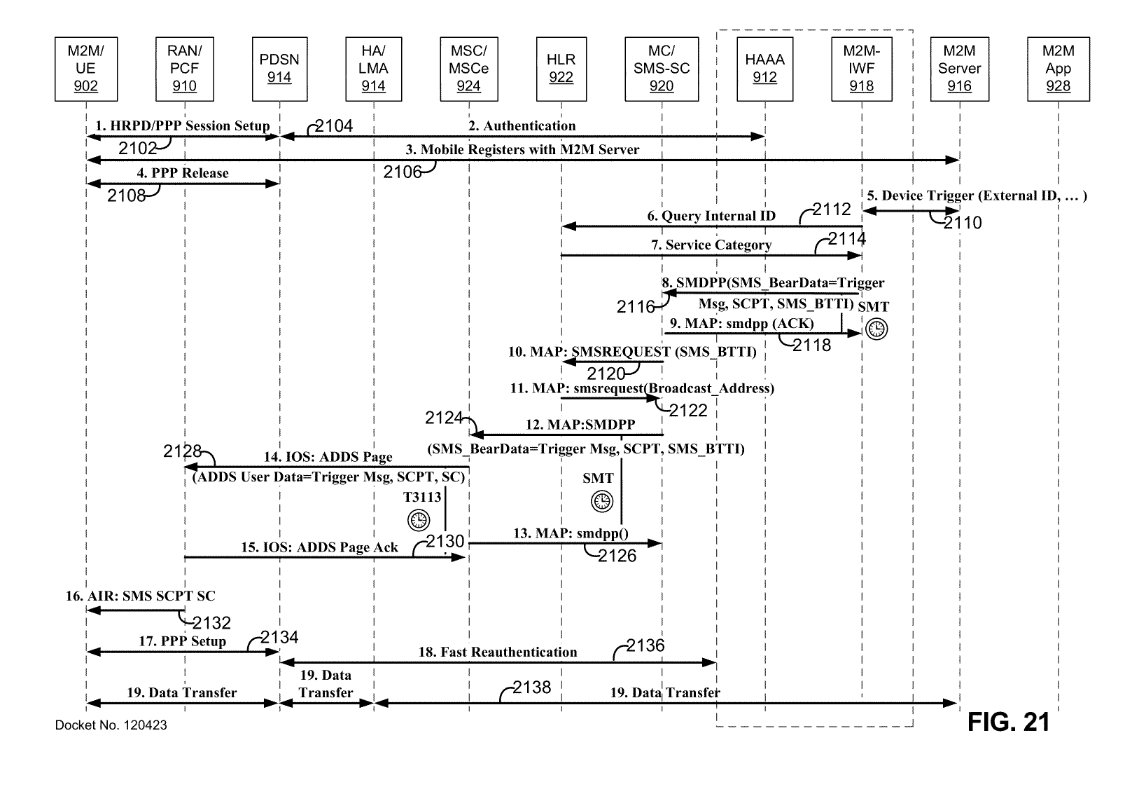

FIG. 21 is a call flow diagram of an exemplary call flow for broadcast machine-to-machine device triggering using an SMS message. In one aspect the broadcast SMS can be used. In this case, a value for a Service Category can be defined for M2M device triggering so that when the SMS parser receives the indication to send the M2M triggering SMS, it can route it to the M2M handler within the MC/SMS-SC 920. The MSC/MSCe 924 can use the broadcast common channel to send the triggering message.

Initial M2M device registration for any one of multiple M2M devices as shown in calls 2102, 2104, 2106, and 2108 can occur as described above with reference to FIG. 11. Once M2M devices are registered, sometime thereafter as described above, the M2M server 916 can wish to trigger one or more M2M devices with a single broadcast request. At call 2110, the M2M Server 916 can send a device trigger to the M2M-IWF 918 indicating that a device triggering request should be broadcast to one or more M2M devices. At calls 2112 and 2114, the M2M-IWF 918 can query the HLR 922 and receive the service category. The service category can be defined to correspond to a mode for broadcasting an SMS message including a device triggering request to one or more M2M devices. At call 2116, the M2M-IWF 918 sends broadcast SMS request for device triggering to the MC/SMS-SC 920 using an MAP SMDPP INVOKE message with SMS_BearData set to trigger message that includes the broadcast teleservice (SCPT) and SMS_BTTI including the service categories (SC). At this point the M2M-IWF 918 can start the SMT. At call 2118, the MC/SMS-SC 920 acknowledges the SMDPP message to the M2M-IWF 918 at which point the SMT can stop if the acknowledgement is received. At calls 2120 and 2122, the MC/SMS-SC 920 queries the HLR 922 using the service category in the SMS_BTTI to retrieve the broadcast address including information about the zones and the MSCs that are part of the broadcast domain. At call 2124, the MC/SMS-SC 920 constructs a MAP SMDPP INVOKE message with SMS_BearData parameter including a triggering message, broadcast teleservice and service categories and sends the message to the MSC/MSCe 924. At this point, the MC/SMS-SC 920 can start an SMT. When the MSC/MSCe 924 receives the SMDPP INVOKE message, the MSC/MSCe 924 can send an empty MAP smdpp at call 2126 to the MC/SMS-SC 920 at which point the SMT can be stopped by the MSC/MSCe 924.

At call 2128, the MSC/MSCe 924 can construct an IOS ADDS Page that includes the triggering message, the broadcast teleservice and service category. The MSC/MSCe 924 sends the IOS ADDS page to the RAN/PCF 910. The MSC/MSCe 924 can start a timer T3113 based on the paging request. When the RAN/PCF 910 receives the IOS:ADDS Page message, at call 2130, the RAN/PCF 910 sends an acknowledgment message via a IOS:ADDS Page Ack to the MSC/MSCe 924. At that point the MSC/MSCe 924 can stop the timer T3113. The RAN/PCF 910 then transmits the broadcast triggering message over the common channel at call 2132. The M2M device 902 of the broadcast group can then initiate a communication link with the M2M server 916 by establishing a PPP session or like session and proceed with transferring data with the M2M server 916 in calls 2134, 2136, and 2138 as described above with reference to FIG. 17.

In one implementation, USSD based messaging can be used for point-to-point M2M device triggering while SMS broadcast base messaging can be used for broadcast M2M device triggering. In another implementation, only SMS based messaging can be used for point-to-point M2M device triggering. In yet another implementation only USSD based messaging can be used for M2M device triggering. In yet another implementation, SMS based messaging can be used for point-to-point M2M device triggering while USSD based message can be used for broadcast. As such, any combination of the above can be used.

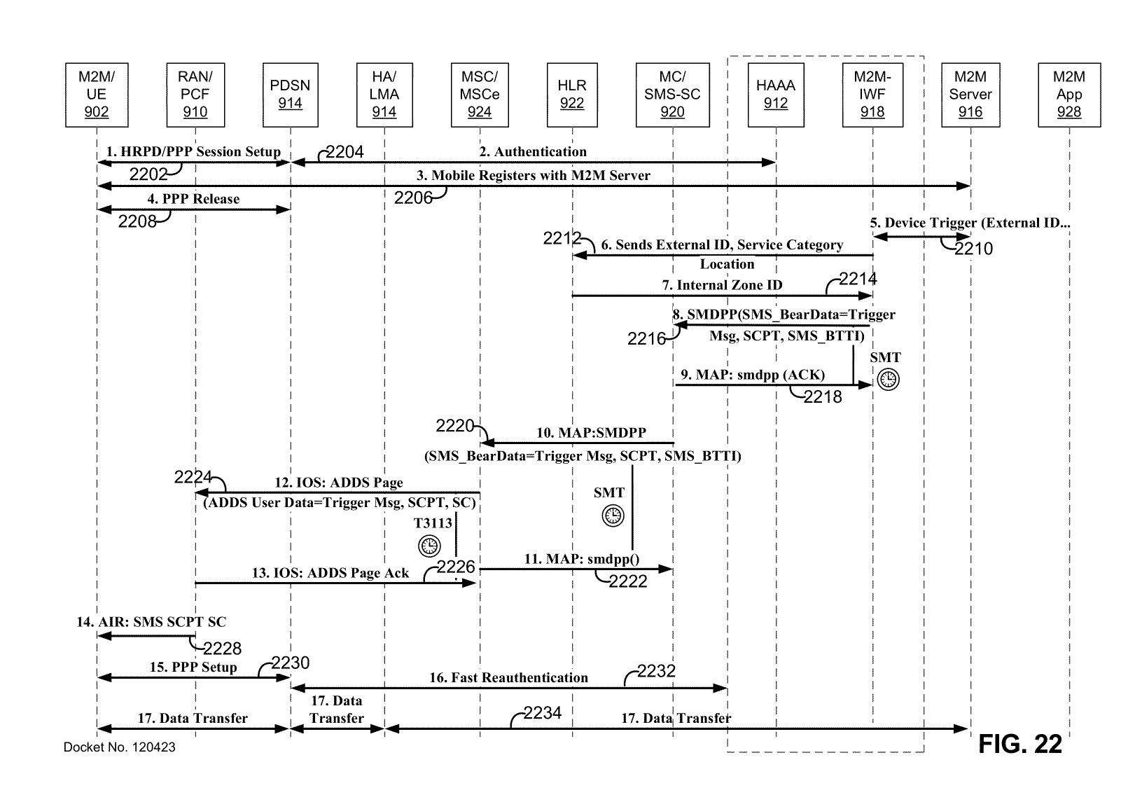

FIG. 22 is a call flow diagram of another exemplary call flow for broadcast machine-to-machine device triggering using an SMS message. In one aspect the broadcast SMS can be used. In this case, a value for a Service Category can be defined for M2M device triggering so that when the SMS parser receives the indication to send the M2M triggering SMS, it can route it to the M2M handler within the MC/SMS-SC 920. The MSC/MSCe 924 can use the broadcast common channel to send the triggering message. In contrast to FIG. 21, the M2M-IWF 918 can send the external ID, service category, and location to the HLR 1612 to receive, in response, an internal location (e.g., internal zone ID) that can be used for example to indicate the broadcast address. In this way the MC/SMS-SC 920 may not need to request the location information from the HLR 922 and can send it directly to the correct MSC/MSCe 924.

Accordingly, initial M2M device registration for any one of multiple M2M devices as shown in calls 2202, 2204, 2206, and 2208 can occur as described above with reference to FIG. 11. As further explanation of the functions of calls 2202, 2204, 2206, and 2208, call 2202 can be associated with a data-session-registration phase which can be a one time event when the M2M device 902 (i.e., UE 902) moves to a different subnet (e.g., HRPD/PZID(1x)). At call 2102, the PDSN can send the subnet ID (HRPD) or PCF_ID (1x) and the IMSI to the HAAA 912 during authentication and authorization. AT call 2106, the device registers with the M2M server 916. At call 2108, the PPP session is torn down and the IP address is released.

At call 2210, the M2M Server 916 can send a device trigger to the M2M-IWF 918 indicating that a device triggering request should be broadcast to one or more M2M devices. At calls 2212 and 2214, the M2M-IWF 918 can query the HLR 922 with the external ID, service category, and location for the broadcast M2M device triggering and receive internal location information via an Internal Zone ID for the broadcast M2M device triggering from the HLR 922. The service category can be defined to correspond to a mode for broadcasting an SMS message including a device triggering request to one or more M2M devices. At call 2216, the M2M-IWF 918 sends broadcast SMS request for device triggering to the MC/SMS-SC 920 using an MAP SMDPP INVOKE message with SMS_BearData set to trigger message that includes the triggering message, the broadcast teleservice (SCPT), and the SMS_BTTI indicating the service category (SC) received from the HLR 922. At this point the M2M-IWF 918 can start the SMT. At call 2218, the MC/SMS-SC 920 acknowledges the SMDPP message to the M2M-IWF 918 at which point the SMT can stop if the acknowledgement is received. As the information obtained originally from the HLR at call 2214 can be sufficient to obtain necessary broadcast information, the MC/SMS-SC 920 may not have to re-query the HLR 922 for additional information. At call 2220, the MC/SMS-SC 920 constructs a MAP SMDPP INVOKE message with SMS_BearData parameter including a triggering message, broadcast SCPT teleservice, and service category and sends the message to the MSC/MSCe 924. At this point, the MC/SMS-SC 920 can start an SMT. When the MSC/MSCe 924 receives the SMDPP INVOKE message, the MSC/MSCe 924 can determine if broadcast M2M device triggering is authorized and sends an empty MAP smdpp at call 2222 to the MC/SMS-SC 920 at which point the SMT can be stopped by the MSC/MSCe 924.

At call 2224, the MSC/MSCe 924 determines if broadcast M2M device triggering is authorized. The MSC/MSCe 924 then constructs an IOS ADDS Page that includes the triggering message, the broadcast teleservice, and service category. The data burst type of the ADDS User Data Informational Element is set to SMS. The SMS-BearData parameter of the MAP SMDPP INVOKE is used to create the Application Data Message of the ADDS User Data Informational Element. The MSC/MSCe 924 sends the IOS ADDS page to the RAN/PCF 910. The MSC/MSCe 924 can start a timer T3113 based on the paging request. When the RAN/PCF 910 receives the IOS:ADDS Page message, at call 2226, the RAN/PCF 910 sends an acknowledgment message via a IOS:ADDS Page Ack to the MSC/MSCe 924. At that point the MSC/MSCe 924 can stop the timer T3113. The RAN/PCF 910 then transmits the broadcast triggering message over the common channel at call 2228. The M2M device 902 of the broadcast group can initiate a communication link with the M2M server 916 by establishing a PPP session or like session and proceed with transferring data with the M2M server 916 in calls 2230, 2232, and 2234 as described above with reference to FIG. 17.

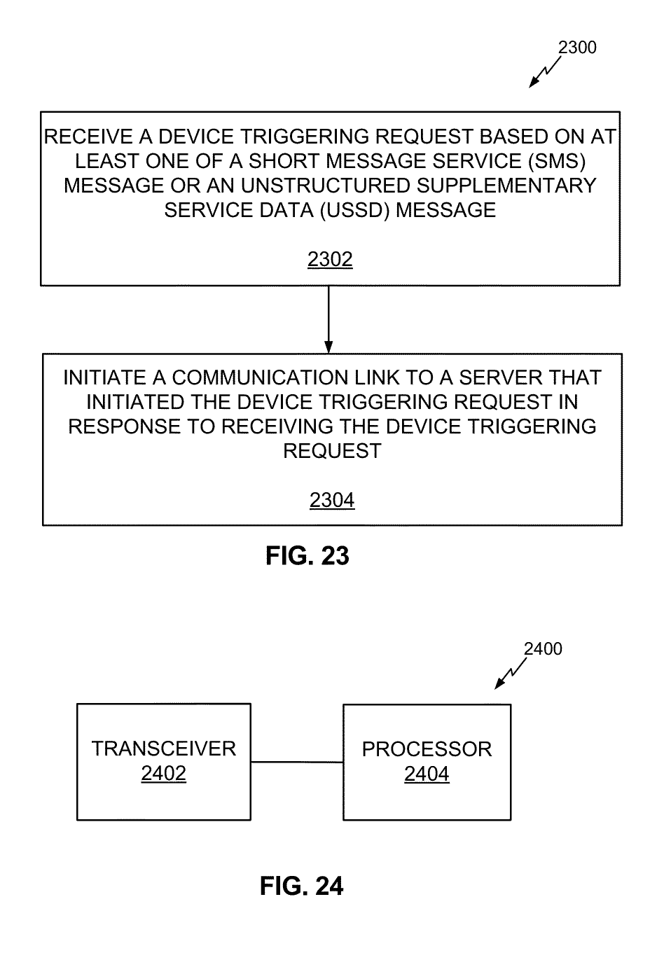

FIG. 23 shows a process flow diagram of an exemplary process 2300 for triggering a device. The process shown in FIG. 23 can be implemented, for example, using the device as described above in FIG. 2 or below in FIG. 24. At block 2302, an M2M device 902 can receive a device triggering request based on at least one of a short message service (SMS) message or an Unstructured Supplementary Service Data (USSD) message. At block 2304, the M2M device 902 can initiate a communication link to a server 916 that initiated the device triggering request in response to receiving the device triggering request.

FIG. 24 shows a functional block diagram of another exemplary device that can be employed within the communication system of FIG. 1. Those skilled in the art will appreciate that a wireless communication device can have more components than the simplified wireless communication device 2400 shown in FIG. 24. The wireless communication device 2400 shown includes only those components useful for describing some prominent features of certain implementations. The wireless communication device 2400 includes a transceiver 2402 and a processor 2404.

The transceiver 2402 can be configured to receive a device triggering request based on at least one of a short message service (SMS) message or an Unstructured Supplementary Service Data (USSD) message. The transceiver 2402 can include one or more of a memory, a processor, and a signal detector. In some implementations the means for transceiving, means for receiving, or means for transmitting includes a transceiver 2402.

The processor 2404 can be configured to initiate a communication link to a server 916 that initiated the device triggering request in response to receiving the device triggering request. In some implementations, the means for initiating can include the processor 2404.

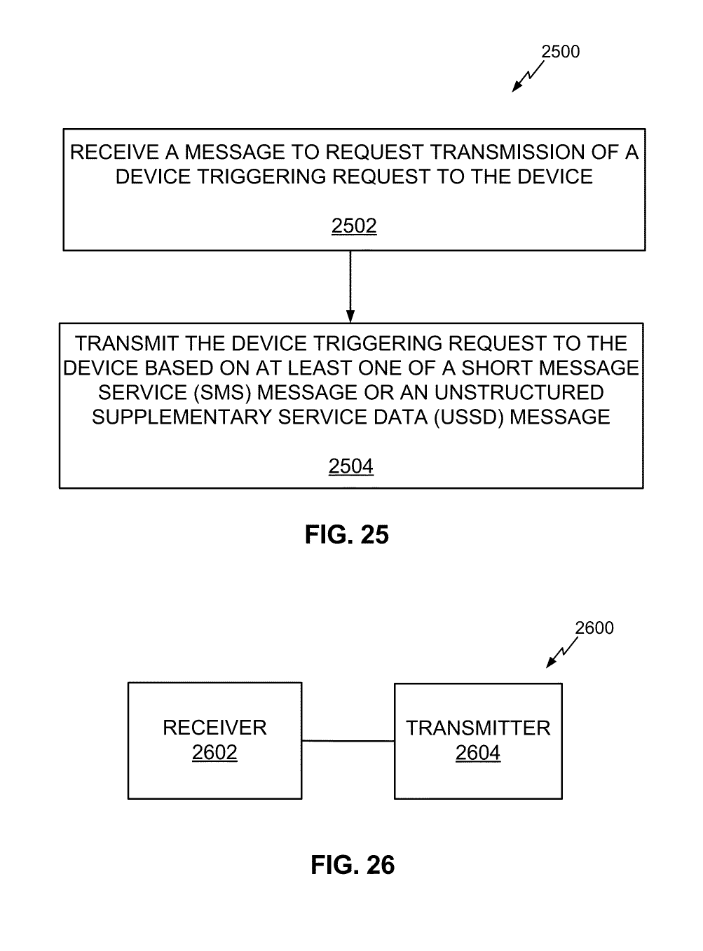

FIG. 25 shows a process flow diagram of an exemplary process 2500 for triggering a device. The process shown in FIG. 25 can be implemented, for example, using the device as described above in FIG. 2 or below in FIG. 26. In one aspect, the process shown in FIG. 25 can be implemented, for example, in a USSD gateway 926 or the SMS-SC 920. At block 2502, a USSD gateway 926 or the SMS-SC 920 can receive a message to request transmission of a device triggering request to an M2M device 902. At block 2504, the USSD gateway 926 or the SMS-SC 920 can transmit the device triggering request to the device based on at least one of a short message service (SMS) message or an Unstructured Supplementary Service Data (USSD) message.

FIG. 26 shows a functional block diagram of another exemplary device that can be employed within the communication system of FIG. 1. Those skilled in the art will appreciate that a wireless communication device can have more components than the simplified wireless communication device 2600 shown in FIG. 26. The wireless communication device 2600 shown includes only those components useful for describing some prominent features of certain implementations. The wireless communication device 2600 includes a receiver 2602 and a transmitter 2604.

The receiver 2602 can be configured to receive a message to request transmission of a device triggering request to an M2M device 902. The receiver 2602 can be implemented in the USSD gateway 926 or the SMS-SC 920. The receiver 2602 can include one or more of a memory, a processor, and a signal detector. In some implementations the means for receiving includes a receiver 2602.

The transmitter 2604 can be configured to transmit the device triggering request to the device 902 based on at least one of a short message service (SMS) message or an Unstructured Supplementary Service Data (USSD) message. The transmitter 2604 can be implemented in the USSD gateway 926 or the SMS-SC 920. In some implementations, the means for transmitting can include the transmitter 2604.

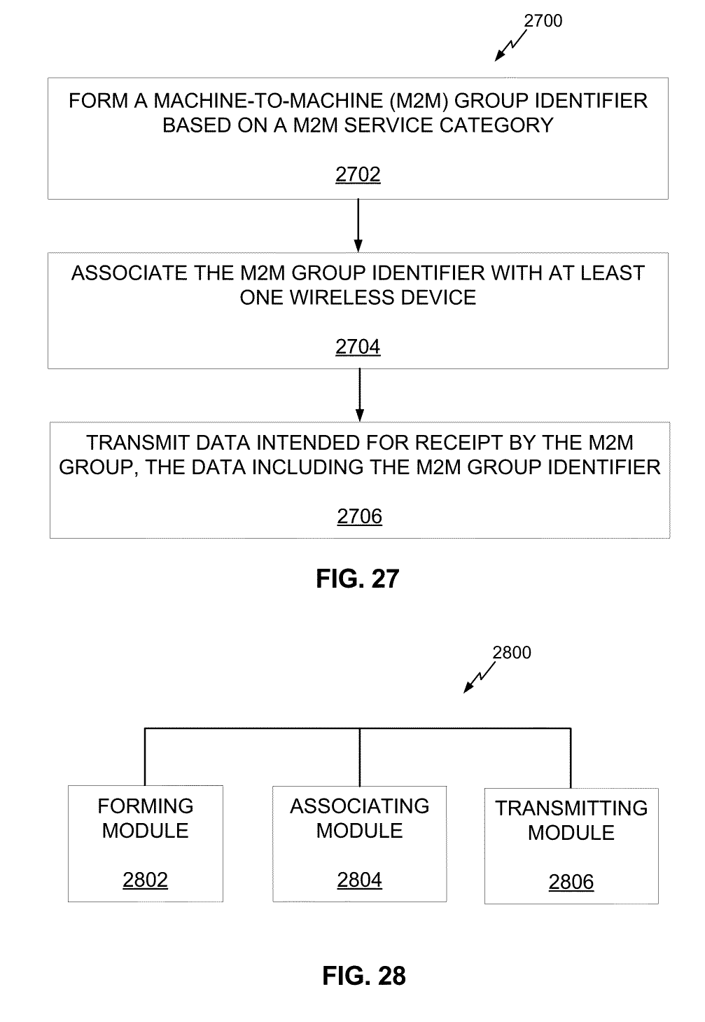

FIG. 27 shows a flowchart for an exemplary method 2700 of wireless communication within the communication system 100 of FIG. 1. One or more of the apparatuses described herein can be configured to implement the method shown in FIG. 27. An AP 104 can be configured to implement the method shown in FIG. 27. Although the method 2700 is described herein with reference to the AP 104, a person having ordinary skill in the art will appreciate that the method 2700 can be implemented by and/or any other suitable device. Moreover, although the method 2700 is described herein with reference to a particular order, in various embodiments, blocks herein can be performed in a different order, or omitted, and additional blocks can be added.

First, at block 2702, the AP 104 forms a machine-to-machine (M2M) group identifier based on a M2M service category. For example, the M2M group identifier and M2M service categories can include those shown above in Table 2. In an embodiment, the AP 104 can determine the M2M service category based on a quality-of-service (QoS) indication

Next, at block 2704, the AP 104 associates the M2M group identifier with at least one wireless device. For example, the AP 104 can associate the M2M group identifier with the device 106a. In an embodiment, the AP 104 can receive an association communication from the at least one wireless device and associate the M2M group identifier based on the association communication.

Then, at block 2706, the AP 104 transmits data intended for receipt by the M2M group. The data can include the M2M group identifier. For example, the AP 104 can transmit a paging message intended for a particular M2M group, or data buffered for one or more devices in a particular M2M group.

FIG. 28 shows a functional block diagram of another exemplary device 2800 that can be employed within the communication system 100 of FIG. 1. Those skilled in the art will appreciate that a wireless communication device can have more components than the simplified wireless communication device 2800 shown in FIG. 28. The wireless communication device 2800 shown includes only those components useful for describing some prominent features of certain implementations. The wireless communication device 2800 includes a forming module 2802, an associating module 2804, and a transmitting module 2806.

In some implementations the forming module 2802 is configured to form a machine-to-machine (M2M) group identifier based on a M2M service category. The forming module 2802 can be configured to implement the block 2702, described above with respect to FIG. 27. The forming module 2802 can include means for forming The forming module 2802 can include one or more of the processor 204 and/or the memory 206, described above with respect to FIG. 2.

The associating module 2804 can be configured to associate the M2M group identifier with at least one wireless device. The associating module 2804 can be configured to implement the block 2704, described above with respect to FIG. 27. The associating module 2804 can include means for associating. The associating module 2804 can include one or more of the processor 204, the processor 204, the memory 206, the network I/O 228, and/or the transmitter 210, described above with respect to FIG. 2.

The transmitting module 2806 can be configured to transmit data intended for receipt by the M2M group. The transmitting module 2806 can be configured to implement the block 2706, described above with respect to FIG. 27. The transmitting module 2806 can include means for transmitting. The transmitting module 2806 can include one or more of the processor 204, the access control processor 232, the memory 206, the network I/O 228, and/or the transmitter 210, described above with respect to FIG. 2.

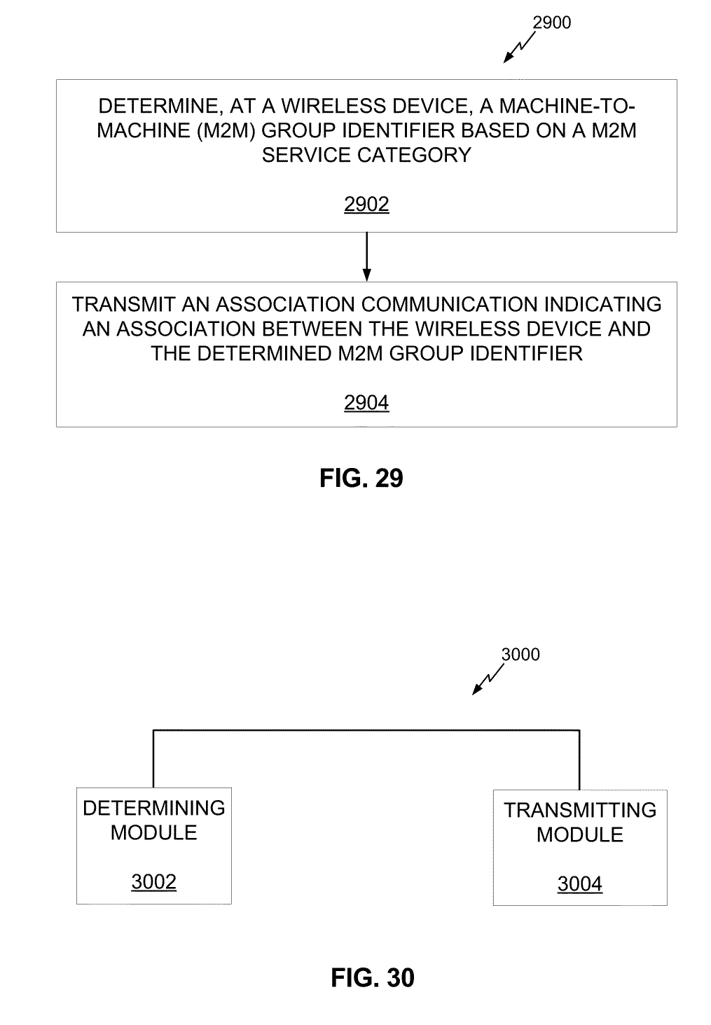

FIG. 29 shows a flowchart for an exemplary method 2900 of wireless communication within the communication system 100 of FIG. 1. One or more of the apparatuses described herein can be configured to implement the method shown in FIG. 29. The device 106a can be configured to implement the method shown in FIG. 29. Although the method 2900 is described herein with reference to the device 106a, a person having ordinary skill in the art will appreciate that the method 2900 can be implemented by and/or any other suitable device. Moreover, although the method 2900 is described herein with reference to a particular order, in various embodiments, blocks herein can be performed in a different order, or omitted, and additional blocks can be added.

First, at block 2902, the device 106a determines a machine-to-machine (M2M) group identifier based on a M2M service category. For example, the M2M group identifier and M2M service categories can include those shown above in Table 2. In an embodiment, the device 106a can determine the M2M service category based on a quality-of-service (QoS) indication

Next, at block 2904, the device 106a transmits an association communication indicating an association between the wireless device and the determined M2M group identifier. For example, association communication can cause the AP 104 to associate the M2M group identifier with the device 106a. In an embodiment, the device 106a can receive data intended for receipt by the M2M group. The data can include the M2M group identifier. For example, the device 106a can receive a paging message intended for a particular M2M group, or data buffered for one or more devices in a particular M2M group.

FIG. 30 shows a functional block diagram of another exemplary device 3000 that can be employed within the communication system 100 of FIG. 1. Those skilled in the art will appreciate that a wireless communication device can have more components than the simplified wireless communication device 3000 shown in FIG. 30. The wireless communication device 3000 shown includes only those components useful for describing some prominent features of certain implementations. The wireless communication device 3000 includes a determining module 3002, and a transmitting module 3004.

In some implementations the determining module 3002 is configured to determine a machine-to-machine (M2M) group identifier based on a M2M service category. The determining module 3002 can be configured to implement the block 2902, described above with respect to FIG. 29. The determining module 3002 can include means for determining. The determining module 3002 can include means for determining. The determining module 3002 can include one or more of the processor 204 and/or the memory 206, described above with respect to FIG. 2.

The transmitting module 3004 can be configured to transmit an association communication indicating an association between the wireless device and the determined M2M group identifier. The transmitting module 3004 can be configured to implement the block 2904, described above with respect to FIG. 29. The transmitting module 3004 can include means for transmitting. The transmitting module 3004 can include one or more of the processor 204, the access control processor 232, the memory 206, the network I/O 228, and/or the transmitter 210, described above with respect to FIG. 2.

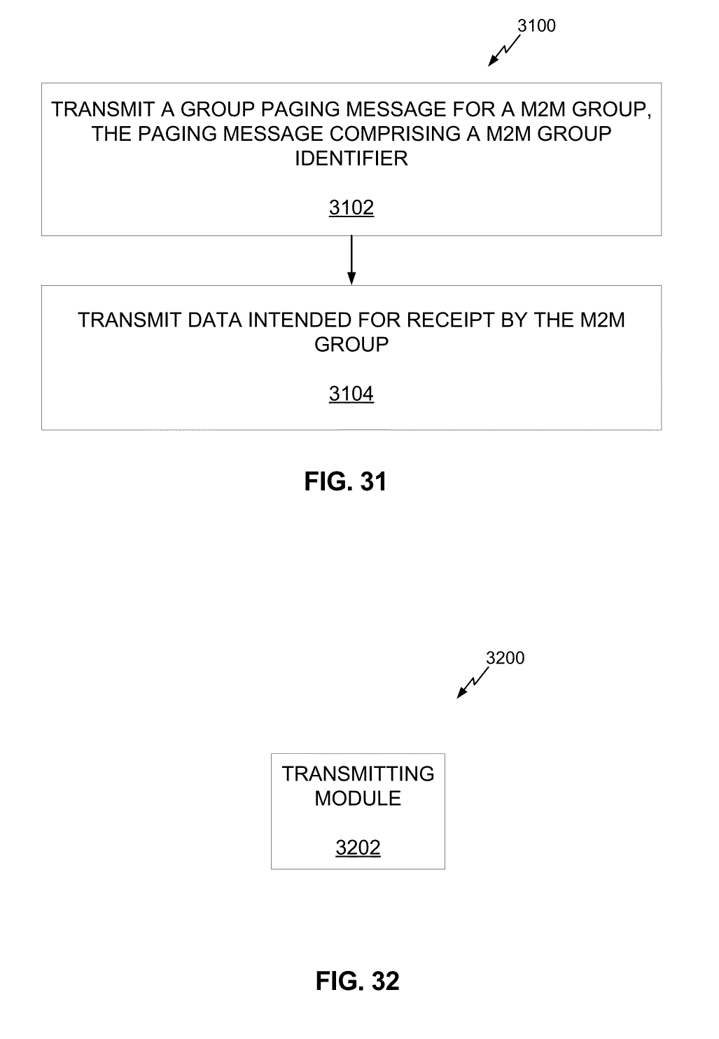

FIG. 31 shows a flowchart for controlling access of a group of wireless devices within the communication system 100 of FIG. 1. One or more of the apparatuses described herein can be configured to implement the method shown in FIG. 31. The AP 104 can be configured to implement the method shown in FIG. 31. Although the method 3100 is described herein with reference to the AP 104, a person having ordinary skill in the art will appreciate that the method 3100 can be implemented by and/or any other suitable device. Moreover, although the method 3100 is described herein with reference to a particular order, in various embodiments, blocks herein can be performed in a different order, or omitted, and additional blocks can be added.

First, at block 3102, the AP 104 transmits a group paging message for the M2M group, the paging message including the M2M group identifier. For example, the M2M group identifier can include those shown above in Table 2. In an embodiment, the AP 104 can prioritize a plurality of group paging messages that each includes a different M2M group identifier. The AP 104 can prioritize the paging messages based on one or more of a latency preference, a data volume per data session, a quality-of-service (QoS) indicator, an M2M class, and/or a subscription level associated with each M2M group. The AP 104 can determine M2M groups based on one or more of a latency preference, a data volume per data session, a quality-of-service (QoS) indicator, an M2M class, and/or a subscription level associated with each M2M group.

Next, at block 3104, the AP 104 transmits data intended for receipt by the M2M group. The data can include the M2M group identifier. For example, the AP 104 can transmit a paging message intended for a particular M2M group, or data buffered for one or more devices in a particular M2M group.

FIG. 32 shows a functional block diagram of another exemplary device 3200 that can be employed within the communication system 100 of FIG. 1. Those skilled in the art will appreciate that a wireless communication device can have more components than the simplified wireless communication device 3200 shown in FIG. 32. The wireless communication device 3200 shown includes only those components useful for describing some prominent features of certain implementations. The wireless communication device 3200 includes a transmitting module 3202.

In some implementations the transmitting module 3202 can be configured to transmit an association communication indicating an association between the wireless device and the determined M2M group identifier. The transmitting module 3202 can be configured to implement the block 3102 and/or block 3104, described above with respect to FIG. 31. The transmitting module 3202 can include means for transmitting. The transmitting module 3202 can include one or more of the processor 204, the memory 206, the network I/O 228, and/or the transmitter 210, described above with respect to FIG. 2.

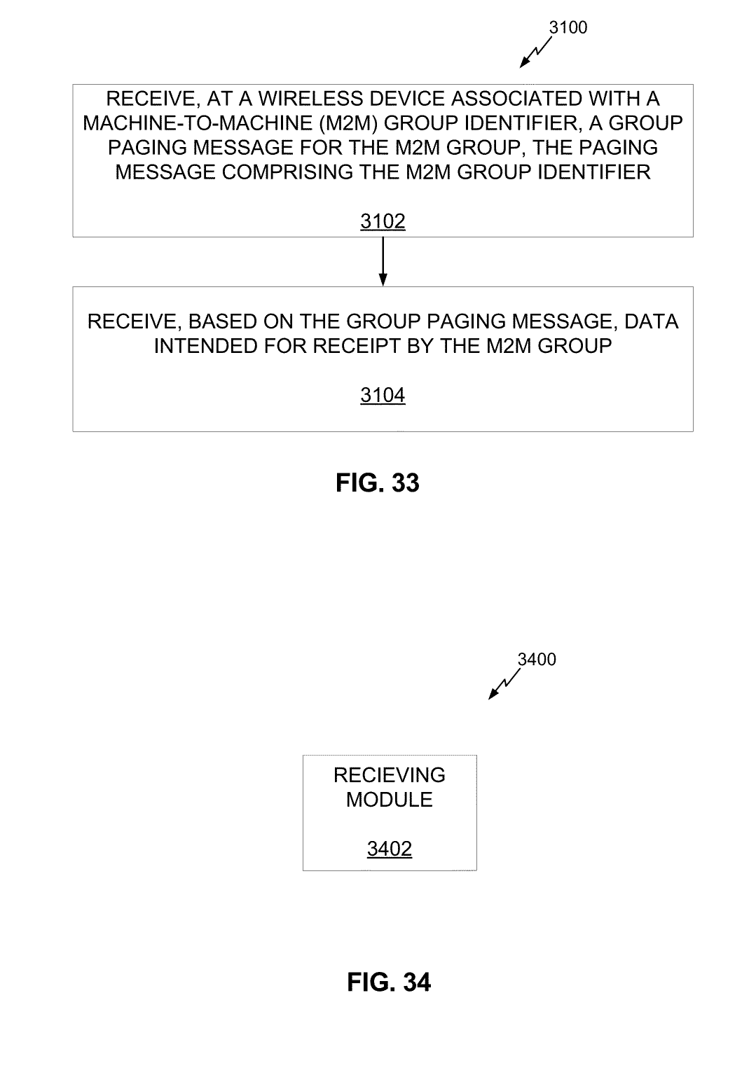

FIG. 33 shows a flowchart for an exemplary method 3300 of controlling access of a group of wireless devices within the communication system 100 of FIG. 1. One or more of the apparatuses described herein can be configured to implement the method shown in FIG. 33. The device 106a can be configured to implement the method shown in FIG. 33. Although the method 3300 is described herein with reference to the device 106a, a person having ordinary skill in the art will appreciate that the method 3300 can be implemented by and/or any other suitable device. Moreover, although the method 3300 is described herein with reference to a particular order, in various embodiments, blocks herein can be performed in a different order, or omitted, and additional blocks can be added.

First, at block 3302, the device 106a receives a group paging message for the M2M group, the paging message including the M2M group identifier. For example, the M2M group identifier can include those shown above in Table 2. In an embodiment, the group paging message can be prioritized based on one or more of a latency preference, a data volume per data session, a quality-of-service (QoS) indicator, an M2M class, and/or a subscription level associated with each M2M group. The device 106a can determine M2M groups based on one or more of a latency preference, a data volume per data session, a quality-of-service (QoS) indicator, an M2M class, and/or a subscription level associated with each M2M group.

Next, at block 3304, the device 106a receives, based on the group paging message, data intended for receipt by the M2M group. The data can include the M2M group identifier. For example, the device 106a can receive data buffered for one or more devices in a particular M2M group.

FIG. 34 shows a functional block diagram of another exemplary device 3400 that can be employed within the communication system 100 of FIG. 1. Those skilled in the art will appreciate that a wireless communication device can have more components than the simplified wireless communication device 3400 shown in FIG. 34. The wireless communication device 3400 shown includes only those components useful for describing some prominent features of certain implementations. The wireless communication device 3400 includes a receiving module 3402.

In some implementations the receiving module 3402 can be configured to receive, based on the group paging message, data intended for receipt by the M2M group. The receiving module 3402 can be configured to implement the block 3302 and/or block 3304, described above with respect to FIG. 33. The receiving module 3402 can include means for receiving. The receiving module 3402 can include one or more of the processor 204, the memory 206, the network I/O 228, and/or the receiver 212, described above with respect to FIG. 2.

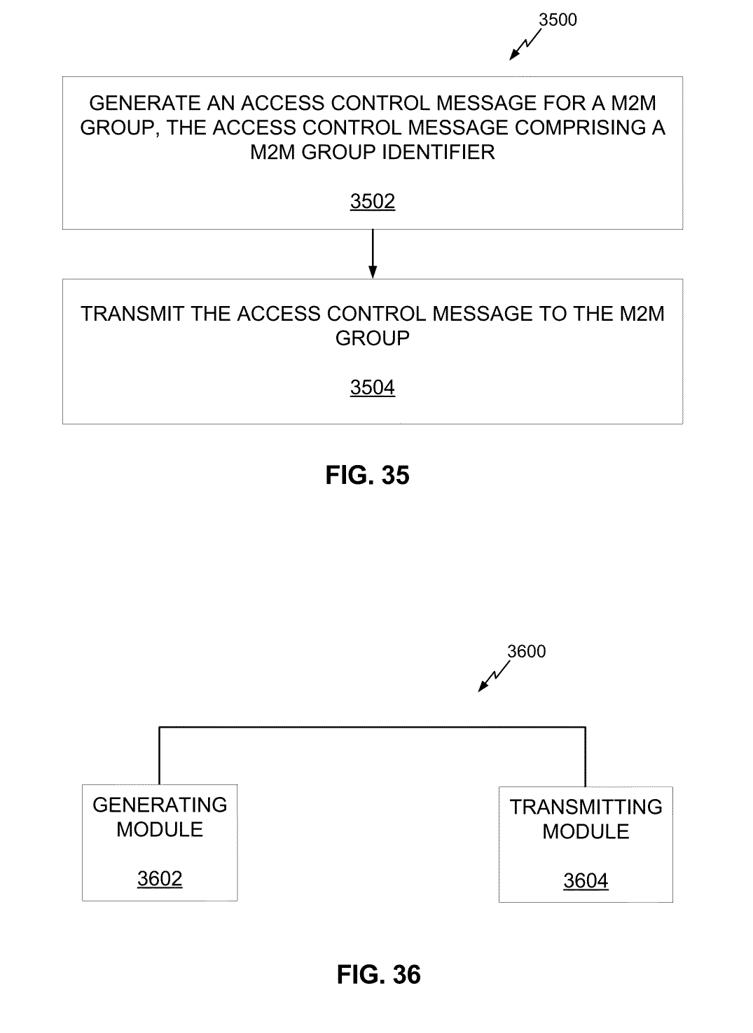

FIG. 35 shows a flowchart for an exemplary method 3500 of controlling access, for a group of wireless devices, to the communication system 100 of FIG. 1. One or more of the apparatuses described herein can be configured to implement the method shown in FIG. 35. An AP 104 can be configured to implement the method shown in FIG. 35. Although the method 3500 is described herein with reference to the AP 104, a person having ordinary skill in the art will appreciate that the method 3500 can be implemented by and/or any other suitable device. Moreover, although the method 3500 is described herein with reference to a particular order, in various embodiments, blocks herein can be performed in a different order, or omitted, and additional blocks can be added.

First, at block 3502, the AP 104 generates an access control message for the M2M group. The access control message can include the M2M group identifier. For example, the M2M group identifier can include those shown above in Table 2. In an embodiment, the access control message indicates a duration and/or time of day that the M2M group is allowed to access the wireless network. In an embodiment, the access control message indicates that the M2M group is not allowed to access the wireless network. In an embodiment, the access control message indicates that the M2M group is not allowed to access a channel of the wireless network. In an embodiment, the access control message restricts access of the M2M group based on one or more of a network loading condition, device subscription information, an M2M class, and a quality-of-service (QoS) indication. In an embodiment, the access control message indicates a backoff parameter and/or an initial transmit power parameter. In an embodiment, the access control message indicates a quality-of-service (QoS) for the M2M group.

Next, at block 3504, the AP 104 transmits the access control message to the M2M group. For example, the AP 104 can transmit the message to the device 106a.

FIG. 36 shows a functional block diagram of another exemplary device 3600 that can be employed within the communication system 100 of FIG. 1. Those skilled in the art will appreciate that a wireless communication device can have more components than the simplified wireless communication device 3600 shown in FIG. 36. The wireless communication device 3600 shown includes only those components useful for describing some prominent features of certain implementations. The wireless communication device 3600 includes a generating module 3602 and a transmitting module 3604.

In some implementations the generating module 3602 is configured to generate an access control message for the M2M group. The access control message can include the M2M group identifier. The generating module 3602 can be configured to implement the block 3502, described above with respect to FIG. 35. The generating module 3602 can include means for generating. The generating module 3602 can include one or more of the processor 204, the access control processor 232, and/or the memory 206, described above with respect to FIG. 2.

The transmitting module 3604 can be configured to transmit the access control message to the M2M group. The transmitting module 3604 can be configured to implement the block 3504, described above with respect to FIG. 35. The transmitting module 3604 can include means for transmitting. The transmitting module 3604 can include one or more of the processor 204, the access control processor 232, the memory 206, the network I/O 228, and/or the transmitter 210, described above with respect to FIG. 2.

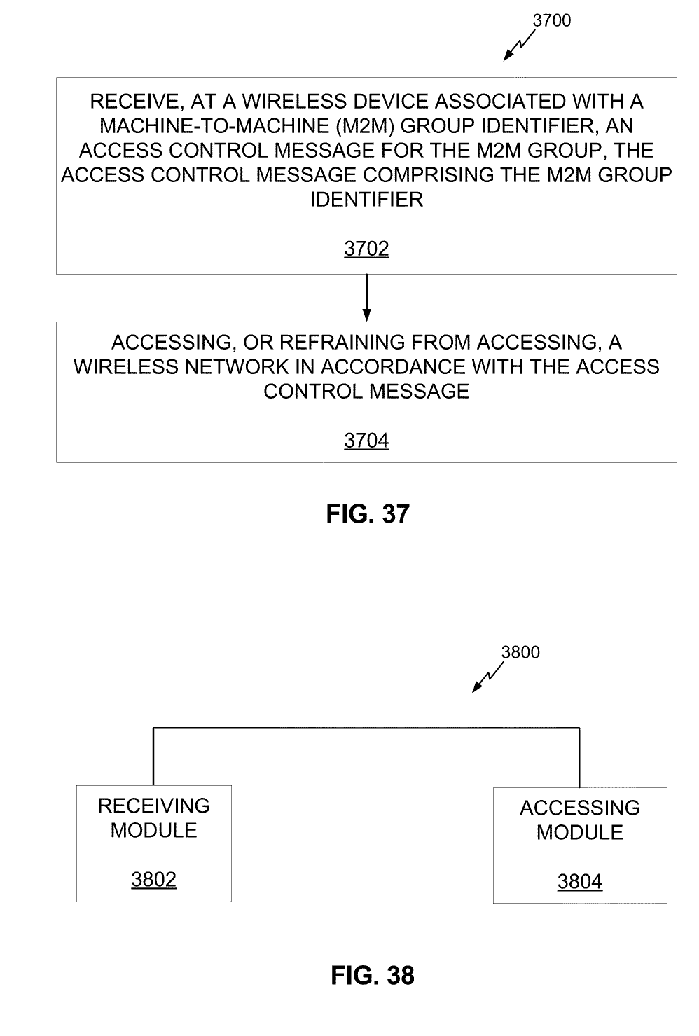

FIG. 37 shows a flowchart for an exemplary method 3700 of accessing the communication system 100 of FIG. 1. One or more of the apparatuses described herein can be configured to implement the method shown in FIG. 37. A device 106a can be configured to implement the method shown in FIG. 37. Although the method 3700 is described herein with reference to the device 106a, a person having ordinary skill in the art will appreciate that the method 3700 can be implemented by and/or any other suitable device. Moreover, although the method 3700 is described herein with reference to a particular order, in various embodiments, blocks herein can be performed in a different order, or omitted, and additional blocks can be added.

First, at block 3702, the device 106a receives an access control message for the M2M group. The access control message can include the M2M group identifier, which can be associated with the device 106a. For example, the M2M group identifier can include those shown above in Table 2. In an embodiment, the access control message indicates a duration and/or time of day that the M2M group is allowed to access the wireless network. In an embodiment, the access control message indicates that the M2M group is not allowed to access the wireless network. In an embodiment, the access control message indicates that the M2M group is not allowed to access a channel of the wireless network. In an embodiment, the access control message restricts access of the M2M group based on one or more of a network loading condition, device subscription information, an M2M class, and a quality-of-service (QoS) indication. In an embodiment, the access control message indicates a backoff parameter and/or an initial transmit power parameter. In an embodiment, the access control message indicates a quality-of-service (QoS) for the M2M group.

Next, at block 3704, the device 106a accesses, or refrains from accessing, the wireless network in accordance with the access control message. In an embodiment, the device 106a accesses the network based on a duration and/or time of day that the M2M group is allowed to access the wireless network. In an embodiment, the device 106 refrains from accessing the network when the access control message indicates that the M2M group associated with the device 106a is not allowed to access the wireless network. In an embodiment, the device 106 refrains from accessing a channel of the wireless network based on the access control message. In an embodiment, the device 106a implements a backoff parameter and/or an initial transmit power parameter based on the access control message.

FIG. 38 shows a functional block diagram of another exemplary device 3800 that can be employed within the communication system 100 of FIG. 1. Those skilled in the art will appreciate that a wireless communication device can have more components than the simplified wireless communication device 3800 shown in FIG. 38. The wireless communication device 3800 shown includes only those components useful for describing some prominent features of certain implementations. The wireless communication device 3800 includes a receiving module 3802 and an accessing module 3804.

In some implementations the receiving module 3802 is configured to receive an access control message for the M2M group. The access control message can include the M2M group identifier. The receiving module 3802 can be configured to implement the block 3702, described above with respect to FIG. 37. The receiving module 3802 can include means for receiving. The receiving module 3802 can include one or more of the processor 204, the access control processor 232, the memory 206, the network I/O 228, and/or the receiver 212, described above with respect to FIG. 2.

The accessing module 3804 can be configured to access, or refraining from accessing, the wireless network in accordance with the access control message. The accessing module 3804 can be configured to implement the block 3704, described above with respect to FIG. 37. The accessing module 3804 can include means for accessing. The accessing module 3804 can include one or more of the processor 204, the access control processor 232, the memory 206, the network I/O 228, and/or the transmitter 210, described above with respect to FIG. 2.

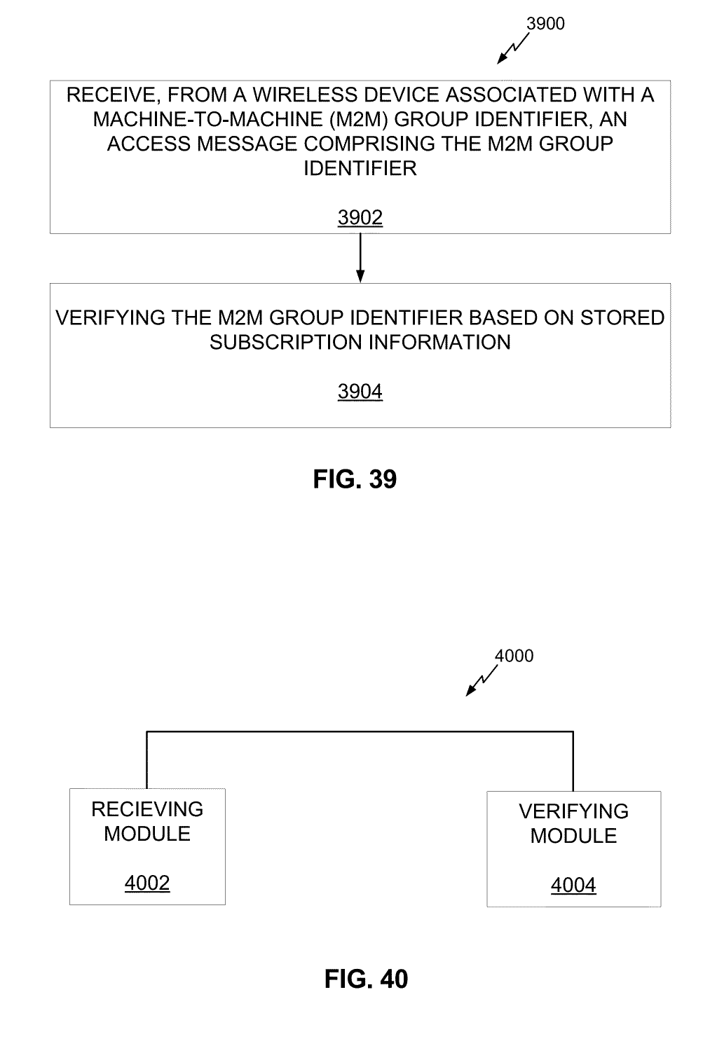

FIG. 39 shows a flowchart for an exemplary method 3900 of controlling access, for a group of wireless devices, to the communication system 100 of FIG. 1. One or more of the apparatuses described herein can be configured to implement the method shown in FIG. 39. An AP 104 can be configured to implement the method shown in FIG. 39. Although the method 3900 is described herein with reference to the AP 104, a person having ordinary skill in the art will appreciate that the method 3900 can be implemented by and/or any other suitable device. Moreover, although the method 3900 is described herein with reference to a particular order, in various embodiments, blocks herein can be performed in a different order, or omitted, and additional blocks can be added.

First, at block 3902, the AP 104 receives an access message. The access message can include the M2M group identifier. For example, the M2M group identifier can include those shown above in Table 2. In various embodiments, the access message can include one or more a registration message, a call origination message, a page response message, an attachment message, and a radio resource control (RRC) message.

Next, at block 3904, the AP 104 verifies the M2M group identifier based on stored subscription information. For example, the AP 104 can retrieve stored subscription information for the device 106a from a memory. The AP 104 can compare the M2M group identifier received from the device 106a to the stored subscription information. Based on the comparison, the AP 104 can allow or deny access, update one or more parameters of the device 106a, etc. The AP 104 can transmit a message to the device 106a indicating a verification of the M2M group identifier.

FIG. 40 shows a functional block diagram of another exemplary device 4000 that can be employed within the communication system 100 of FIG. 1. Those skilled in the art will appreciate that a wireless communication device can have more components than the simplified wireless communication device 4000 shown in FIG. 40. The wireless communication device 4000 shown includes only those components useful for describing some prominent features of certain implementations. The wireless communication device 4000 includes a receiving module 4002 and a verifying module 4004.

In some implementations the receiving module 4002 is configured to receive an access message. The access message can include the M2M group identifier. The receiving module 4002 can be configured to implement the block 3902, described above with respect to FIG. 39. The receiving module 4002 can include means for receiving. The receiving module 4002 can include one or more of the processor 204, the access control processor 232, the memory 206, the network I/O 228, and/or the receiver 212, described above with respect to FIG. 2.

The verifying module 4004 can be configured to verify the M2M group identifier based on stored subscription information. The verifying module 4004 can be configured to implement the block 3904, described above with respect to FIG. 39. The verifying module 4004 can include means for verifying. The verifying module 4004 can include one or more of the processor 204, the access control processor 232, the memory 206, the network I/O 228, and/or the receiver 212, described above with respect to FIG. 2.

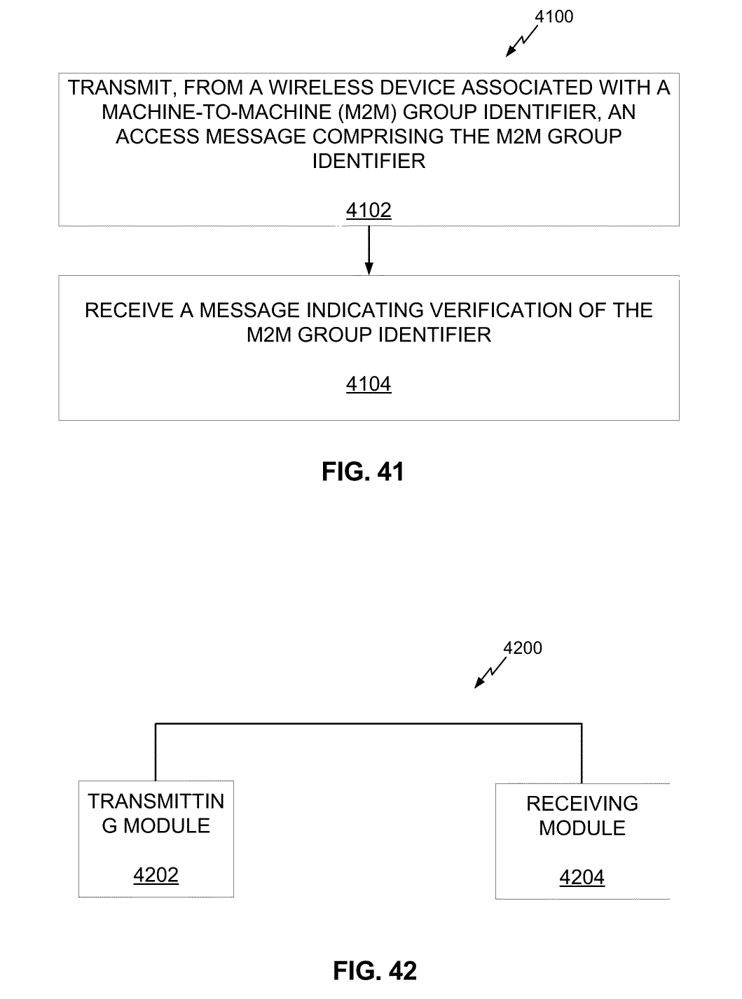

FIG. 41 shows a flowchart for an exemplary method 4100 of accessing the communication system 100 of FIG. 1. One or more of the apparatuses described herein can be configured to implement the method shown in FIG. 41. A device 106a can be configured to implement the method shown in FIG. 41. Although the method 4100 is described herein with reference to the device 106a, a person having ordinary skill in the art will appreciate that the method 4100 can be implemented by and/or any other suitable device. Moreover, although the method 4100 is described herein with reference to a particular order, in various embodiments, blocks herein can be performed in a different order, or omitted, and additional blocks can be added.

First, at block 4102, the device 106a transmits an access message including the M2M group identifier to the AP 104. The access message can include the M2M group identifier, which can be associated with the device 106a. For example, the M2M group identifier can include those shown above in Table 2. In various embodiments, the access message can include one or more a registration message, a call origination message, a page response message, an attachment message, and a radio resource control (RRC) message.

Next, at block 4104, the device 106a receives a message indicating verification of the M2M group identifier. For example, the device 106a can receive a verification message from the AP 104. The verification message can allow or deny access to the network, update a parameter of the device 106a, etc.

FIG. 42 shows a functional block diagram of another exemplary device 4200 that can be employed within the communication system 100 of FIG. 1. Those skilled in the art will appreciate that a wireless communication device can have more components than the simplified wireless communication device 4200 shown in FIG. 42. The wireless communication device 4200 shown includes only those components useful for describing some prominent features of certain implementations. The wireless communication device 4200 includes a transmitting module 4202 and a receiving module 4204.

In some implementations the transmitting module 4202 is configured to transmit an access message. The access message can include the M2M group identifier. The transmitting module 4202 can be configured to implement the block 4102, described above with respect to FIG. 41. The transmitting module 4202 can include means for transmitting. The transmitting module 4202 can include one or more of the processor 204, the access control processor 232, the memory 206, the network I/O 228, and/or the transmitter 210, described above with respect to FIG. 2.

The receiving module 4204 can be configured to receive a message indicating verification of the M2M group identifier. The receiving module 4204 can be configured to implement the block 4104, described above with respect to FIG. 41. The receiving module 4204 can include means for receiving. The receiving module 4204 can include one or more of the processor 204, the access control processor 232, the memory 206, the network I/O 228, and/or the receiver 212, described above with respect to FIG. 2.

As used herein, the term “determining” encompasses a wide variety of actions. For example, “determining” can include calculating, computing, processing, deriving, investigating, looking up (e.g., looking up in a table, a database or another data structure), ascertaining and the like. Also, “determining” can include receiving (e.g., receiving information), accessing (e.g., accessing data in a memory) and the like. Also, “determining” can include resolving, selecting, choosing, establishing and the like. Further, a “channel width” as used herein can encompass or can also be referred to as a bandwidth in certain aspects.

As used herein, a phrase referring to “at least one of” a list of items refers to any combination of those items, including single members. As an example, “at least one of: a, b, or c” is intended to cover: a, b, c, a-b, a-c, b-c, and a-b-c.

The various operations of methods described above can be performed by any suitable means capable of performing the operations, such as various hardware and/or software component(s), circuits, and/or module(s). Generally, any operations illustrated in the Figures can be performed by corresponding functional means capable of performing the operations.

The various illustrative logical blocks, modules and circuits described in connection with the present disclosure can be implemented or performed with a general purpose processor, a digital signal processor (DSP), an application specific integrated circuit (ASIC), a field programmable gate array signal (FPGA) or other programmable logic device (PLD), discrete gate or transistor logic, discrete hardware components or any combination thereof designed to perform the functions described herein. A general purpose processor can be a microprocessor, but in the alternative, the processor can be any commercially available processor, controller, microcontroller or state machine. A processor can also be implemented as a combination of computing devices, e.g., a combination of a DSP and a microprocessor, a plurality of microprocessors, one or more microprocessors in conjunction with a DSP core, or any other such configuration.

In one or more aspects, the functions described can be implemented in hardware, software, firmware, or any combination thereof. If implemented in software, the functions can be stored on or transmitted over as one or more instructions or code on a computer-readable medium. Computer-readable media includes both computer storage media and communication media including any medium that facilitates transfer of a computer program from one place to another. A storage media can be any available media that can be accessed by a computer. By way of example, and not limitation, such computer-readable media can include RAM, ROM, EEPROM, CD-ROM or other optical disk storage, magnetic disk storage or other magnetic storage devices, or any other medium that can be used to carry or store desired program code in the form of instructions or data structures and that can be accessed by a computer. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. Disk and disc, as used herein, includes compact disc (CD), laser disc, optical disc, digital versatile disc (DVD), floppy disk and blu-ray disc where disks usually reproduce data magnetically, while discs reproduce data optically with lasers. Thus, in some aspects computer readable medium can include non-transitory computer readable medium (e.g., tangible media). In addition, in some aspects computer readable medium can include transitory computer readable medium (e.g., a signal). Combinations of the above should also be included within the scope of computer-readable media.

The methods disclosed herein include one or more steps or actions for achieving the described method. The method steps and/or actions can be interchanged with one another without departing from the scope of the claims. In other words, unless a specific order of steps or actions is specified, the order and/or use of specific steps and/or actions can be modified without departing from the scope of the claims.

The functions described can be implemented in hardware, software, firmware or any combination thereof. If implemented in software, the functions can be stored as one or more instructions on a computer-readable medium. A storage media can be any available media that can be accessed by a computer. By way of example, and not limitation, such computer-readable media can include RAM, ROM, EEPROM, CD-ROM or other optical disk storage, magnetic disk storage or other magnetic storage devices, or any other medium that can be used to carry or store desired program code in the form of instructions or data structures and that can be accessed by a computer. Disk and disc, as used herein, include compact disc (CD), laser disc, optical disc, digital versatile disc (DVD), floppy disk, and Blu-ray® disc where disks usually reproduce data magnetically, while discs reproduce data optically with lasers.

Thus, certain aspects can include a computer program product for performing the operations presented herein. For example, such a computer program product can include a computer readable medium having instructions stored (and/or encoded) thereon, the instructions being executable by one or more processors to perform the operations described herein. For certain aspects, the computer program product can include packaging material.

Software or instructions can also be transmitted over a transmission medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of transmission medium.

Further, it should be appreciated that modules and/or other appropriate means for performing the methods and techniques described herein can be downloaded and/or otherwise obtained by a user terminal and/or base station as applicable. For example, such a device can be coupled to a server to facilitate the transfer of means for performing the methods described herein. Alternatively, various methods described herein can be provided via storage means (e.g., RAM, ROM, a physical storage medium such as a compact disc (CD) or floppy disk, etc.), such that a user terminal and/or base station can obtain the various methods upon coupling or providing the storage means to the device. Moreover, any other suitable technique for providing the methods and techniques described herein to a device can be utilized.

It is to be understood that the claims are not limited to the precise configuration and components illustrated above. Various modifications, changes and variations can be made in the arrangement, operation and details of the methods and apparatus described above without departing from the scope of the claims.

While the foregoing is directed to aspects of the present disclosure, other and further aspects of the disclosure can be devised without departing from the basic scope thereof, and the scope thereof is determined by the claims that follow.

What is claimed is:

1. A method of wireless communication comprising:
forming a machine-to-machine (M2M) group identifier based on a M2M service category;
associating the M2M group identifier with at least one wireless device; and
transmitting data intended for receipt by the M2M group, the data comprising the M2M group identifier.

2. The method of claim 1, further comprising determining the M2M service category based on a quality-of-service (QoS) indication.

3. The method of claim 1, wherein associating the M2M group identifier with at least one wireless device comprises receiving an association communication from the at least one wireless device.

4. A method of wireless communication comprising:
determining, at a wireless device, a machine-to-machine (M2M) group identifier based on a M2M service category; and
transmitting an association communication indicating an association between the wireless device and the determined M2M group identifier.

5. The method of claim 4, further comprising determining the M2M service category based on a quality-of-service (QoS) indication.

6. The method of claim 4, further comprising receiving data intended for receipt by the M2M group, the data comprising the M2M group identifier.

7. An apparatus configured to communicate wirelessly comprising:
a processor configured to:
form a machine-to-machine (M2M) group identifier based on a M2M service category; and
associate the M2M group identifier with at least one wireless device; and
a transmitter configured to transmit data intended for receipt by the M2M group, the data comprising the M2M group identifier.

8. The apparatus of claim 7, wherein the processor is further configured to determine the M2M service category based on a quality-of-service (QoS) indication.

9. The apparatus of claim 7, wherein the processor is further configured to associate the M2M group identifier with at least one wireless device by receiving an association communication from the at least one wireless device.

10. A wireless device comprising:
a processor configured to determine a machine-to-machine (M2M) group identifier based on a M2M service category; and
a transmitter configured to transmit an association communication indicating an association between the wireless device and the determined M2M group identifier.

11. An apparatus for wireless communication comprising:
means for forming a machine-to-machine (M2M) group identifier based on a M2M service category;
means for associating the M2M group identifier with at least one wireless device; and
means for transmitting data intended for receipt by the M2M group, the data comprising the M2M group identifier.

12. An apparatus for wireless communication comprising:
means for determining a machine-to-machine (M2M) group identifier based on a M2M service category; and
means for transmitting an association communication indicating an association between the apparatus and the determined M2M group identifier.

13. A non-transitory computer-readable medium comprising code that, when executed, causes an apparatus to:
form a machine-to-machine (M2M) group identifier based on a M2M service category;
associate the M2M group identifier with at least one wireless device; and
transmit data intended for receipt by the M2M group, the data comprising the M2M group identifier.

14. A non-transitory computer-readable medium comprising code that, when executed, causes an apparatus to:
determine a machine-to-machine (M2M) group identifier based on a M2M service category; and
transmit an association communication indicating an association between the apparatus and the determined M2M group identifier.

15. A method of controlling access of a group of wireless devices associated with a machine-to-machine (M2M) group identifier, the method comprising:
transmitting a group paging message for the M2M group, the paging message comprising the M2M group identifier; and
transmitting data intended for receipt by the M2M group.

16. The method of claim 15, further comprising prioritizing a plurality of group paging messages, each paging message comprising a different M2M group identifier, based on one or more of a latency preference, a data volume per data session, a quality-of-service (QoS) indicator, an M2M class, and/or a subscription level associated with each M2M group.

17. The method of claim 16, further comprising determining the M2M groups based on one or more of a latency preference, a data volume per data session, a quality-of-service (QoS) indicator, an M2M class, and/or a subscription level.

18. The method of claim 16, further comprising applying an intra-group paging delay.

19. A method of accessing a wireless network, comprising:
receiving, at a wireless device associated with a machine-to-machine (M2M) group identifier, a group paging message for the M2M group, the paging message comprising the M2M group identifier; and
receiving, based on the group paging message, data intended for receipt by the M2M group.

20. An apparatus configured to control wireless network access for a group of wireless devices associated with a machine-to-machine (M2M) group identifier, the apparatus comprising a transmitter configured to:
transmit configured to transmit a group paging message for the M2M group, the paging message comprising the M2M group identifier; and
transmit data intended for receipt by the M2M group.

21. An apparatus associated with a machine-to-machine (M2M) group identifier and configured to access a wireless network, comprising a receiver configured to:
receive a group paging message for the M2M group, the paging message comprising the M2M group identifier; and
receive, based on the group paging message, data intended for receipt by the M2M group.

22. An apparatus for controlling access of a group of wireless devices associated with a machine-to-machine (M2M) group identifier, the apparatus comprising:
means for transmitting a group paging message for the M2M group, the paging message comprising the M2M group identifier; and
means for transmitting data intended for receipt by the M2M group.

23. An apparatus for accessing a wireless network, comprising:
means for receiving, at a wireless device associated with a machine-to-machine (M2M) group identifier, a group paging message for the M2M group, the paging message comprising the M2M group identifier; and
means for receiving, based on the group paging message, data intended for receipt by the M2M group.

24. A non-transitory computer-readable medium comprising code that, when executed, causes an apparatus to:
transmit a group paging message for a group of wireless devices associated with a machine-to-machine (M2M) group identifier, the paging message comprising the M2M group identifier; and
transmit data intended for receipt by the M2M group.

25. A non-transitory computer-readable medium comprising code that, when executed, causes an apparatus associated with a machine-to-machine (M2M) group identifier to:
receive a group paging message for the M2M group, the paging message comprising the M2M group identifier; and
receive, based on the group paging message, data intended for receipt by the M2M group.

26. A method of controlling access to a wireless network for a group of wireless devices associated with a machine-to-machine (M2M) group identifier, the method comprising:
generating an access control message for the M2M group, the access control message comprising the M2M group identifier; and
transmitting the access control message to the M2M group.

27. The method of claim 26, wherein the access control message indicates a duration and/or time of day that the M2M group is allowed to access the wireless network.

28. The method of claim 26, wherein the access control message indicates that the M2M group is not allowed to access the wireless network.

29. The method of claim 26, wherein the access control message indicates that the M2M group is not allowed to access a channel of the wireless network.

30. The method of claim 26, wherein the access control message restricts access of the M2M group based on one or more of a network loading condition, device subscription information, an M2M class, and a quality-of-service (QoS) indication.

31. The method of claim 26, wherein the access control message indicates a backoff parameter and/or an initial transmit power parameter.

32. The method of claim 26, wherein the access control message indicates a quality-of-service (QoS) for the M2M group.

33. A method of wireless network access, the method comprising:
receiving, at a wireless device associated with a machine-to-machine (M2M) group identifier, an access control message for the M2M group, the access control message comprising the M2M group identifier; and
accessing, or refraining from accessing, the wireless network in accordance with the access control message.

34. The method of claim 33, wherein the access control message indicates a duration and/or time of day that the M2M group is allowed to access the wireless network.

35. The method of claim 33, wherein the access control message indicates that the M2M group is not allowed to access the wireless network.

36. The method of claim 33, wherein the access control message indicates that the M2M group is not allowed to access a channel of the wireless network.

37. The method of claim 33, wherein the access control message restricts access of the M2M group based on one or more of a network loading condition, device subscription information, an M2M class, and a quality-of-service (QoS) indication.

38. The method of claim 33, wherein the access control message indicates a backoff parameter and/or an initial transmit power parameter.

39. The method of claim 33, wherein the access control message indicates a quality-of-service (QoS) for the M2M group.

40. An apparatus configured to control access to a wireless network for a group of wireless devices associated with a machine-to-machine (M2M) group identifier, the apparatus comprising:
a processor configured to generate an access control message for the M2M group, the access control message comprising the M2M group identifier; and
a transmitter configured to transmit the access control message to the M2M group.

41. An apparatus associated with a machine-to-machine (M2M) group identifier, configured to access a wireless network, the apparatus comprising:
a receiver configured to receive an access control message for the M2M group, the access control message comprising the M2M group identifier; and
a processor configured to access, or refrain from accessing, the wireless network in accordance with the access control message.

42. An apparatus for controlling access to a wireless network for a group of wireless devices associated with a machine-to-machine (M2M) group identifier, the apparatus comprising:
means for generating an access control message for the M2M group, the access control message comprising the M2M group identifier; and
means for transmitting the access control message to the M2M group.

43. An apparatus for wireless network access, the apparatus associated with a machine-to-machine (M2M) group identifier and comprising:
means for receiving the access control message comprising the M2M group identifier; and
means for accessing, or refraining from accessing, the wireless network in accordance with the access control message.

44. A non-transitory computer-readable medium comprising code that, when executed, causes an apparatus to:
generate an access control message for a group of wireless devices associated with a machine-to-machine (M2M) group identifier, the access control message comprising the M2M group identifier; and
transmit the access control message to the M2M group.

45. A non-transitory computer-readable medium comprising code that, when executed, causes an apparatus associated with a machine-to-machine (M2M) group identifier to:
receive an access control message for the M2M group, the access control message comprising the M2M group identifier; and
access, or refrain from accessing, the wireless network in accordance with the access control message.

46. A method of controlling access to a wireless network for a group of wireless devices associated with a machine-to-machine (M2M) group identifier, the method comprising:
receiving, from a wireless device associated with a machine-to-machine (M2M) group identifier, an access message comprising the M2M group identifier; and
verifying the M2M group identifier based on stored subscription information.

47. The method of claim 46, wherein the access message comprises one or more of a registration message, a call origination message, a page response message, an attachment message, and a radio resource control (RRC) message.

48. A method of wireless network access, the method comprising:
transmitting, from a wireless device associated with a machine-to-machine (M2M) group identifier, an access message comprising the M2M group identifier; and
receiving a message indicating verification of the M2M group identifier.

49. The method of claim 48, wherein the access message comprises one or more of a registration message, a call origination message, a page response message, an attachment message, and a radio resource control (RRC) message.

50. An apparatus configured to control access to a wireless network for a group of wireless devices associated with a machine-to-machine (M2M) group identifier, the apparatus comprising:
a receiver configured to receive, from a wireless device associated with a machine-to-machine (M2M) group identifier, an access message comprising the M2M group identifier; and
a processor configured to verify the M2M group identifier based on stored subscription information.

51. An apparatus associated with a machine-to-machine (M2M) group identifier and configured to access a wireless network, the apparatus comprising:
a transmitter configured to transmit an access message comprising the M2M group identifier; and
a receiver configured to receive a message indicating verification of the M2M group identifier.

52. An apparatus for controlling access to a wireless network for a group of wireless devices associated with a machine-to-machine (M2M) group identifier, the apparatus comprising:
means for receiving, from a wireless device associated with a machine-to-machine (M2M) group identifier, an access message comprising the M2M group identifier; and
means for verifying the M2M group identifier based on stored subscription information.

53. An apparatus for wireless network access, the apparatus associated with a machine-to-machine (M2M) group identifier and comprising:
means for transmitting an access message comprising the M2M group identifier; and
means for receiving a message indicating verification of the M2M group identifier.

54. A non-transitory computer-readable medium comprising code that, when executed, causes an apparatus to:
receive, from a wireless device associated with a machine-to-machine (M2M) group identifier, an access message comprising the M2M group identifier; and
verify the M2M group identifier based on stored subscription information.

55. A non-transitory computer-readable medium comprising code that, when executed, causes an apparatus associated with a machine-to-machine (M2M) group identifier to:
transmit access message comprising the M2M group identifier; and
receive a message indicating verification of the M2M group identifier.

56. A method for triggering a device, the method comprising:
receiving a device triggering request based on at least one of a short message service (SMS) message or an Unstructured Supplementary Service Data (USSD) message; and
initiating a communication link to a server that initiated the device triggering request in response to receiving the device triggering request.

57. The method of claim 56, wherein the device triggering request is based on the USSD message.

58. The method of claim 56, wherein the USSD message comprises a USSD REGISTER message for establishing a communication session with the device, and wherein the method further includes transmitting a USSD RELEASE COMPLETE message to end the communication session.

59. The method of claim 56, wherein the SMS message is associated with a teleservice defined for device triggering.

60. The method of claim 56, wherein the device triggering request is received as part of a broadcast of the device triggering request to one or more devices including the device.

61. The method of claim 60, wherein the SMS message is associated with a service category defined for broadcasting device triggering requests.

62. The method of claim 60, wherein a proxy entity for the device is configured to send a message to release a session associated with the USSD message.

63. The method of claim 56, wherein the device triggering request is received over one of a traffic channel or a common channel.

64. The method of claim 63, wherein the device triggering request is received over one of the traffic channel or the common channel based on the length of the SMS message or the USSD message.

65. The method of claim 56, wherein the device triggering request is based on the SMS message if the device triggering request is received according to a broadcast of the device triggering request to one or more devices including the device, and wherein the device triggering request is based on the USSD message if the device triggering request is directed only to the device.

66. The method of claim 56, wherein the device triggering request is received via a wide area wireless communications network.

67. The method of claim 56, wherein the device triggering request comprises information indicating that the device should initiate the communication link to the server.

68. An apparatus for triggering a device, the apparatus comprising:
a transceiver configured to receive a device triggering request based on at least one of a short message service (SMS) message or an Unstructured Supplementary Service Data (USSD) message; and
a processor configured to initiate a communication link via the transceiver to a server that initiated the device triggering request in response to receiving the device triggering request.

69. The apparatus of claim 68, wherein the device triggering request is based on the USSD message.

70. An apparatus for triggering a device, the apparatus comprising:
means for receiving a device triggering request based on at least one of a short message service (SMS) message or an Unstructured Supplementary Service Data (USSD) message; and
means for initiating a communication link to a server that initiated the device triggering request in response to receiving the device triggering request.

71. The apparatus of claim 70, wherein the device triggering request is based on the USSD message.

72. A computer program product, comprising:
computer readable medium comprising:
code for receiving a device triggering request based on at least one of a short message service (SMS) message or an Unstructured Supplementary Service Data (USSD) message; and
code for initiating a communication link to a server that initiated the device triggering request in response to receiving the device triggering request.

73. The computer program product of claim 72, wherein the device triggering request is based on the USSD message.

74. A method for triggering a device, the method comprising:
receiving a message to request transmission of a device triggering request to the device; and
transmitting the device triggering request to the device based on at least one of a short message service (SMS) message or an Unstructured Supplementary Service Data (USSD) message.

75. The method of claim 74, wherein the device triggering request is based on the USSD message.

76. The method of claim 74, wherein the USSD message comprises a USSD REGISTER message for establishing a communication session with the device, and wherein the method further includes receiving a USSD RELEASE COMPLETE message to end the communication session.

77. The method of claim 74, wherein the SMS message is associated with a teleservice defined for device triggering.

78. The method of claim 74, wherein the device triggering request is transmitted as part of a broadcast of the device triggering request to one or more devices including the device.

79. The method of claim 78, wherein the SMS message is associated with a service category defined for broadcasting device triggering requests.

80. The method of claim 78, wherein the message comprises information regarding the broadcast location of the device along with the request for transmission of the device triggering request.

81. The method of claim 78, wherein a proxy entity for the device is configured to send a message to release a session associated with the USSD message.

82. The method of claim 74, wherein the device triggering request is transmitted to the device over one of a traffic channel or a common channel.

83. The method of claim 82, wherein the device triggering request is transmitted over one of the traffic channel or the common channel based on the length of the SMS message or the USSD message.

84. The method of claim 74, wherein the device triggering request is based on the SMS message if the device triggering request is transmitted according to a broadcast of the device triggering request to one or more devices including the device, and wherein the device triggering request is based on the USSD message if the device triggering request is directed only to the device.

85. The method of claim 74, wherein the device triggering request is transmitted via a wide area wireless communications network.

86. The method of claim 74, wherein the device triggering request comprises information indicating that the device should initiate the communication link to a server.

87. An apparatus for triggering a device, the apparatus comprising:
a receiver configured to receive a message to request transmission of a device triggering request to the device; and
a transmitter configured to transmit the device triggering request to the device based on at least one of a short message service (SMS) message or an Unstructured Supplementary Service Data (USSD) message.

88. The apparatus of claim 87, wherein the device triggering request is based on the USSD message.

89. An apparatus for triggering a device, the apparatus comprising:
means for receiving a message to request transmission of a device triggering request to the device; and
means for transmitting the device triggering request to the device based on at least one of a short message service (SMS) message or an Unstructured Supplementary Service Data (USSD) message.

90. The apparatus of claim 89, wherein the device triggering request is based on the USSD message.

91. A computer program product, comprising:
computer readable medium comprising:
code for receiving a message to request transmission of a device triggering request to the device; and
code for transmitting the device triggering request to the device based on at least one of a short message service (SMS) message or an Unstructured Supplementary Service Data (USSD) message.

92. The computer program product of claim 91, wherein the device triggering request is based on the USSD message.
